(19) United States
(12) Patent Application Publication
(10) Pub. No.: US 2008/0040388 A1
(43) Pub. Date: Feb. 14, 2008

(54) Methods and systems for tracking document lineage

(76) Inventors: Jonah Petri, Mountain View, CA (US); Yan Arrouye, Mountain View, CA (US); Scott Forstall, Mountain View, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/499,525

(22) Filed: Aug. 4, 2006

(51) Int. Cl. G06F 17/00

(52) U.S. Cl. 707/104.1

(57) ABSTRACT

Systems and methods for managing data, such as metadata, are disclosed. In one exemplary method, metadata representing a document lineage are stored, and the stored metadata are searched. The metadata representing a document lineage may comprise a document identifier, identifying a collection of related documents; a file identifier, identify document branches in the collection of related documents; and version identifier, identifying a version of document within a branch of documents. The searching of metadata allows the identifying and tracking of document lineage through modification and duplication operations. Other methods are described and data processing systems and machine readable media are also described.

### BACKGROUND OF THE INVENTION

Modern data processing systems, such as general purpose computer systems, allow the users of such systems to share data files across a network, across a plurality of file storages, or a plurality of storage partitions. For example, a designer can work on a portion of a design file while another designer works on another portion of the design file. Numerous other collaborations or sharing of files has been used by one or more users for a typical data processing system. The large number of duplicated and modified files can present a challenge to a typical user who is seeking to identify, track or find a particular file which has been created.

Modern data processing systems often include a file management system which allows a user to place files in various directories or subdirectories (e.g. folders) and allows a user to give the file a name. Further, these file management systems often allow a user to find a file by searching for the file's name, or the date of creation, or the date of modification, or the type of file. An example of such a file management system is the Finder program which operates on Macintosh computers from Apple Computer, Inc. of Cupertino, Calif. Another example of a file management system program is the Windows Explorer program which operates on the Windows operating system from Microsoft Corporation of Redmond, Wash. Both the Finder program and the Windows Explorer program include a find command which allows a user to search for files by various criteria including a file name or a date of creation or a date of modification or the type of file. However, this search capability searches through information which is the same for each file, regardless of the type of file. Thus, for example, the searchable data for a Microsoft Word file is the same as the searchable data for an Adobe PhotoShop file, and this data typically includes the file name, the type of file, the date of creation, the date of last modification, the size of the file and certain other parameters which may be maintained for the file by the file management system.

A file management system is also responsible for identifying and tracking related documents, mainly through a document identifier and optionally a version identifier. Certain presently existing application programs allow a user to maintain these identifiers and other data about a particular file. This data about a particular file may be considered metadata because it is data about other data. This metadata for a particular file may further include information about the author of a file, a summary of the document, and various other types of information. A program such as Microsoft Word may automatically create some of this data when a user creates a file and the user may add additional data or edit the data by selecting the “property sheet” from a menu selection in Microsoft Word. The property sheets in Microsoft Word allow a user to create metadata for a particular file or document. However, in existing systems, a user is not able to search for metadata across a variety of different applications using one search request from the user. Furthermore, existing systems can perform one search for data files, but this search does not also include searching through metadata for those files.

### SUMMARY OF THE DESCRIPTION

Methods for managing data in a data processing system and systems for managing data are described herein.

A method of managing data in one exemplary embodiment includes the assignment of a file identifier to a document for identifying branches of related documents, in addition to preserving an existing document identifier and version identifier for the document. The incorporation of the file identifier while preserving an existing identifier provides a capability of identifying branches in this collection of related documents, where all related documents in a branch have the same file identifier.

In an embodiment of the present invention, the same file identifier is maintained when a document is modified, thus keeping the modified document in the same branch as the original document. In a preferred embodiment, when a document is modified, its version identifier is updated to indicate a newer version with the file identifier remaining the same to indicate a branch of related documents where the documents descend from each other. The existing document identifier is constant throughout the changes to identify a collection of related documents.

In another embodiment of the present invention, a new file identifier is provided when a document is duplicated (including file creating which is a duplication from a null document, or file importing which is a duplication from a document outside of the file system) to establish a new branch of documents in the collection of related documents. In one embodiment, a persistent, unique file identification number is used as the file identifier. This number persists across different saved versions of the file and is unique, allowing the file to be distinguished from other files. In an embodiment, the file identifier can be a null file identifier (e.g. an empty file identifier, or no file identifier field). In another embodiment, the null file identifier is assigned to the first document branch (e.g. newly created document, or newly imported document). A null file identifier may be used to provide compatibility between documents with file identifier and existing documents without file identifier. In another embodiment, the file identifier is associated with a parent document to provide a lineage between branches. In still another embodiment, the version identifier of the duplicated document is reset (e.g. version 1) to indicate a first version in a new document branch in a document collection.

Another aspect of the present invention relates to the generation of a metadata identifier which may include a file identifier. In an exemplary embodiment, the present invention provides a method to manage, identify and tracking document through the metadata identifiers comprising a document identifier (identifying a document collection), a file identifier (identifying a document branch) and a version identifier (identifying an update of document in a document branch). In an embodiment, the method provides a way to identify and track a relationship between two documents; for example, the method may show that documents are not related (different document identifier), related but in different branches (same document identifier but different file identifier), a version of each other (same document identifier and file identifier), or identical file (same document identifier, file identifier and version identifier). For documents in different branches, an exemplary method according to the present invention provides a relationship path or tree between the two documents. In an embodiment, the method provides for the identifying or tracking of a document, such as tracking a latest version in a branch, tracking a plurality of latest versions in different branches, identifying a tree of related documents, or identifying a tree of a document branch. These metadata identifiers may be stored with a document or in a metadata database which is separate from the document.

Another aspect of the present invention relates to the capturing of metadata from a plurality of files for possible searching operations. This search may occur concurrently for all of the metadata, including document lineage metadata, with a single search interface, thereby allowing a single search to search through all of the metadata for all of the files created by the different software applications. In an embodiment, the metadata can be stored on a storage medium in a flat file format and the metadata can include different types of metadata for different types of files.

Another aspect of the present invention relates to various user interfaces such as search input interfaces and interfaces that present search results, to allow a user to search through the metadata. For example, the search results may be displayed in multiple different formats with headers to separate the match groups, or be limited to a predetermined number for each category. Further, a search query can be saved to generate another search on the saved search query. Another user interface feature provides multiple views for different portions of a search results window, and these interfaces may display document lineage information and include selectable interface controls for showing, or not showing, document lineage in a search results window.

Another aspect of the present invention relates to a software architecture for managing metadata and non-metadata databases such as an indexed database of the full text content of the data files. Search queries may be directed concurrently to metadata, including document lineage metadata, and non-metadata (e.g. full text content) sources in response to a single search query.

Another aspect of the inventions described herein relates to one or more importers which interact with new or modified files created by different application programs. The importer may retrieve the document lineage metadata from a file system storage and then cause that lineage metadata to be stored in a metadata database. For example, an importer is called by the application programs or by a metadata processing software in response to a notification from the application programs or from an operating system (OS) kernel or other element that a new file has been created or an existing file has been modified. An importer will typically specify a file path name for the extracted metadata and specify selected data to be extracted and written for the file containing the extracted metadata.

Another aspect of the inventions described herein relates to performing a search through a system while receiving input from a user. In an exemplary method of this aspect, the data processing system begins a search through the plurality of data files as the user enters input and before the user completes the entry of the search query. This search may be performed through the plurality of data files as well as the metadata and non-metadata databases. The search results may be sorted by relevancy or organized by categories, and the system may display a partial list of matches with options for displaying additional information.

Other aspects of the present invention include various data processing systems which perform these methods and machine readable media which perform various methods described herein.

### BRIEF DESCRIPTION OF THE DRAWINGS

The present invention is illustrated by way of example and not limitation in the figures of the accompanying drawings in which like references indicate similar elements.

FIG. 1 shows a prior art file modification flowchart.

FIG. 2 shows a prior art modification and copy flowchart.

FIG. 3 shows a prior art version control flowchart.

FIGS. 4A-4D show various embodiments of metadata structures of the present invention.

FIGS. 5A and 5B show an embodiment of the present invention for a file creating or a file importing process.

FIG. 6 shows an embodiment of the present invention for a file modification and duplication process.

FIG. 7 shows an embodiment of data structures of the present invention.

FIG. 8 shows an embodiment of a collection of documents, together with branches of documents, wherein metadata indicates and tracks the lineage of documents.

FIG. 9 shows a flowchart according to an embodiment of the present invention for the incorporation of an identifier in a file creation or a file import process.

FIG. 10 shows a flowchart according to an embodiment of the present invention in a file modification process.

FIG. 11 shows a flowchart according to an embodiment of the present invention in a file duplication process.

FIG. 12 shows a flowchart according to an embodiment of the present invention for tracking a relationship between two documents.

FIG. 13 shows a flowchart according to another embodiment of the present invention for tracking a relationship between two documents.

FIG. 14 shows a flowchart according to an embodiment of the present invention for tracking a document.

FIG. 15 shows an exemplary user interface according to an embodiment of the present invention.

FIG. 16 shows an exemplary embodiment of a data processing system, which may be a general purpose computer system and which may operate in any of the various methods described herein.

FIG. 17 shows a general example of one exemplary method of one aspect of the invention.

FIG. 18A shows an example of the content of the particular type of metadata for a particular type of file.

FIG. 18B shows another example of a particular type of metadata for another particular type of file.

FIG. 19 shows an example of an architecture for managing metadata according to one exemplary embodiment of the invention.

FIG. 20 is a flowchart showing another exemplary method of the present invention.

FIG. 21 shows an example of a storage format which utilizes a flat file format for metadata according to one exemplary embodiment of the invention.

FIGS. 22A-22E show a sequence of graphical user interfaces provided by one exemplary embodiment in order to allow searching of metadata and/or other data in a data processing system.

FIGS. 23A and 23B show two examples of formats for displaying search results according to one exemplary embodiment of the invention.

FIG. 24 shows another exemplary user interface of the present invention.

FIG. 25 shows another exemplary user interface of the present invention.

FIGS. 26A-26D show, in sequence, another exemplary user interface according to the present invention.

FIGS. 27A-27D show alternative embodiments of user interfaces according to the present invention.

FIGS. 28A and 28B show further alternative embodiments of user interfaces according to the present invention.

FIGS. 29A, 29B, 29C, and 29D show further alternative embodiments of user interfaces according to the present invention.

FIGS. 30A, 30B, 30C and 30D show another alternative embodiment of user interfaces according to the present invention.

FIGS. 31A and 31B show certain aspects of embodiments of user interfaces according to the present invention.

FIG. 32 shows an aspect of certain embodiments of user interfaces according to the present invention.

FIGS. 33A and 33B show further aspects of certain embodiments of user interfaces according to the present invention.

FIGS. 34A, 34B, 34C, 34D, and 34E show further illustrative embodiments of user interfaces according to the present invention.

FIG. 35 is a flow chart which illustrates another exemplary method of the present invention.

### DETAILED DESCRIPTION OF THE INVENTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Computer, Inc. 2003.

In an embodiment, the present invention discloses a method for managing data by storing a plurality of document lineages and by retrieving the document lineages for identifying and tracking document. The exemplary method comprises the assignment of an additional file identifier to a document for identifying branches of related documents. The file identifier identifies a collection of documents and is in addition to an existing document. In one aspect, the file identifier provides a capability of identifying a branch in this collection of related documents, distinguishing between modifying (updating version number) and copying (updating file identifier).

In a preferred embodiment, the file identifier is a part of a metadata which is stored in a metadata database, and which is preferably the document lineage associated with the document. In one aspect, the present invention provides a method for identifying and tracking document lineage through the metadata database. With the metadata comprising, in one embodiment, a document identifier, a file identifier and a version identifier, the present invention document lineage tracking method can provide a complete tree of the document's lineage, and can provide a complete relationship between any two documents.

In one aspect, the present invention provides a data structure comprising a plurality of document lineages, with each document lineage associated with a document, and comprising a document identifier, a file identifier and a version identifier. The document lineage is preferably a metadata associated with the document (e.g. stored with the document), and more preferably stored in a metadata database which is separate from the document. It will be understood that the lineage metadata may be maintained for any type of information and hence “document” includes any type of information including, for example, web pages, emails, downloads, etc.

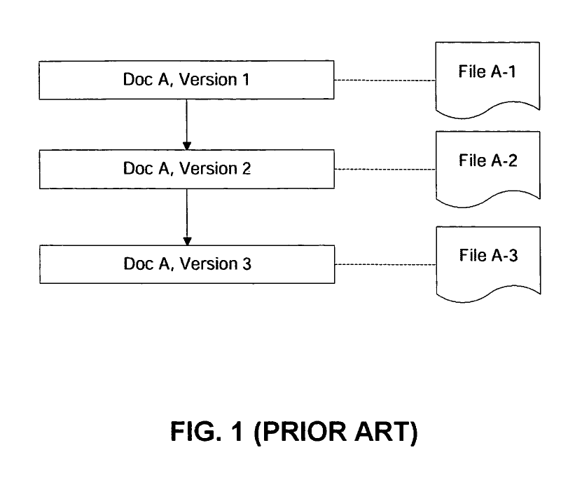

FIG. 1 shows an exemplary prior art document management system for file modification, comprising a document identifier and a version identifier. The document identifier identifies a collection of related documents, e.g. Doc A in this Figure, and the version identifier identifies the updating of the document. The document typically starts at version 1, and becomes a version 2 after the first update, and becomes version 3 after another update. The document identifier and the version identifier identify a file content, which is typically integrated together in a file storage area with a first few bytes reserved for the identifiers.

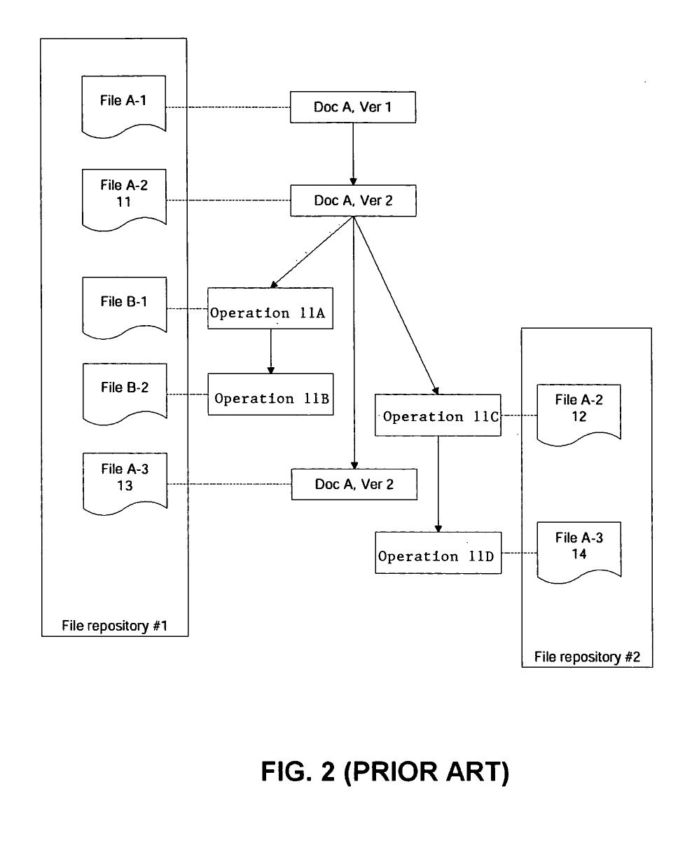

FIG. 2 shows an exemplary prior art document management system for file modification and copying. A document A starts at version 1 (Doc A, Ver 1) and is stored in a File depository #1 as File A-1. After a modification operation (e.g. edit and save), the update document becomes version 2 (Doc A, Ver 2), and is stored in File depository #1 as File A-2 (11). Document A, version 2, is then copied (in operation 11A) and also stored in File depository #1. This prior art file management system allows only two identifiers (document identifier and version identifier), and hence the copied document cannot be stored as A-2 because it would be in conflict with the original File A-2 (11). It also cannot be stored as File A-2-1 since this has three identifiers. Thus the copied document is stored in File depository #1 as File B-1 which is a copy of document A, version 2. A modification of File B-1 (in operation 11B) results in a File B-2, which is a modification of a copy of document A, version 2. There is no relationship discernable (from the identifiers) between File A-2 (11) and File B-1, even though they are copies of each other.

Another copy of File A-2 (11) can be made (in operation 11C), resulting in a copy 2 of document A, version 2. Since this copy is stored in a File depository #2, the document can retain the original name as File A-2 (12). There is no conflict because this File A-2 (12) in the File depository #2 is identical to the File A-2 (11) in the File depository #1. This File A-2 (12) is then modified (in operation 11D), resulting in File A-3 (14) in File depository #2, which is a modification of a copy 2 of document A, version 2. However, this File A-3 (14) is different from a File A-3 (13) in the File depository #1, which now is a modification of the original File A-2 (11). The prior art file management system cannot handle document lineage tracking across multiple file depositories since there can be multiple different documents with the same identifiers (e.g. File A-3), or multiple same documents with different identifiers (e.g. File A-2 and File B-2).

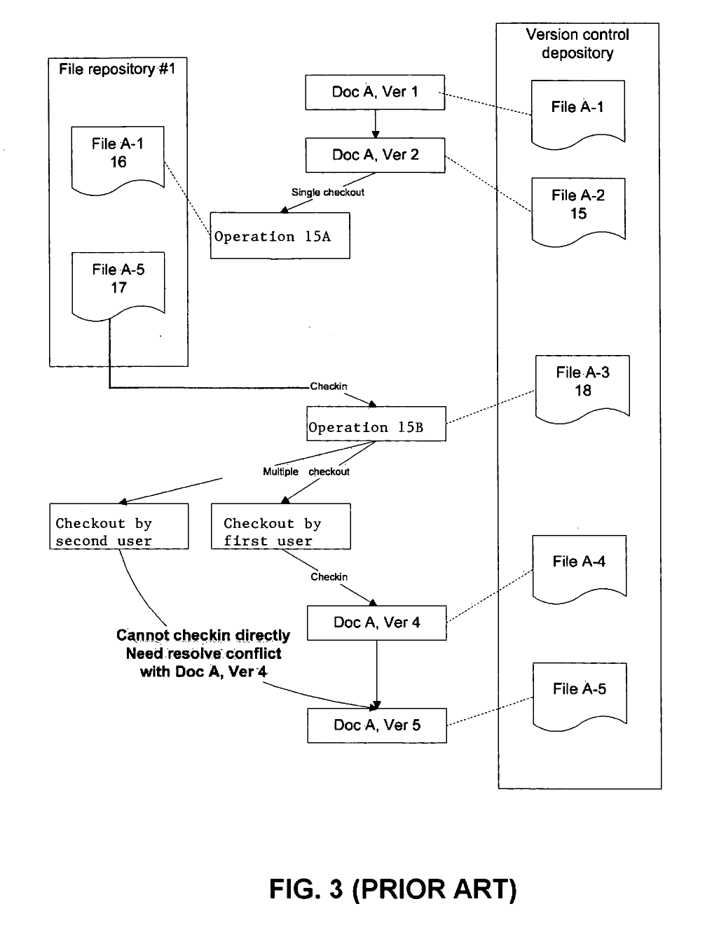

FIG. 3 shows a prior art file management system using version control, including a version control depository. For a single checkout methodology, after a user checks out a document, the document is prevented from being modified by other users. A user can checkout a File A-2 (document A, version 2) (15) in operation 15A, and copy it to a File depository #1 as File A-2 (16). This File A-2 (16) can be edited and saved a plurality of times (e.g. 3 times), resulting in a File A-5 (17). File A-5 (17) is then checked back into the version control depository as File A-3 (18) in operation 15B. The File depository #1 is separate from the version control depository, and therefore the version number in the version control depository runs independently of the File depository #1.

Multiple checkout methodology can allow multiple users to check out the same document. However, the first user can check in with a next version (File A-4) while the later user has to resolve a conflict with this version before the later user can check in and become a later version (File A-5). Again, version control file management system does not handle file depository outside the version control depository.

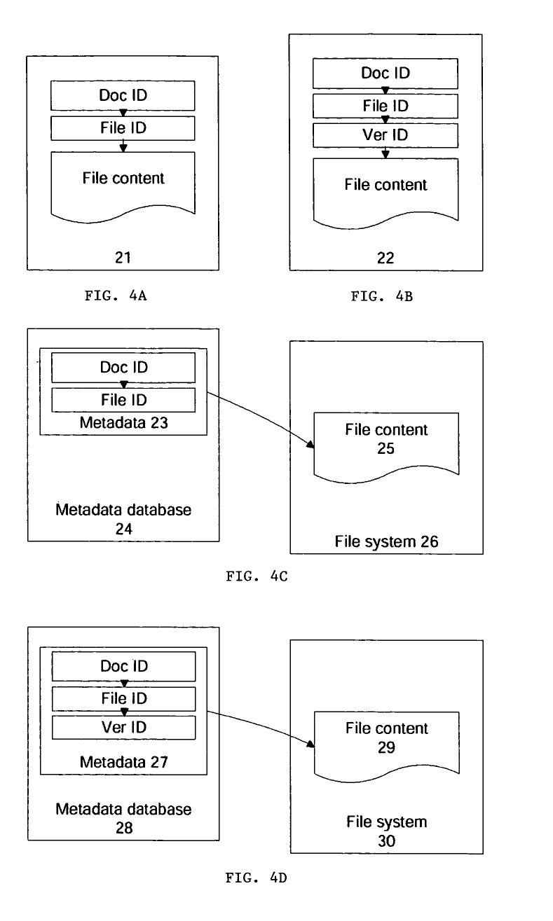

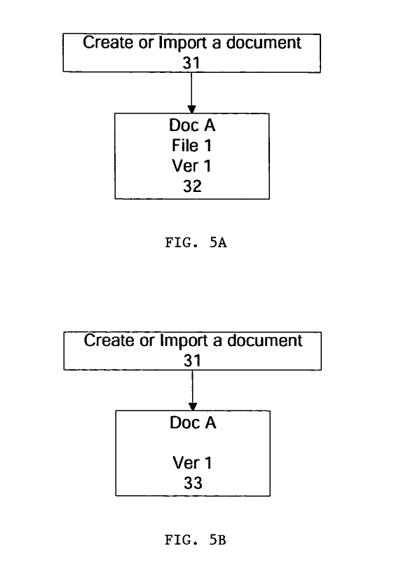

FIGS. 4A-4D illustrate various embodiments of the present invention file identifier for documents. In the embodiment of FIG. 4A, a file 21 comprises a document identifier and a file identifier, preceding or otherwise accompanying a file content. In the embodiment of FIG. 4B, a file 22 comprises a document identifier, a file identifier and a version identifier, also preceding or otherwise accompanying a file content. In another aspect of the present invention, one or more identifiers are stored as metadata of document lineage in a metadata database separately from the document/file rather than with the document/file. FIG. 4C shows a metadata 23 comprising a document identifier and a file identifier which are stored in a metadata database 24. This metadata identifier 23 is associated with a file content 25 which is stored in a separate file system 26. In the embodiment of FIG. 4D, a metadata 27 comprises a document identifier, a file identifier and a version identifier and is stored in a metadata database 28. This metadata identifier 27 is associated with a file content 29 which is stored in a separate file system 30. The separation of metadata and file content provides many advantages, such as the fast speed of searching, especially in large databases.

In one aspect, the file or other identifier of the present invention provides the capability for identifying and tracking branching in a collection of documents. In an embodiment, the file identifier remains the same when the document is modified (e.g. edit and save), thereby identifying the same branch in the document collection. A version identifier can be used to keep track of the modification. In another embodiment, the file identifier changes when the document is duplicated (e.g. copied), identifying a new document branch in the document collection. Creating or importing a document can be classified as either modifying or copying.

FIGS. 5A and 5B illustrate two embodiments of a creating/importing operation. FIG. 5A includes an operation in which a document 31 is created or imported, and then the document is assigned a triplet identifier which consists of a document identifier, file identifier, and version identifier, and this triplet identifier is shown as a metadata identifier 32.

FIG. 5B includes an operation which involves creating or importing a document 31, and then the document is assigned a document identifier and a version identifier, which are shown as a metadata identifier 33.

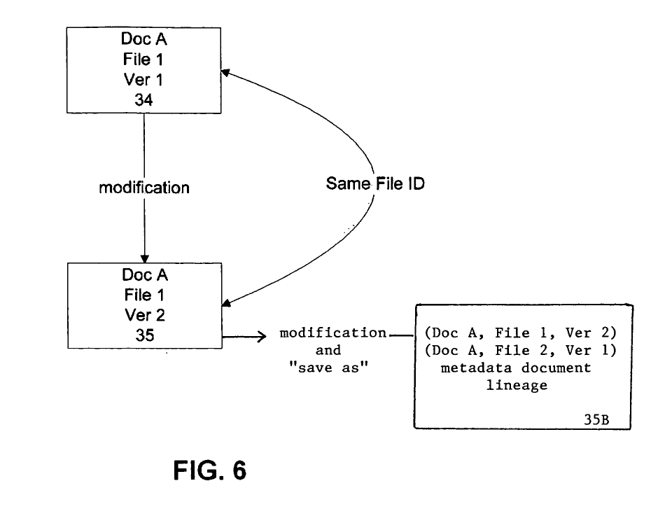

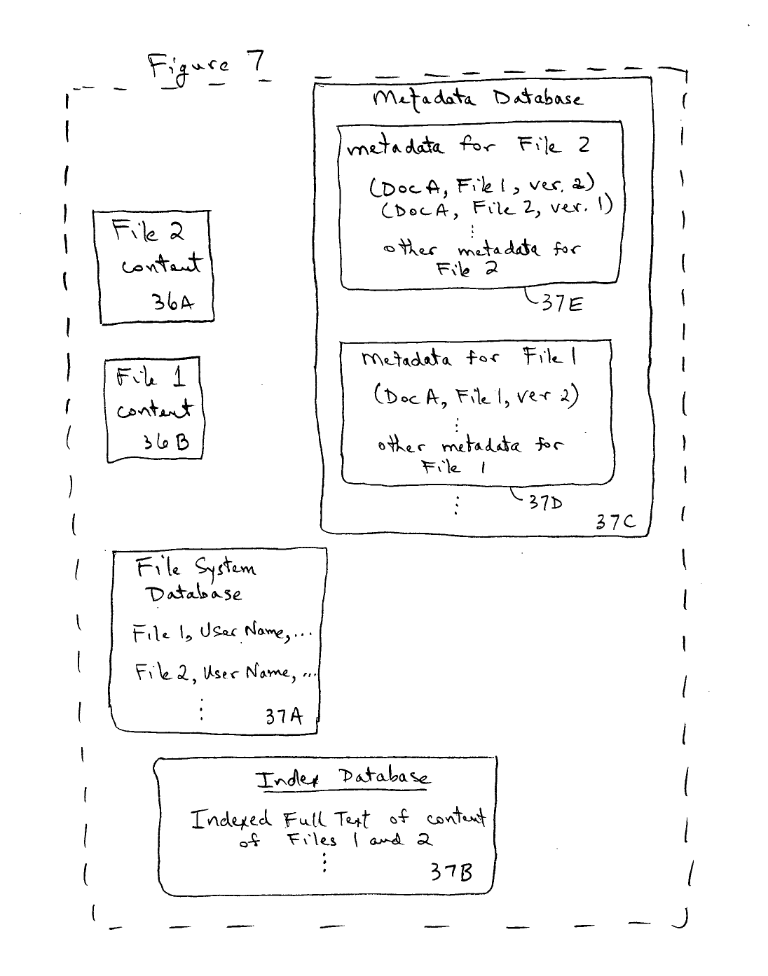

FIG. 6 illustrates another embodiment of the present invention, showing a modification operation (e.g. a document has been edited by the user and the edited version is saved and the edited version replaces the prior version of the document; this is different than a “save as” operation which creates a new document and does not replace or delete the prior version of the document. The original document 34 has a metadata identifier of Doc A, File 1, and Ver 1. Updating the document (e.g. saving the edited version) results in a newer version, with a new metadata identifier 35 of Doc A, File 1, Ver 2. The modification operation retains the file identifier of File 1 for the original and the modified documents. The file identifier (e.g. “File 1”) may be a unique, persistent value assigned by the file system of an operating system to the document; this value is used by the file system to uniquely identify the corresponding document. This file identifier may be stored in an “inode,” maintained for the file by the file system, and this file identifier is also stored as metadata for the document, either in a separate metadata database (such as those described herein which contain different types of metadata for different types of files) or as a metadata stored as an appendage (e.g. a header) to the document's stored content. A discussion of an inode may be found in the book “Practical File System Design” by Dominic Giampaolo, Morgan Kaufmann Publishers, Inc., 1999. Metadata processing software may receive this assigned file identifier from the file system and then cause the assigned file identifier to be saved as metadata along with other metadata, including metadata showing document lineage. The identifier “Doc A” may be a unique value assigned to a new or imported file, and it may be assigned by the metadata processing software or by the operating system's file system. The “Doc A” identifier may be considered a document identifier which indicates a collection of documents because, in at least certain embodiments, it remains the same as a document is “saved” after modifications and it remains the same as a document is copied (e.g. through a “save as” operation within the software which created or edited the document or through a copy or duplicate operation by file system software). If two documents (e.g. two files separately maintained by the file system software) have the same document identifier (e.g. “Doc A”) in their document lineage metadata, then this indicates that the documents are linked or otherwise are part of a lineage. If two documents have the same document identifier and file identifier, then they are also linked or otherwise are part of a lineage and they are different versions of each other (e.g. a first document was used to create a second document, where the second is a later version of the first). The version identifier (e.g. “Ver 2” for metadata identifier 35) shows the version number of the document, and it may be assigned by the metadata processing software or by the file system software. The document lineage metadata is maintained and processed by the metadata processing software so that a user can determine the lineage of one or more documents when search results are presented. The file name given by a user (e.g. a file name entered by a user when saving or creating or importing a document) is normally separate from the identifiers used in the document lineage metadata; thus, the file name is saved as metadata in a metadata database and may also be saved in a file system's database, but the user's file name is not normally used to identify document lineage. Hence, the system of at least certain embodiments automatically maintains and tracks document lineage without effecting (e.g. renaming) a user's file name.

Referring back to FIG. 6, it can be seen that a modification with a “save as” (or file level copying) operation will cause the amount of document lineage metadata to increase in order to preserve lineage information. In the example of FIG. 6, a user has modified the document having the document lineage metadata “Doc A, File 1, Ver 2” (shown as metadata identifier 35) and has created a new document by selecting “save as” when saving this new document, which saving does not replace the prior document (having metadata identifier 35). In other words, two documents will exist in the file system after the “save as” operation (or after a file copy or duplication operation which uses the file system software to copy or duplicate the document). One document is the “original” document associated with the metadata identifier 35, and the other document is a new document which is the modified version which will be associated with metadata document lineage 35B which includes metadata identifier 35 (“Doc A, File 1, Ver 2”) and additional metadata (“Doc A, File 2, Ver 1”). This additional metadata shows that this other document is related to the original document which itself is the second version (“Ver 2”) of Document A (“Doc A”). The combination of metadata identifier 35, which may be referred to as a metadata document lineage triplet from the “original” document, and the new metadata document lineage triplet (“Doc A, File 2, Ver 1”), together specify the complete lineage of the new document. In this example, this combination is a set of triplets where the set has two triplets. More generally, the lineage created by the set of triplets may be referred to as a set of lineage identifiers. In particular, the metadata identifier 35 (“Doc A, File 1, Ver 2”), which is part of the metadata document lineage 35B, specifies to the metadata processing software that the new document originated from or was derived from the document specified by metadata identifier 35, and the additional metadata (“Doc A, File 2, Ver 1”) specifies to the metadata processing software that the new document is on version 1 (as specified by “Ver 1”) and is related to document A (as specified by “Doc A”) and is stored as File 2 in the file system. The metadata document lineage 35B may be created in the following manner. In response to receiving a command, such as “save as” or a file copy command for an existing file, the metadata processing software copies the metadata document lineage triplet (such as metadata identifier 35 in this example) and stores that copy as document lineage metadata for the new document, and the metadata processing software also creates (optionally) additional metadata (such as the additional metadata “Doc A, File 2, Ver 1”) which is also stored as document lineage metadata for the new document. The creation of the additional metadata is optional at this stage because it can be created later when the second version of the new document is created; the metadata for the new document already includes the file identifier “File 2” (even if the additional metadata is not stored) which can be compared to the “File 1” identifier to determine that the new document is a derivative from “Doc A, File 1, Ver 2.” The difference between these file identifiers can be used when the new document is modified to create the second version to cause the metadata processing software to add the additional metadata (in this case “Doc A, File 2, Ver 2”) as the second version is stored/saved.

FIG. 7 illustrates examples of several data structures which may be used in certain embodiments of the invention which maintain and track document lineage through the use of document lineage metadata. These data structures are also described further below. The data structures may be stored on a non-volatile storage device such as a bootable hard drive which includes functional operating system software and file system software as well as metadata processing software and “find by content” software. The implementation shown in FIG. 7 includes at least the two documents represented in FIG. 6 after the “save as” operation (or a file copying operation) created the new document, represented by metadata identifier 35B, from the “original” document represented by metadata identifier 35. Hence, the storage device shown in FIG. 7 includes the content of File 1 (shown as file content 36A) and the content of File 2 (shown as file content 36B). The file system database 37A represents a database or data structure created by and maintained by the file system software, and this database typically includes, for each file, a file identifier (such as a persistent, unique file value which uniquely identifies the file relative to all other files maintained by the file system), the user's file name, certain file attributes (e.g. creation date, file type, etc.) and a list of storage locations (either logical or physical) which contain the contents of the file. The file identifier may be the same as the file identifier used in metadata database 37C to identify the file with its associated metadata. The index database 37B is the indexed full text of the content of at least files 1 and 2; this index database may be created and maintained by the “find by content” software which creates a full text index of the full text of the content of the files, such as files 1 and 2. The metadata database 37C is an example of a database of the collected and/or imported metadata from files in the system, including a least files 1 and 2. The metadata 37E for File 2 includes the file identifier “File 2” and includes the document lineage metadata from both File 1 (Doc A, File 1, Ver 2) and the additional metadata (Doc A, File 2, Ver 1). The metadata 37E may include other metadata such that the metadata database includes different types of metadata for different types of files. The metadata 37D for File 1 includes the file identifier “File 1” and also includes the document lineage metadata for “File 1” (Doc A, File 1, Ver 2) and may also include other metadata.

In certain embodiments, the document lineage metadata may use only two values rather than three (a triplet). In one implementation, the two values may specify a file identifier (e.g. a persistent, unique file identifier as described above) and a version identifier. When an original document is copied (e.g. in a “save as” operation within an application program which created the original document or a file system copy operation), a new set of two values is created for the copy, wherein the new set includes a new, persistent and unique file identifier and a version number (e.g., version=1 for a newly created copy). The lineage metadata for the original document, after the copy operation, includes both the file identifier (e.g. F1) and version identifier (V2) for the original document (and hence there is one pair of values in this set of lineage metadata), and the lineage metadata for the newly created copy is two pairs of values in a set of lineage metadata: one pair is the pair (F1, V2) from the original document, and the other pair is the file identifier (e.g. F2) and the version identifier (V1) for the newly created copy. Hence, in this example, the complete lineage metadata for the newly created copy is: [(F1, V2), (F2, V1)]. Other alternatives may use a different technique to identify the file or the version.

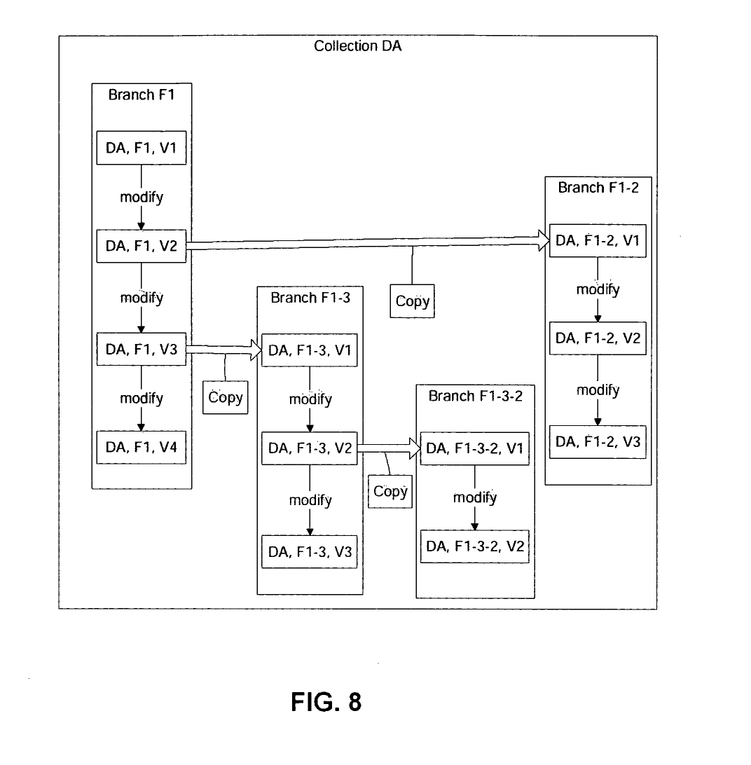

FIG. 8 illustrates a collection of related documents, identifiable by a document identifier DA, with multiple document branches of Branch F1, Branch F1-3, Branch F1-3-2, and Branch F1-2. Document branch F1 comprises documents with the same document identifier (DA) and file identifier (F1) and with different version identifier (V1-V4). A copy operation from document (DA, F1, V3) results in document (DA, F1-3, V1), which has a file identifier F1-3 linked to the parent document (file identifier F1, version 3), and a version identifier reset to 1. The copied document (DA, F1-3, V1) forms a new document branch F1-3 and comprises documents with the same document identifier (DA) and file identifier (F1-3) and with a different version identifier (V1-V3). Another copy operation from document (DA, F1-3, V2) results in document (DA, F1-3-2, V1), which has a file identifier F1-3-2 linked to the parent document (file identifier F1-3, version 2), and a version identifier reset to 1. The copied document (DA, F1-3-2, V1) forms a new document branch F1-3-2 and comprises documents with the same document identifier (DA) and file identifier (F1-3-2) and with different version identifier (V1-V2). The document collection further comprises a document branch F1-2, which resulted from a copy operation from document (DA, F1, V2). This document branch has a file identifier F1-2 linked to the parent document (file identifier F1, version 2), and a version identifier reset to 1. The collection of related documents can be stored in a single or multiple file repositories, with each metadata identifier uniquely associated with a document.

The tree representation of document collection in FIG. 8 can provide a relationship between any two documents, can provide all branches in a document collection, can identify and track document lineage of any document, and can provide the latest versions of any document. This tree representation may be created form the document lineage metadata described herein, such as the document lineage metadata shown in FIGS. 6 and 7.

The file identifier may be captured as a metadata and stored in a metadata database, which will be described further below. The following sections describe embodiments using metadata, but the invention can be equally applicable to non-metadata.

An embodiment of the present invention provides an assignment and storage of metadata comprising a file identifier to identify one or more documents for file management. The metadata is preferably a triplet of a document identifier, a file identifier and a version identifier. In one aspect, the file identifier remains the same when the document is modified, and becomes different when the document is duplicated. Thus the file identifier generates a document branch in a document collection whenever a duplication operation is performed.

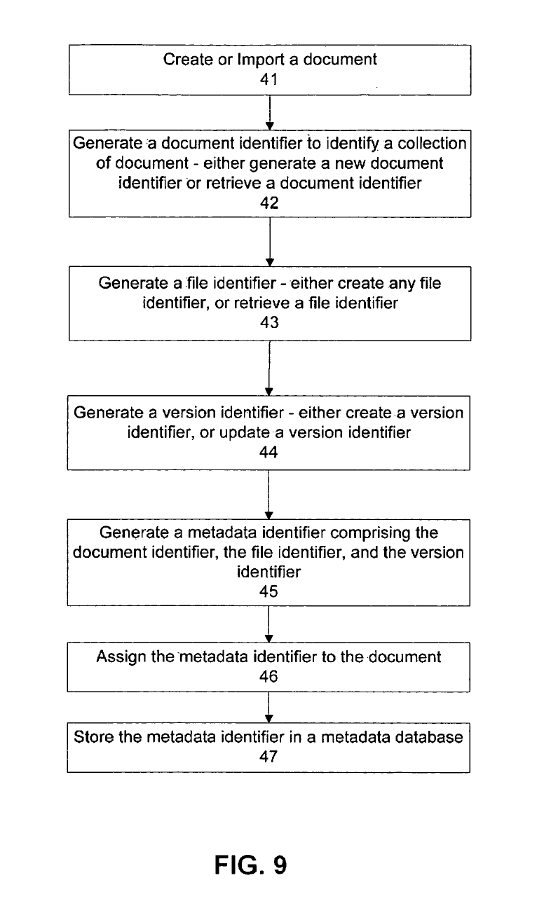

FIG. 9 illustrates an exemplary process for assignment and storage of file identifier during a creation or import of document. The method of FIG. 9 may begin in operation 41 in which a document is created or imported. This operation may come from an OS kernel or from an application software such as a word processing software or an importer software or import process (e.g. downloading a file from a network or detaching a file from an email). A document identifier is generated in operation 42. This document identifier can be any new document identifier, or can be retrieved from the imported document. This document identifier can serve to identify a collection of related documents that starts from the creating or importing operation. A file identifier is then generated in operation 43. This file identifier is normally created and used by the file system software as described herein. This file identifier can serve to identify a branch of related documents that starts from this document. A version identifier is then generated in operation 44. This version identifier can be new version identifier (e.g. 1), or can be retrieved or updated from the imported document. This version identifier can serve to identify a version of related documents that starts from this document. The generation of these three identifiers can be done in any order. Then in operation 45, a metadata identifier is generated, comprising a document identifier, a file identifier and a version identifier. The metadata identifier is then assigned to the document in operation 46, and stored in a metadata database in operation 47.

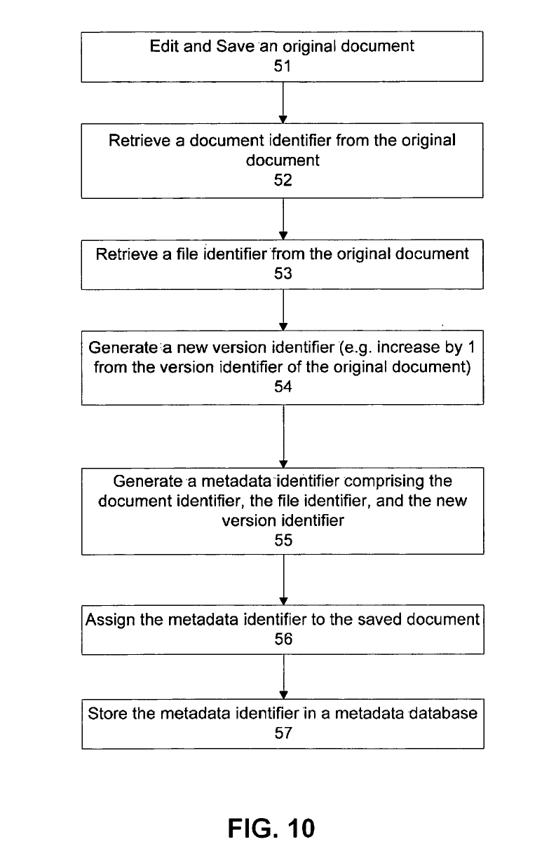

FIG. 10 illustrates an exemplary process for assignment and storage of document lineage metadata during a modification of a document. The method of FIG. 10 may begin in operation 51 in which a document is modified (e.g. edits are made and then it is saved). A document identifier is retrieved in operation 52; a file identifier is retrieved in operation 53; and a version identifier is generated in operation 54, updated from the retrieved version identifier. The generation of these three identifiers can be performed in any order. The retrieval of the identifiers is preferably from the metadata of the original document, but can be from the document itself. Then in operation 55, a metadata identifier is generated, comprising a document identifier, a file identifier and a version identifier. The metadata identifier is then assigned to the document in operation 56, and stored in a metadata database in operation 57. In other embodiments, a plug-in or importer or other resource may provide and store the lineage in a data structure other than a metadata database, and the plug-in or importer or other resource may be separate and distinct from metadata processing software.

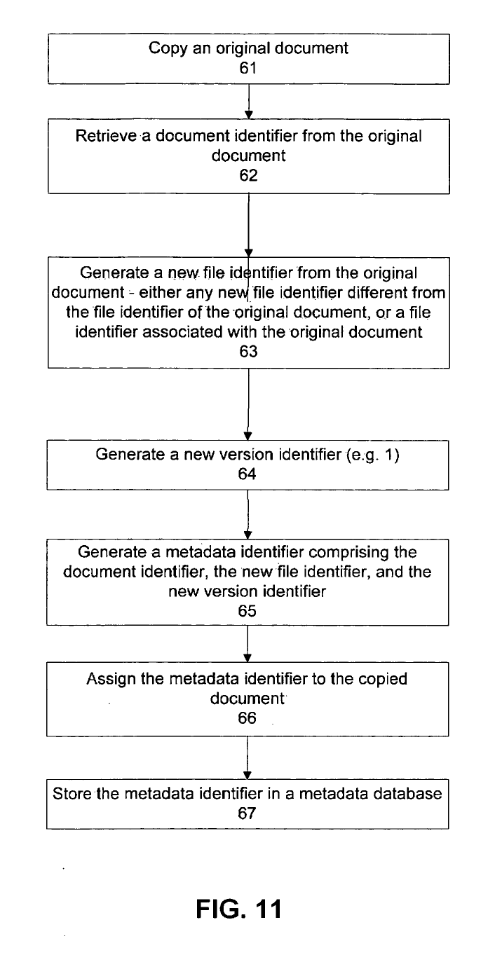

FIG. 11 illustrates an exemplary process for assignment and storage of document lineage metadata during a copy operation of document. The method of FIG. 11 may begin in operation 61 in which a document is copied. A document identifier is retrieved in operation 62; a file new identifier is generated in operation 63; and a version identifier is generated in operation 64, preferably a reset version identifier (e.g. 1). A new file identifier may be linked to the original document or the metadata of the original document. The generation of these three identifiers can be of any order. The retrieval of the identifiers is preferably from the metadata of the original document, but can be from the document itself. Then in operation 65, a metadata identifier is generated, comprising a document identifier, a file identifier and a version identifier. The metadata identifier is then assigned to the document in operation 66, and stored in a metadata database in operation 67.

Another embodiment of the present invention provides a tracking of document lineage, preferably through the metadata database. In one aspect, the file management system according to the present invention can provide a relationship between any two documents, or can identify or track any document in the file system through the document lineage metadata of the documents.

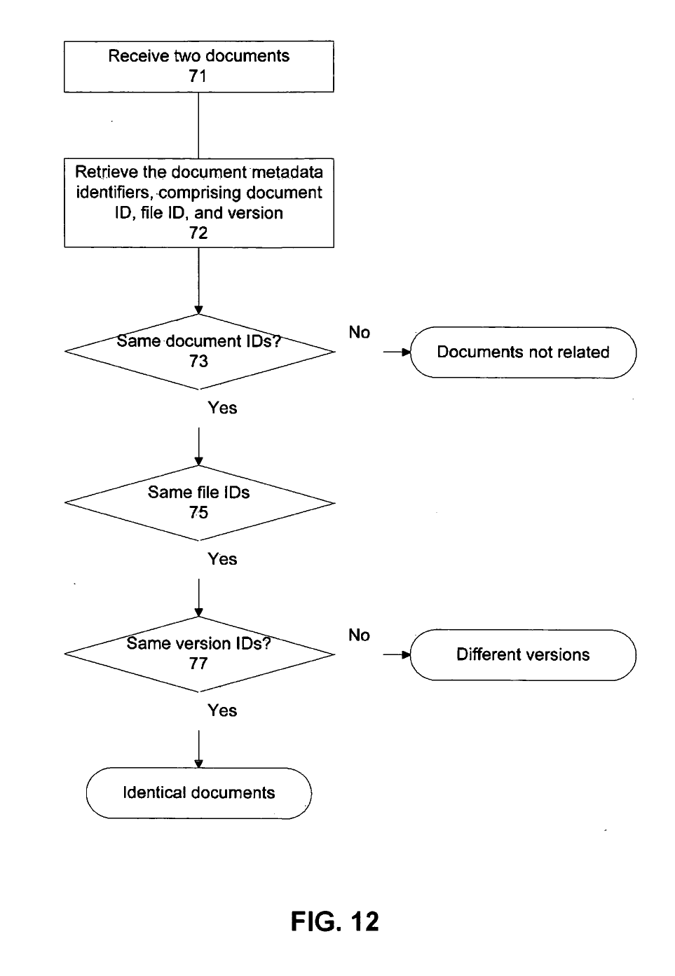

FIG. 12 illustrates an exemplary process for identify a relationship between two documents. The method of FIG. 12 may begin in operation 71 in which two documents are provided. The metadata for these two documents are then retrieved with the document identifier, the file identifier, and the version identifier extracted in operation 72, and the document identifiers are compared in operation 73. If the document identifiers are not the same, then the two documents are not related. Then the file identifiers are compared in operation 75. If the file identifiers are not the same, then the two documents are copies of each other and belong to a same document branch. Then the version identifiers are compared in operation 77. If the version identifiers are not the same, then the two documents are versions of each other. If the version identifiers are the same, then the two documents are identical.

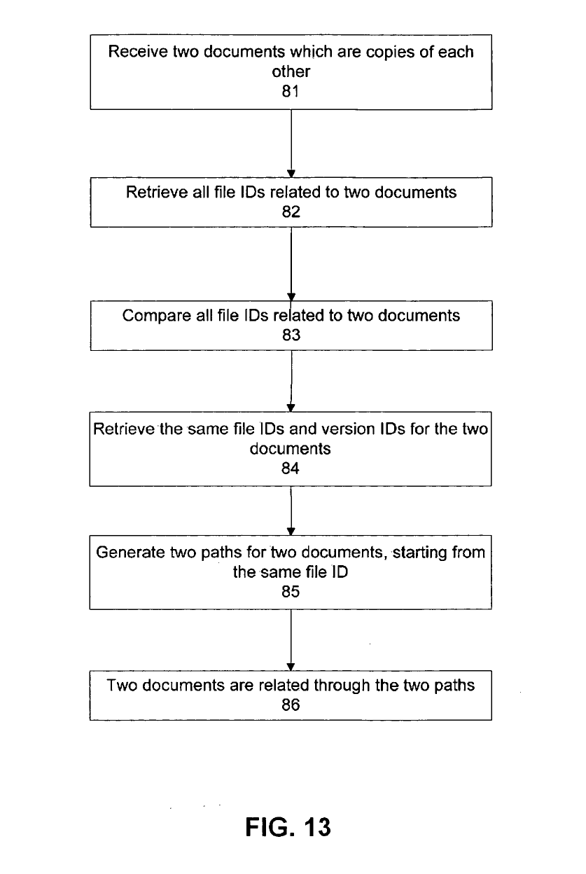

FIG. 13 illustrates an exemplary process to identify a relationship between two documents which are copies of each other. The method of FIG. 13 may begin in operation 81 in which two documents which are copies of each other are provided. This operation might be a continuation of operation 76 in FIG. 12. The metadata for these two documents are then retrieved with the file identifier extracted in operation 82, and the file identifiers are compared in operation 83. After retrieving the file identifiers in operation 84, two paths are generated from the same file identifier in operation 85. The two documents are related through these two paths in operation 86.

An exemplary example for comparing two copied documents (DA, F1-3, V3) and (DA, F1-2, V2) is provided by referring to FIG. 8. A number of file identifiers (or branches) of (DA, F1-3, V3) are retrieved, which are branches F1-3 and branch F1. The file identifiers (or branches) of (DA, F1-2, V2) is also retrieved, which are branches F1-2 and branch F1. A comparison between these file identifiers provides a common file identifier which is F1. Further comparison provides a common version identifier of V2, which identifies a common document of (DA, F1, V2). The path for document (DA, F1-3, V3) starts from document (DA, F1, V2) is then (DA, F1, V2) versioned to (DA, F1, V3) copied to (DA, F1-3, V1) versioned to (DA, F1-3, V2). The path for document (DA, F1-2, V2) starts from document (DA, F1, V2) is then (DA, F1, V2) copied to (DA, F1-2, V1) versioned to (DA, F1-2, V2).

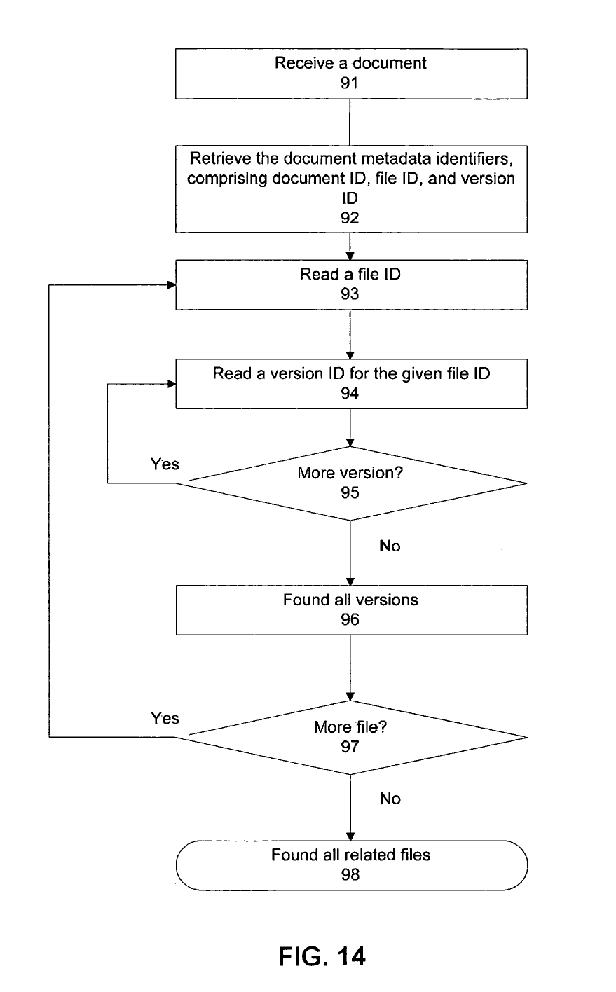

FIG. 14 illustrates an exemplary process for identifying or tracking a document. The method of FIG. 14 may begin in operation 91 in which a document is provided. The metadata for this document is then retrieved with the document identifier, the file identifier, and the version identifier extracted in operation 92. A file identifier is read in operation 93, and a version identifier is read in operation 94. A loop is performed in operation 95 back to operation 94 to search for all versions with all versions are found in operation 96. An outer loop is then performed in operation 97 back to operation 93 to search for all branches. All related documents are found in operation 98.

This process provides a complete document collection with all document branches and versions. Modifications of this process can provide information about a particular document branch, a particular latest version in a particular branch, or all latest versions in all branches.

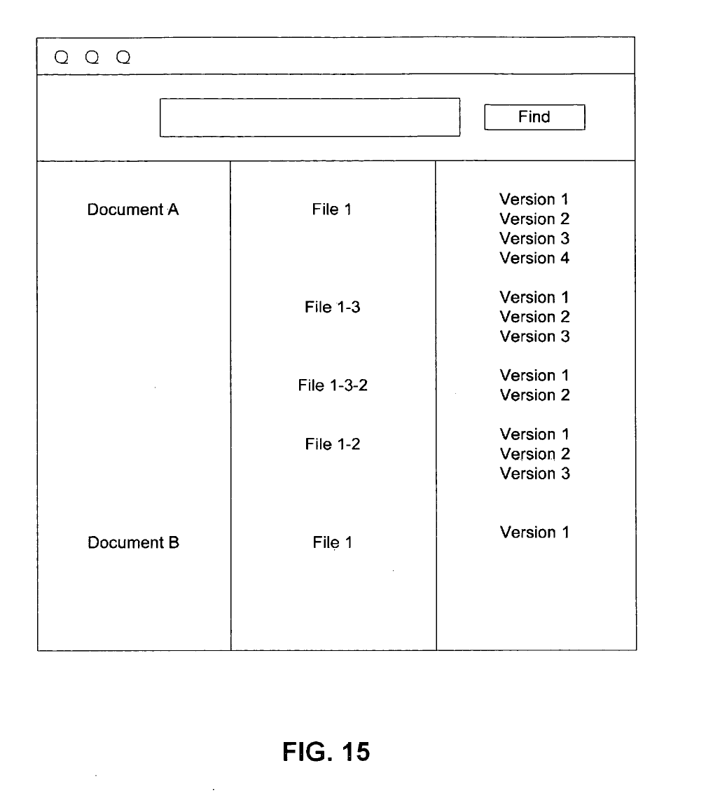

FIG. 15 shows an exemplary user interface according to an embodiment of the present invention to identify and track related documents. The display is related to the collection of documents in FIG. 8.

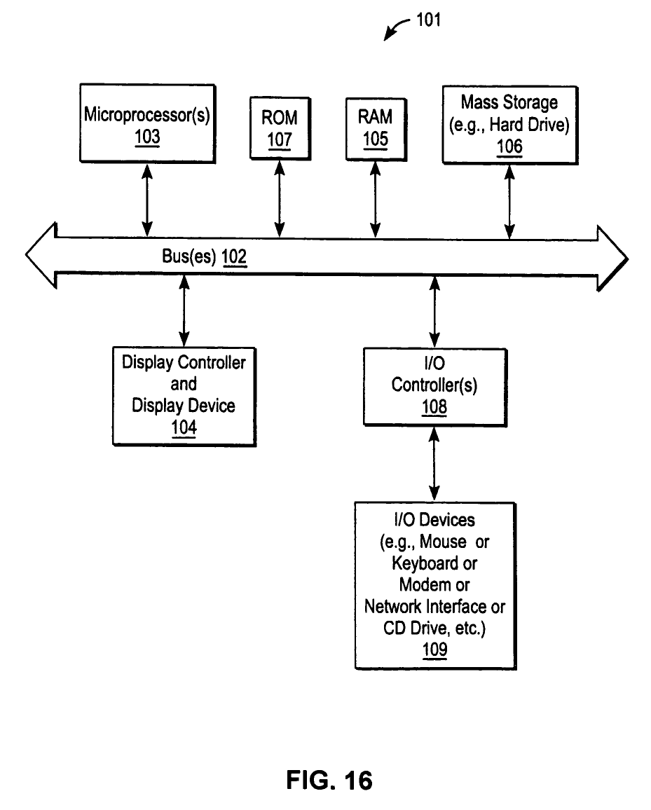

FIG. 16 shows one example of a typical computer system which may be used with the present invention. Note that while FIG. 16 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. The computer system of FIG. 16 may, for example, be a Macintosh computer from Apple Computer, Inc.

As shown in FIG. 16, the computer system 101, which is a form of a data processing system, includes a bus 102 which is coupled to a microprocessor(s) 103 and a ROM (Read Only Memory) 107 and volatile RAM 105 and a non-volatile memory 106. The microprocessor 103 may be a G3 or G4 microprocessor from Motorola, Inc. or one or more G5 microprocessors from IBM. The bus 102 interconnects these various components together and also interconnects these components 103, 107, 105, and 106 to a display controller and display device 104 and to peripheral devices such as input/output (I/O) devices which may be mice, keyboards, modems, network interfaces, printers and other devices which are well known in the art. Typically, the input/output devices 109 are coupled to the system through input/output controllers 108. The volatile RAM (Random Access Memory) 105 is typically implemented as dynamic RAM (DRAM) which requires power continually in order to refresh or maintain the data in the memory. The mass storage 106 is typically a magnetic hard drive or a magnetic optical drive or an optical drive or a DVD RAM or other types of memory systems which maintain data (e.g. large amounts of data) even after power is removed from the system. Typically, the mass storage 106 will also be a random access memory although this is not required. While FIG. 16 shows that the mass storage 106 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the I/O controller 108 includes a USB (Universal Serial Bus) adapter for controlling USB peripherals and an IEEE 1394 controller for IEEE 1394 compliant peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 107, RAM 105, mass storage 106 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 103.

Capturing and Use of Metadata Across a Variety of Application Programs

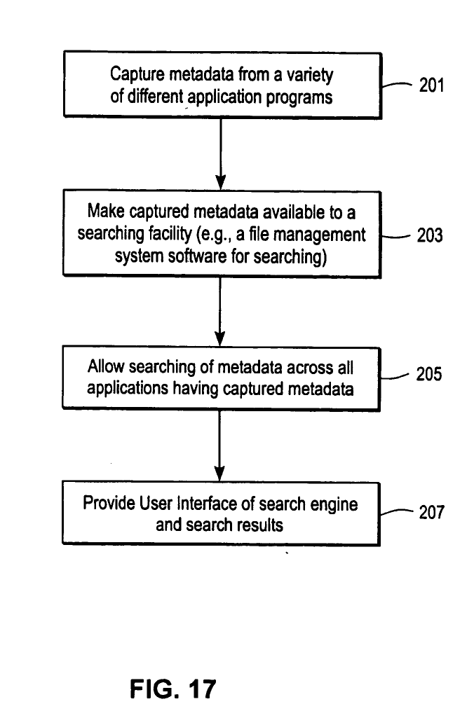

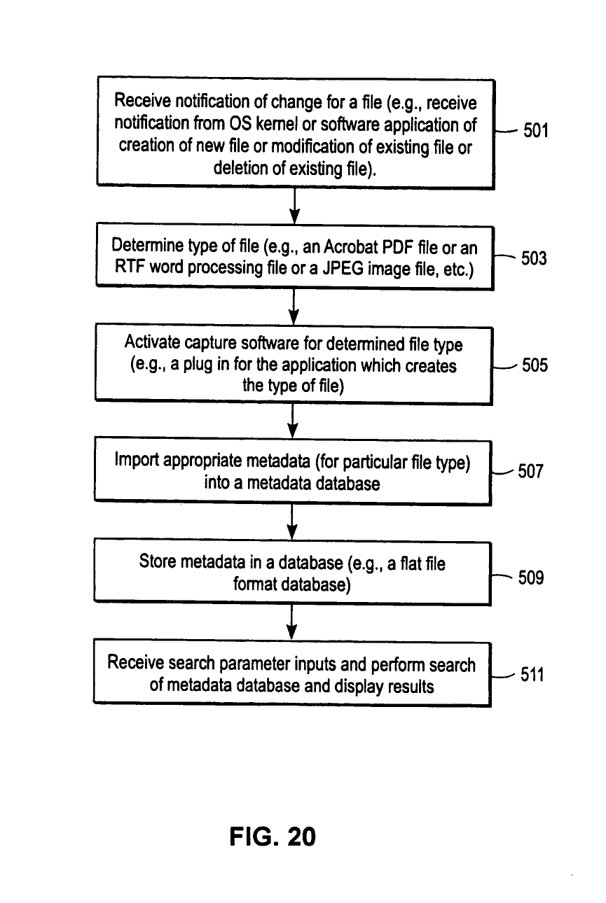

The metadata to identify and track a document lineage as disclosed above can be captured for a searching facility. The following description discusses the applications of document lineage metadata in searching and displaying search input and search results for document lineage identifying and tracking. FIG. 17 shows a generalized example of one embodiment of the present invention. In this example, captured metadata is made available to a searching facility, such as a component of the operating system which allows concurrent searching of all metadata for all applications having captured metadata (and optionally for all non-metadata of the data files). The method of FIG. 17 may begin in operation 201 in which metadata is captured from a variety of different application programs. This captured metadata is then made available in operation 203 to a searching facility, such as a file management system software for searching. This searching facility allows, in operation 205, the searching of metadata across all applications having captured metadata. The method also provides, in operation 207, a user interface of a search engine and the search results which are obtained by the search engine. There are numerous possible implementations of the method of FIG. 17. For example, FIG. 20 shows a specific implementation of one exemplary embodiment of the method of FIG. 17. Alternative implementations may also be used. For example, in an alternative implementation, the metadata may be provided by each application program to a central source which stores the metadata for use by searching facilities and which is managed by an operating system component, which may be, for example, the metadata processing software. The user interface provided in operation 207 may take a variety of different formats, including some of the examples described below as well as user interfaces which are conventional, prior art user interfaces. The metadata may be stored in a database which may be any of a variety of formats including a B tree format or, as described below, in a flat file format according to one embodiment of the invention.

The method of FIG. 17 may be implemented for programs which do not store or provide metadata. In this circumstance, a portion of the operating system provides for the capture of the metadata from the variety of different programs even though the programs have not been designed to provide or capture metadata. For those programs which do allow a user to create metadata for a particular document, certain embodiments of the present invention may allow the exporting back of captured metadata back into data files for applications which maintain metadata about their data files.

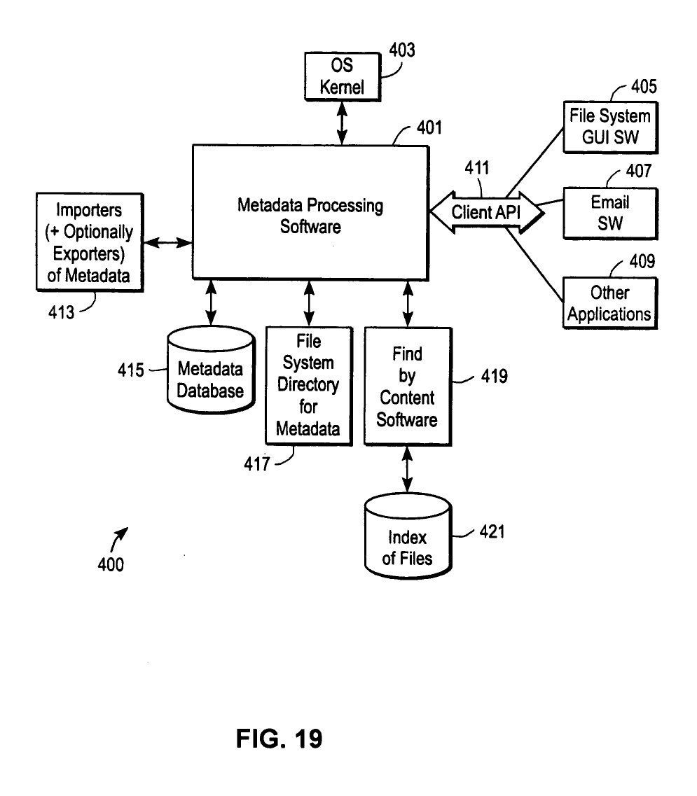

The method of FIG. 17 allows information about a variety of different files created by a variety of different application programs to be accessible by a system wide searching facility, which is similar to the way in which prior art versions of the Finder or Windows Explorer can search for file names, dates of creation, etc. across a variety of different application programs. Thus, the metadata for a variety of different files created by a variety of different application programs can be accessed through an extension of an operating system, and an example of such an extension is shown in FIG. 19 as a metadata processing software which interacts with other components of the system and will be described further below.

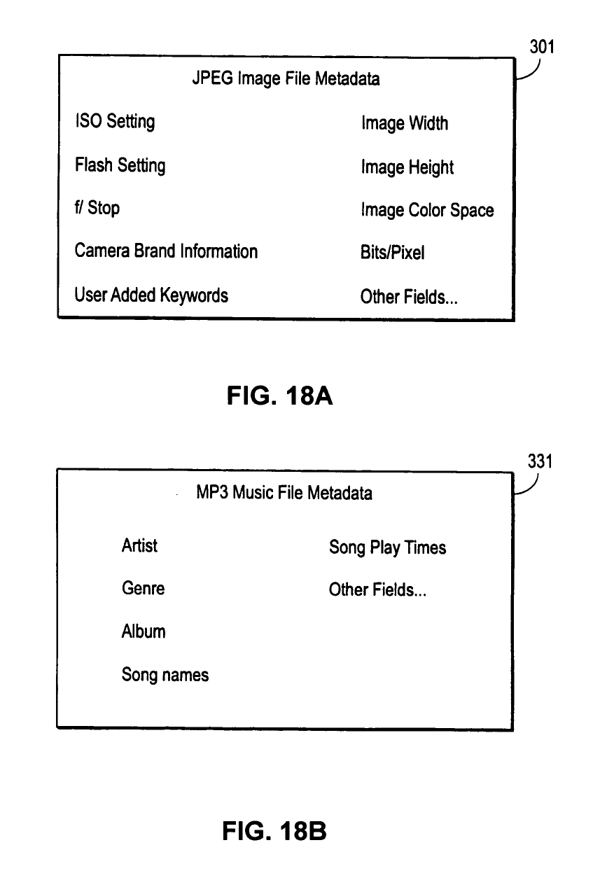

FIGS. 18A and 18B show two different metadata formats for two different types of data files. Note that there may be no overlap in any of the fields; in other words, no field in one type of metadata is the same as any field in the other type of metadata. Metadata format 301 may be used for an image file such as a JPEG image file. This metadata may include information such as the image's width, the image's height, the image's color space, the number of bits per pixel, the ISO setting, the flash setting, the F/stop of the camera, the brand name of the camera which took the image, user added keywords and other fields, such as a field which uniquely identifies the particular file, which identification is persistent through modifications of the file. Metadata format 331 shown in FIG. 18B may be used for a music file such as an MP3 music file. The data in this metadata format may include an identification of the artist, the genre of the music, the name of the album, song names in the album or the song name of the particular file, song play times or the song play time of a particular song and other fields, such as a persistent file ID number which identifies the particular MP3 file from which the metadata was captured. Other types of fields may also be used. The following chart shows examples of the various fields which may be used in metadata for various types of files.

| | | | | | | | | | Copied | |
|---|---|---|---|---|---|---|---|---|---|---|
| Item | Parent in | | | | Multi- | | User | | with | App |
| name | hierarchy | Attribute name | Description/Notes | CFType | value | Localized | settable | Gettable | copy | viewable |
| Item | n/a | Authors | Who created or | CFString | Yes | No | Yes | Yes | Yes | Address |
| | | | contributed to the | | | | | | | Book |
| | | | contents of this item | | | | | | | |
| | | Comment | A free form text | CFString | No | No | Yes | Yes | Yes | |
| | | | comment | | | | | | | |
| | | ContentType | This is the type that is | CFString | No | ? | No | Yes | Yes | |
| | | | determined by UTI | | | | | | | |
| | | ContentTypes | This is the inheritance | CFString | Yes | ? | No | Yes | Yes | |
| | | | of the UTI system | | | | | | | |
| | | CreatedDate | When was this item | CFDate | No | No | No | Yes | Yes | |
| | | | created | | | | | | | |
| | | DisplayName | The name of the item | CFString | No | Yes | Yes | Yes | Yes | Finder |
| | | | as the user would like | | | | | | | (or |
| | | | to read it. | | | | | | | Launch |
| | | | Very well may be the | | | | | | | Services) |
| | | | file name, but it may | | | | | | | |
| | | | also be the subject of | | | | | | | |
| | | | an e-mail message or | | | | | | | |
| | | | the full name of a | | | | | | | |
| | | | person, for example. | | | | | | | |
| | | Keywords | This is a list words set | CFString | Yes | System- | Yes | Yes | Ask | |
| | | | by the user to identify | | | provided | | | | |
| | | | arbitrary sets of | | | keywords | | | | |
| | | | organization. The scope | | | (if | | | | |
| | | | is determined by the | | | any) | | | | |
| | | | user and can be flexibly | | | | | | | |
| | | | used for any kind of | | | | | | | |
| | | | organization. For | | | | | | | |
| | | | example, Family, | | | | | | | |
| | | | Hawaii, Project X, etc. | | | | | | | |
| | | Contact | A list of contacts that | CFString | Yes | No | Yes | Yes | Ask | Address |
| | | Keywords | are associated with this | | | | | | | Book |
| | | | document, beyond what | | | | | | | |
| | | | is captured as Author. | | | | | | | |
| | | | This may be a person | | | | | | | |
| | | | who's in the picture or a | | | | | | | |
| | | | document about a | | | | | | | |
| | | | person or contact | | | | | | | |
| | | | (performance review, | | | | | | | |
| | | | contract) | | | | | | | |
| | | ModifiedDate | When this item was last | CFDate | No | No | No | Yes | | |
| | | | modified | | | | | | | |
| | | Rating | A relative rating (0 to 5 | CFNumber | No | n/a | Yes | Yes | | |
| | | | value) on how | | | | | | | |
| | | | important a particular | | | | | | | |
| | | | item is to you, whether | | | | | | | |
| | | | it's a person, file or | | | | | | | |
| | | | message | | | | | | | |
| | | RelatedTos | A list of other items | CFString | Yes | No | Yes | Yes | | |
| | | | that are arbitrarily | | | | | | | |
| | | | grouped together. | | | | | | | |
| | | TextContent | An indexed version of | CFString | No | No | No | Yes | | |
| | | | any content text | | | | | | | |
| | | UsedDates | Which days was the | CFDate | Yes | No | No | Yes | | |
| | | | document | | | | | | | |
| | | | opened/viewed/played | | | | | | | |
| Content/ | Item | Copyright | Specifies the owner of | CFString | No | No | Yes | Yes | | |
| Data | | | this content, i.e. | | | | | | | |
| | | | Copyright Apple | | | | | | | |
| | | | Computer, Inc. | | | | | | | |
| | | CreatorApp | Keeps track of the | CFString | No | ? | No | Yes | | |
| | | | application that was | | | | | | | |
| | | | used to create this | | | | | | | |
| | | | document (if it's | | | | | | | |
| | | | known). | | | | | | | |
| | | Languages | The languages that this | CFString | Yes | Yes | Yes | Yes | | |
| | | | document is composed | | | | | | | |
| | | | in (for either text or | | | | | | | |
| | | | audio-based media) | | | | | | | |
| | | ParentalControl | A field that is used to | CFString | No | ? | Yes | Yes | | |
| | | | determine whether this | | | | | | | |
| | | | is kid-friendly content | | | | | | | |
| | | | or not | | | | | | | |
| | | Publishers | The name or a person | CFString | Yes | No | Yes | Yes | | Address |
| | | | or organization that | | | | | | | Book |
| | | | published this content. | | | | | | | |
| | | PublishedDate | The original date that | CFDate | No | No | Yes | Yes | | |
| | | | this content was | | | | | | | |
| | | | published (if it was), | | | | | | | |
| | | | independent of created | | | | | | | |
| | | | date. | | | | | | | |
| | | Reviewers | A list of contacts who | CFString | Yes | No | Yes | Yes | | Address |
| | | | have reviewed the | | | | | | | Book |
| | | | contents of this file. | | | | | | | |
| | | | This would have to be | | | | | | | |
| | | | set explicitly by an | | | | | | | |
| | | | application. | | | | | | | |
| | | ReviewStatus | Free form text that used | CFString | No | ? | Yes | Yes | | |
| | | | to specify where the | | | | | | | |
| | | | document is in any | | | | | | | |
| | | | arbitrary review | | | | | | | |
| | | | process | | | | | | | |
| | | TimeEdited | Total time spent editing | CFDate | No | No | No | Yes | | |
| | | | document | | | | | | | |
| | | WhereTos | Where did this go to, | CFString | Yes | System- | ? | Yes | | |
| | | | eg. CD, printed, | | | provided | | | | |
| | | | backedup | | | words | | | | |
| | | | | | | only (if | | | | |
| | | | | | | any) | | | | |
| | | WhereFroms | Where did this come | CFString | Yes | System- | ? | Yes | | |
| | | | from, e.g. camera, | | | provided | | | | |
| | | | email, web download, | | | words | | | | |
| | | | CD | | | only (if | | | | |
| | | | | | | any) | | | | |
| Image | Data | BitsPerSample | What is the bit depth of | CFNumber | No | | | Yes | | |
| | | | the image (8-bit, 16-bit, | | | | | | | |
| | | | etc.) | | | | | | | |
| | | ColorSpace | What color space | CFString | No | | | Yes | | ColorSync |
| | | | model is this document | | | | | | | Utility? |
| | | | following | | | | | | | |
| | | ImageHeight | The height of the image | CFNumber | No | | | Yes | | |
| | | | in pixels | | | | | | | |
| | | ImageWidth | The width of the image | CFNumber | No | | | Yes | | |
| | | | in pixels | | | | | | | |
| | | ProfileName | The name of the color | CFString | No | | | Yes | | ColorSync |
| | | | profile used with for | | | | | | | Utility? |
| | | | image | | | | | | | |
| | | ResolutionWidth | Resolution width of | CFNumber | No | | | Yes | | |
| | | | this image (i.e. dpi | | | | | | | |
| | | | from a scanner) | | | | | | | |
| | | ResolutionHeight | Resolution height of | CFNumber | No | | | Yes | | |
| | | | this image (i.e. dpi | | | | | | | |
| | | | from a scanner) | | | | | | | |
| | | LayerNames | For image formats that | CFString | Yes | | | Yes | | |
| | | | contain “named” layers | | | | | | | |
| | | | (e.g. Photoshop files) | | | | | | | |
| | | Aperture | The f-stop rating of the | CFNumber | No | | | Yes | | |
| | | | camera when the image | | | | | | | |
| | | | was taken | | | | | | | |
| | | CameraMake | The make of the | CFString | No | Yes | | Yes | | |
| | | | camera that was used to | | | | | | | |
| | | | acquire this image (e.g. | | | | | | | |
| | | | Nikon) | | | | | | | |
| | | CameraModel | The model of the | CFString | No | Yes | | Yes | | |
| | | | camera used to acquire | | | | | | | |
| | | | this image (Coolpix | | | | | | | |
| | | | 5700) | | | | | | | |
| | | DateTimeOriginal | Date/time the picture | CFDate | No | | | Yes | | |
| | | | was taken | | | | | | | |
| | | ExposureMode | Mode that was used for | CFString | No | | | Yes | | |
| | | | the exposure | | | | | | | |
| | | ExposureTime | Time that the lens was | CFDate | No | | | Yes | | |
| | | | exposed while taking | | | | | | | |
| | | | the picture | | | | | | | |
| | | Flash | This attribute is | CFNumber | No | | | Yes | | |
| | | | overloaded with | | | | | | | |
| | | | information about red- | | | | | | | |
| | | | eye reduction. This is | | | | | | | |
| | | | not a binary value | | | | | | | |
| | | GPS | Raw value received | CFString | No | | | Yes | | |
| | | | from GPS device | | | | | | | |
| | | | associated with photo | | | | | | | |
| | | | acquisition. It hasn't | | | | | | | |
| | | | necessarily been | | | | | | | |
| | | | translated to a user- | | | | | | | |
| | | | understandable | | | | | | | |
| | | | location. | | | | | | | |
| | | ISOSpeed | The ISO speed the | CFNumber | No | | | Yes | | |
| | | | camera was set to when | | | | | | | |
| | | | the image was acquired | | | | | | | |
| | | Orientation | The orientation of the | CFString | No | | | Yes | | |
| | | | camera when the image | | | | | | | |
| | | | was acquired | | | | | | | |
| | | WhiteBalance | The white balance | CFNumber | No | | | Yes | | |
| | | | setting of the camera | | | | | | | |
| | | | when the picture was | | | | | | | |
| | | | taken | | | | | | | |
| | | EXIFversion | The version of EXIF | CFString | No | | | Yes | | |
| | | | that was used to | | | | | | | |
| | | | generate the metadata | | | | | | | |
| | | | for the image | | | | | | | |
| Time- | Data | AcquisitionSources | The name or type of | CFString | Yes | | | Yes | | |
| based | | | device that used to | | | | | | | |
| | | | acquire the media | | | | | | | |
| | | Codecs | The codecs used to | CFString | Yes | | | Yes | | |
| | | | encode/decode the | | | | | | | |
| | | | media | | | | | | | |
| | | DeliveryType | FastStart or RTSP | CFString | No | | | Yes | | |
| | | Duration | The length of time that | CFNumber | No | | | Yes | | |
| | | | the media lasts | | | | | | | |
| | | Streamable | Whether the content is | CFBoolean | No | | | Yes | | |
| | | | prepared for purposes | | | | | | | |
| | | | of streaming | | | | | | | |
| | | TotalBitRate | The total bit rate (audio | CFNumber | No | | | Yes | | |
| | | | & video combined) of | | | | | | | |
| | | | the media. | | | | | | | |
| | | AudioBitRate | The audio bit rate of | CFNumber | No | | | Yes | | |
| | | | the media | | | | | | | |
| | | AspectRatio | The aspect ratio of the | CFString | No | | | Yes | | |
| | | | video of the media | | | | | | | |
| | | ColorSpace | The color space model | CFString | No | | | Yes | | |
| | | | used for the video | | | | | | | |
| | | | aspect of the media | | | | | | | |
| | | FrameHeight | The frame height in | CFNumber | No | | | Yes | | |
| | | | pixels of the video in | | | | | | | |
| | | | the media | | | | | | | |
| | | FrameWidth | The frame width in | CFNumber | No | | | Yes | | |
| | | | pixels of the video in | | | | | | | |
| | | | the media | | | | | | | |
| | | ProfileName | The name of the color | CFString | No | | | Yes | | |
| | | | profile used on the | | | | | | | |
| | | | video portion of the | | | | | | | |
| | | | media | | | | | | | |
| | | VideoBitRate | The bit rate of the | CFNumber | No | | | Yes | | |
| | | | video aspect of the | | | | | | | |
| | | | media | | | | | | | |
| Text | Data | Subject | The subject of the text. | CFString | No | | | Yes | | |
| | | | This could be metadata | | | | | | | |
| | | | that's supplied with the | | | | | | | |
| | | | text or something | | | | | | | |
| | | | automatically generated | | | | | | | |
| | | | with technologies like | | | | | | | |
| | | | VTWIN | | | | | | | |
| | | PageCount | The number of | CFNumber | No | | | Yes | | |
| | | | printable pages of the | | | | | | | |
| | | | document | | | | | | | |
| | | LineCount | The number of lines in | CFNumber | No | | | Yes | | |
| | | | the document | | | | | | | |
| | | WordCount | The number of words | CFNumber | No | | | Yes | | |
| | | | in the document | | | | | | | |
| | | URL | The URL that will get | CFString | No | | | Yes | | |
| | | | you to this document | | | | | | | |
| | | | (or at least did at one | | | | | | | |
| | | | time). Relevant for | | | | | | | |
| | | | saved HTML | | | | | | | |
| | | | documents, bookmarks, | | | | | | | |
| | | | RSS feeds, etc. | | | | | | | |
| | | PageTitle | The title of a web page. | CFString | No | | | Yes | | |
| | | | Relevant to HTML or | | | | | | | |
| | | | bookmark documents | | | | | | | |
| | | Google | Structure of where this | CFString | No | | | Yes | | |
| | | Hierarchy | page can be found in | | | | | | | |
| | | | the Google hierarchy. | | | | | | | |
| | | | Relevant to HTML or | | | | | | | |
| | | | bookmark documents | | | | | | | |
| Com- | Data | <Abstract> | There are no specific | n/a | n/a | n/a | n/a | n/a | n/a | n/a |
| pound | | | attributes assigned to | | | | | | | |
| document | | | this item. This is to | | | | | | | |
| | | | catch all app-specific | | | | | | | |
| | | | file formats that fall | | | | | | | |
| | | | within Data, but don't | | | | | | | |
| | | | fit into any of the other | | | | | | | |
| | | | types. Typically these | | | | | | | |
| | | | documents have | | | | | | | |
| | | | multiple types of media | | | | | | | |
| | | | embedded within them. | | | | | | | |
| | | | (e.g. P | | | | | | | |
| PDF | Com- | NumberOfPages | The number of | CFNumber | No | | | Yes | | |
| | pound | | printable pages in the | | | | | | | |
| | document | | document | | | | | | | |
| | | PageSize | The size of the page | CFNumber | No | | No | Yes | | |
| | | | stored as points | | | | | | | |
| | | PDFTitle | PDF-specific title | CFString | No | | ? | Yes | | |
| | | | metadata for the | | | | | | | |
| | | | document | | | | | | | |
| | | PDFAuthor | PDF-specific author | CFString | No | | ? | Yes | | Address |
| | | | metadata for the | | | | | | | Book |
| | | | document | | | | | | | |
| | | PDFSubject | PDF-specific subject | CFString | No | | ? | Yes | | |
| | | | metadata for the | | | | | | | |
| | | | document | | | | | | | |
| | | PDFKeywords | PDF-specific keywords | CFString | Yes | | ? | Yes | | |
| | | | metadata for the | | | | | | | |
| | | | document | | | | | | | |
| | | PDFCreated | PDF-specific created | CFDate | No | | ? | Yes | | |
| | | | metadata for the | | | | | | | |
| | | | document | | | | | | | |
| | | PDFModified | PDF-specific modified | CFDate | No | | ? | Yes | | |
| | | | metadata for the | | | | | | | |
| | | | document | | | | | | | |
| | | PDFVersion | PDF-specific version | CFString | No | | ? | Yes | | |
| | | | metadata for the | | | | | | | |
| | | | document | | | | | | | |
| | | SecurityMethod | Method by which this | CFString | No | | | Yes | | |
| | | | document is kept | | | | | | | |
| | | | secure | | | | | | | |
| Presen- | Com- | SlideTitles | A collection of the | CFString | Yes | | | Yes | | |
| tation | pound | | titles on slides | | | | | | | |
| (Keynote) | document | SlideCount | The number of slides | CFString | No | | | Yes | | |
| | | SpeakerNotesContent | The content of all the | CFString | ? | | | Yes | | |
| | | | speaker notes from all | | | | | | | |
| | | | of the slides together | | | | | | | |
| Appli- | Item | Categories | The kind of application | CFString | Yes | | | Yes | | |
| | cation | | this is: productivity, | | | | | | | |
| | | | games, utility, graphics, | | | | | | | |
| | | | etc. A set list that | | | | | | | |
| Message | Item | Recipients | Maps to To and Cc: | CFString | Yes | | | Yes | | Address |
| | | | addresses in a mail | | | | | | | Book |
| | | | message. | | | | | | | |
| | | Priority | The priority of the | CFString | No | | | Yes | | |
| | | | message as set by the | | | | | | | |
| | | | sender | | | | | | | |
| | | AttachmentNames | The list of filenames | CFString | Yes | | | Yes | | |
| | | | that represent | | | | | | | |
| | | | attachments in a | | | | | | | |
| | | | particular message | | | | | | | |
| | | | (should be actionable | | | | | | | |
| | | | within the Finder) | | | | | | | |
| | | Authors | maps to From address | CFString | Yes | No | Yes | Yes | Yes | Address |
| | | | in mail message | | | | | | | Book |
| | | Comment | Not applicable to Mail | CFString | No | No | Yes | Yes | Yes | |
| | | | right now (should we | | | | | | | |
| | | | consider?) | | | | | | | |
| | | ContentType | | CFString | No | | No | Yes | Yes | |
| | | ContentTypes | | CFString | Yes | | No | Yes | Yes | |
| | | CreatedDate | When was this message | CFDate | No | No | No | Yes | Yes | |
| | | | was sent or received | | | | | | | |
| | | DisplayName | Subject of the message | CFString | No | Yes | Yes | Yes | Yes | |
| | | Keywords | There will be a way to | CFString | Yes | System- | Yes | Yes | Ask | |
| | | | set keywords within | | | provided | | | | |
| | | | Mail | | | keywords | | | | |
| | | | | | | (if | | | | |
| | | | | | | any) | | | | |
| | | Contact | Could be where | CFString | Yes | No | Yes | Yes | Ask | Address |
| | | Keywords | recipients are held | | | | | | | Book |
| | | ModifiedDate | Not applicable | CFDate | No | No | No | Yes | | |
| | | Rating | A relative rating (0 to 5 | CFNumber | No | n/a | Yes | Yes | | |
| | | | stars) on how important | | | | | | | |
| | | | a particular message is | | | | | | | |
| | | | to you (separate from a | | | | | | | |
| | | | message's Priority) | | | | | | | |
| | | RelatedTos | Potentially threaded | CFString | Yes | No | Yes | Yes | | |
| | | | messages could be put | | | | | | | |
| | | | into this category | | | | | | | |
| | | TextContent | An indexed version of | CFString | No | No | No | Yes | | |
| | | | the mail message | | | | | | | |
| | | UsedDates | The day/time in which | CFDate | Yes | No | No | Yes | | |
| | | | the mail message was | | | | | | | |
| | | | viewed/read | | | | | | | |
| Contact | Item | Company | The company that this | CFString | No | | | Yes | | Address |
| | | | contact is an employee | | | | | | | Book |
| | | | of | | | | | | | |
| | | E-mails | A list of e-mail | CFString | Yes | | | Yes | | Mail |
| | | | addresses that this | | | | | | | |
| | | | contact has | | | | | | | |
| | | IMs | A list of instant | CFString | Yes | | | Yes | | iChat |
| | | | message handles this | | | | | | | |
| | | | contact has | | | | | | | |
| | | Phones | A list of phone | CFString | Yes | | | | | |
| | | | numbers that relate to | | | | | | | |
| | | | this contact | | | | | | | |
| | | Addresses | A list of physical | CFString | Yes | | | | | |
| | | | addresses that relate to | | | | | | | |
| | | | this person | | | | | | | |
| | | Authors | the name of the owner | CFString | Yes | No | Yes | Yes | Yes | Address |
| | | | of the Address Book | | | | | | | Book |
| | | | (current user name) | | | | | | | |
| | | Comment | | CFString | No | No | Yes | Yes | Yes | |
| | | ContentType | | CFString | No | | No | Yes | Yes | |
| | | ContentTypes | | CFString | Yes | | No | Yes | Yes | |
| | | CreatedDate | date the user entered | CFDate | No | No | No | Yes | Yes | |
| | | | this into his | | | | | | | |
| | | | AddressBook (either | | | | | | | |
| | | | through import or | | | | | | | |
| | | | direct entry) | | | | | | | |
| | | DisplayName | Composite name of | CFString | No | Yes | Yes | Yes | Yes | |
| | | | contact (First Name, | | | | | | | |
| | | | Last Name) | | | | | | | |
| | | Keywords | There will be a way to | CFString | Yes | System- | Yes | Yes | Ask | |
| | | | set keywords within | | | provided | | | | |
| | | | Address Book | | | keywords | | | | |
| | | | | | | (if any) | | | | |
| | | Contact | | CFString | Yes | No | Yes | Yes | Ask | Address |
| | | Keywords | | | | | | | | Book |
| | | ModifiedDate | Last time this contact | CFDate | No | No | No | Yes | | |
| | | | entry was modified | | | | | | | |
| | | Rating | A relative rating (0 to 5 | CFNumber | No | n/a | Yes | Yes | | |
| | | | stars) on how important | | | | | | | |
| | | | a particular contact is | | | | | | | |
| | | | to you (separate from a | | | | | | | |
| | | | message's Priority) | | | | | | | |
| | | RelatedTos | (potentially could be | CFString | Yes | No | Yes | Yes | | |
| | | | used to associate | | | | | | | |
| | | | people from the same | | | | | | | |
| | | | company or family) | | | | | | | |
| | | TextContent | An indexed version of | CFString | No | No | No | Yes | | |
| | | | the Notes section | | | | | | | |
| | | UsedDates | The day/time in which | CFDate | Yes | No | No | Yes | | |
| | | | the contact entry was | | | | | | | |
| | | | viewed in Address | | | | | | | |
| | | | Book | | | | | | | |
| Meeting | Item | Body | text, rich text or | CFString | No | | | Yes | | |
| (T BD) | | | document that | | | | | | | |
| | | | represents the full | | | | | | | |
| | | | content of the event | | | | | | | |
| | | Description | text describing the | CFString | No | | | Yes | | |
| | | | event | | | | | | | |
| | | EventTimes | time/date the event | CFDate | Yes | | | Yes | | |
| | | | starts | | | | | | | |
| | | Duration | The length of time that | CFNumber | No | | | Yes | | |
| | | | the meeting lasts | | | | | | | |
| | | Invitees | The list of people who | CFString | Yes | | | Yes | | Address |
| | | | are invited to the | | | | | | | Book |
| | | | meeting | | | | | | | |
| | | Location | The name of the | CFString | No | | | Yes | | |
| | | | location where the | | | | | | | |
| | | | meeting is taking place | | | | | | | |

One particular field which may be useful in the various metadata formats would be a field which includes an identifier of a plug in or other software element which may be used to capture metadata from a data file and/or export metadata back to the creator application.

Various different software architectures may be used to implement the functions and operations described herein. The following discussion provides one example of such an architecture, but it will be understood that alternative architectures may also be employed to achieve the same or similar results. The software architecture shown in FIG. 19 is an example which is based upon the Macintosh operating system. The architecture 400 includes a metadata processing software 401 and an operating system (OS) kernel 403 which is operatively coupled to the metadata processing software 401 for a notification mechanism which is described below. The metadata processing software 401 is also coupled to other software programs such as a file system graphical user interface software 405 (which may be the Finder), an email software 407, and other applications 409. These applications are coupled to the metadata processing software 401 through client application program interface 411 which provide a method for transferring data and commands between the metadata processing software 401 and the software 405, 407, and 409. These commands and data may include search parameters specified by a user as well as commands to perform searches from the user, which parameters and commands are passed to the metadata processing software 401 through the interface 411. The metadata processing software 401 is also coupled to a collection of importers 413 which extract data from various applications. In particular, in one exemplary embodiment, a text importer is used to extract text and other information from word processing or text processing files created by word processing programs such as Microsoft Word, etc. This extracted information is the metadata for a particular file. Other types of importers extract metadata from other types of files, such as image files or music files. In this particular embodiment, a particular importer is selected based upon the type of file which has been created and modified by an application program. For example, if the data file was created by PhotoShop, then an image importer for PhotoShop may be used to input the metadata from a PhotoShop data file into the metadata database 415 through the metadata processing software 401. On the other hand, if the data file is a word processing document, then an importer designed to extract metadata from a word processing document is called upon to extract the metadata from the word processing data file and place it into the metadata database 415 through the metadata processing software 401. Typically, a plurality of different importers may be required in order to handle the plurality of different application programs which are used in a typical computer system. The importers 413 may optionally include a plurality of exporters which are capable of exporting the extracted metadata for particular types of data files back to property sheets or other data components maintained by certain application programs. For example, certain application programs may maintain some metadata for each data file created by the program, but this metadata is only a subset of the metadata extracted by an importer from this type of data file. In this instance, the exporter may export back additional metadata or may simply insert metadata into blank fields of metadata maintained by the application program.

The software architecture 400 also includes a file system directory 417 for the metadata. This file system directory keeps track of the relationship between the data files and their metadata and keeps track of the location of the metadata object (e.g. a metadata file which corresponds to the data file from which it was extracted) created by each importer. In one exemplary embodiment, the metadata database is maintained as a flat file format as described below, and the file system directory 417 maintains this flat file format. One advantage of a flat file format is that the data is laid out on a storage device as a string of data without references between fields from one metadata file (corresponding to a particular data file) to another metadata file (corresponding to another data file). This arrangement of data will often result in faster retrieval of information from the metadata database 415.

The software architecture 400 of FIG. 19 also includes find by content software 419 which is operatively coupled to a database 421 which includes an index of files. The index of files represents at least a subset of the data files in a storage device and may include all of the data files in a particular storage device (or several storage devices), such as the main hard drive of a computer system. The index of files may be a conventional indexed representation of the content of each document. The find by content software 419 searches for words in that content by searching through the database 421 to see if a particular word exists in any of the data files which have been indexed. The find by content software functionality is available through the metadata processing software 401 which provides the advantage to the user that the user can search concurrently both the index of files in the database 421 (for the content within a file) as well as the metadata for the various data files being searched. The software architecture shown in FIG. 19 may be used to perform the method shown in FIG. 20 or alternative architectures may be used to perform the method of FIG. 20.

The method of FIG. 20 may begin in operation 501 in which a notification of a change for a file is received. This notification may come from the OS kernel 403 which notifies the metadata processing software 401 that a file has been changed. This notification may come from sniffer software elements which detect new or modified files and deletion of files. This change may be the creation of a new file or the modification of an existing file or the deletion of an existing file. The deletion of an existing file causes a special case of the processing method of FIG. 20 and is not shown in FIG. 20. In the case of a deletion, the metadata processing software 401, through the use of the file system directory 417, deletes the metadata file in the metadata database 415 which corresponds to the deleted file. The other types of operations, such as the creation of a new file or the modification of an existing file, causes the processing to proceed from operation 501 to operation 503 in which the type of file which is the subject of the notification is determined. The file may be an Acrobat PDF file or an RTF word processing file or a JPEG image file, etc. In any case, the type of the file is determined in operation 503. This may be performed by receiving from the OS kernel 403 the type of file along with the notification or the metadata processing software 401 may request an identification of the type of file from the file system graphical user interface software 405 or similar software which maintains information about the data file, such as the creator application or parent application of the data file. It will be understood that in one exemplary embodiment, the file system graphical user interface software 405 is the Finder program which operates on the Macintosh operating system. In alternative embodiments, the file system graphical user interface system may be Windows Explorer which operates on Microsoft's Windows operating system. After the type of file has been determined in operation 503, the appropriate capture software (e.g. one of the importers 413) is activated for the determined file type. The importers may be a plug-in for the particular application which created the type of file about which notification is received in operation 501. Once activated, the importer or capture software imports the appropriate metadata (for the particular file type) into the metadata database, such as metadata database 415 as shown in operation 507. Then in operation 509, the metadata is stored in the database. In one exemplary embodiment, it may be stored in a flat file format. Then in operation 511, the metadata processing software 401 receives search parameter inputs and performs a search of the metadata database (and optionally also causes a search of non-metadata sources such as the index of files 421) and causes the results of the search to be displayed in a user interface. This may be performed by exchanging information between one of the applications, such as the software 405 or the software 407 or the other applications 409 and the metadata processing software 401 through the interface 411. For example, the file system software 405 may present a graphical user interface, allowing a user to input search parameters and allowing the user to cause a search to be performed. This information is conveyed through the interface 411 to the metadata processing software 401 which causes a search through the metadata database 415 and also may cause a search through the database 421 of the indexed files in order to search for content within each data file which has been indexed. The results from these searches are provided by the metadata processing software 401 to the requesting application which, in the example given here, was the software 405, but it will be appreciated that other components of software, such as the email software 407, may be used to receive the search inputs and to provide a display of the search results. Various examples of the user interface for inputting search requests and for displaying search results are described herein and shown in the accompanying drawings.

It will be appreciated that the notification, if done through the OS kernel, is a global, system wide notification process such that changes to any file will cause a notification to be sent to the metadata processing software. It will also be appreciated that in alternative embodiments, each application program may itself generate the necessary metadata and provide the metadata directly to a metadata database without the requirement of a notification from an operating system kernel or from the intervention of importers, such as the importers 413. Alternatively, rather than using OS kernel notifications, an embodiment may use software calls from each application to a metadata processing software which receives these calls and then imports the metadata from each file in response to the call.

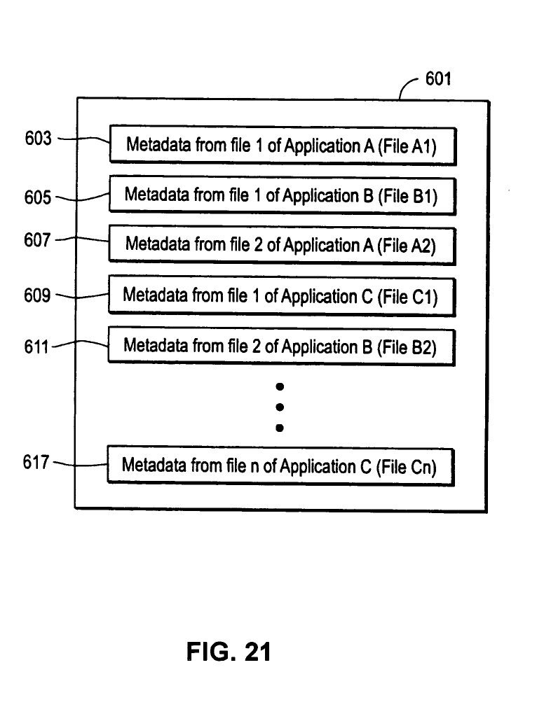

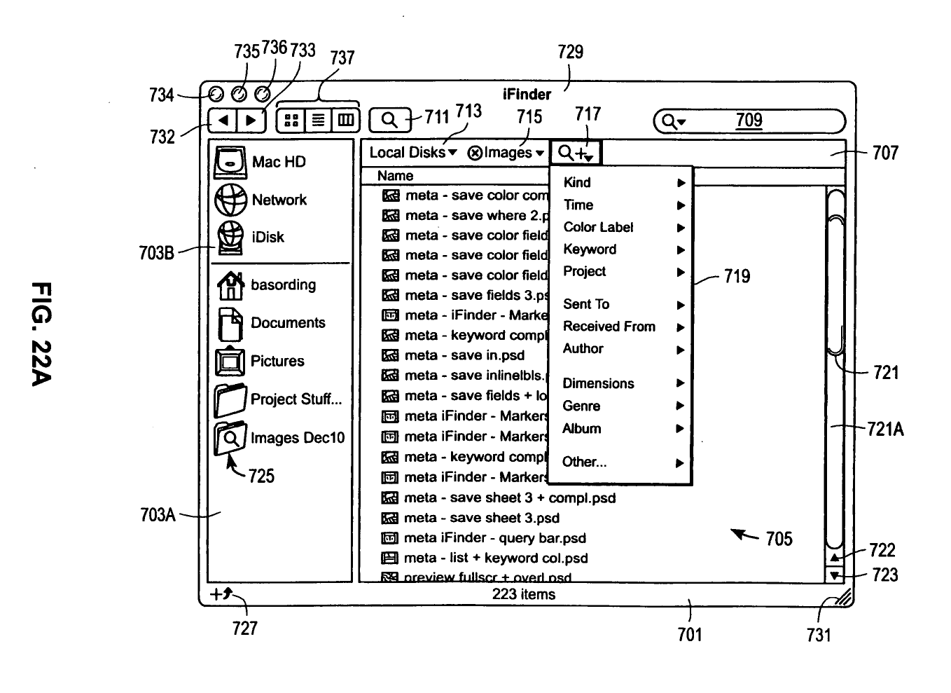

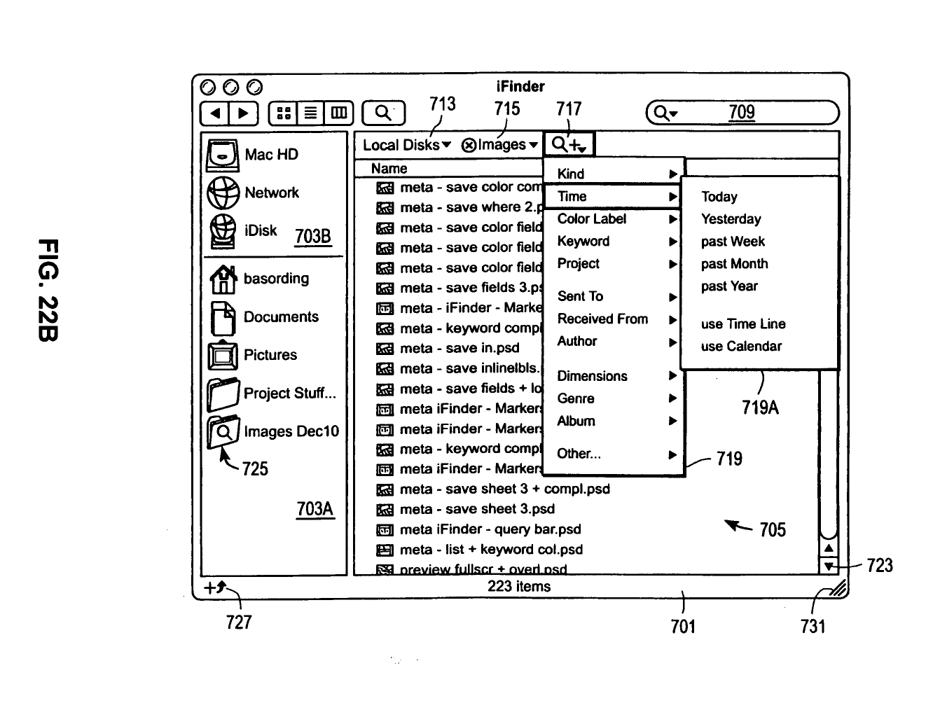

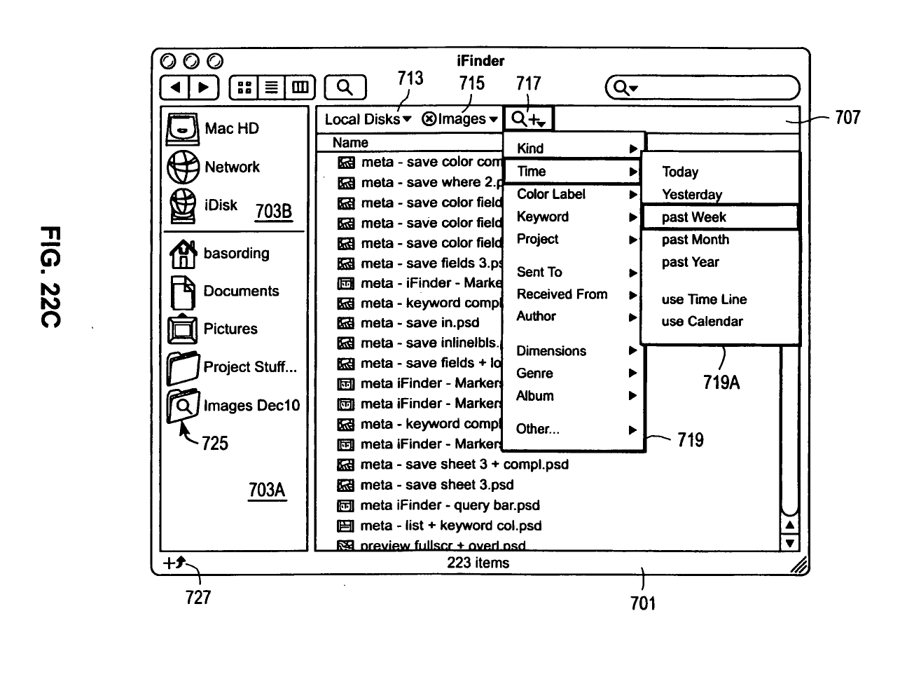

As noted above, the metadata database 415 may be stored in a flat file format in order to improve the speed of retrieval of information in most circumstances. The flat file format may be considered to be a non-B tree, non-hash tree format in which data is not attempted to be organized but is rather stored as a stream of data. Each metadata object or metadata file will itself contain fields, such as the fields shown in the examples of FIGS. 18A and 18B. However, there will typically be no relationship or reference or pointer from one field in one metadata file to the corresponding field (or another field) in the next metadata file or in another metadata file of the same file type. FIG. 21 shows an example of the layout in a flat file format of metadata. The format 601 includes a plurality of metadata files for a corresponding plurality of data files. As shown in FIG. 21, metadata file 603 is metadata from file 1 of application A and may be referred to as metadata file A1. Similarly, metadata file 605 is metadata from file 1 of application B and may be referred to as metadata file B1. Each of these metadata files typically would include fields which are not linked to other fields and which do not contain references or pointers to other fields in other metadata files. It can be seen from FIG. 21 that the metadata database of FIG. 21 includes metadata files from a plurality of different applications (applications A, B, and C) and different files created by each of those applications. Metadata files 607, 609, 611, and 617 are additional metadata files created by applications A, B, and C as shown in FIG. 21.

A flexible query language may be used to search the metadata database in the same way that such query languages are used to search other databases. The data within each metadata file may be packed or even compressed if desirable. As noted above, each metadata file, in certain embodiments, will include a persistent identifier which uniquely identifies its corresponding data file. This identifier remains the same even if the name of the file is changed or the file is modified. This allows for the persistent association between the particular data file and its metadata. User Interface Aspects

Various different examples of user interfaces for inputting search parameters and for displaying search results are provided herein. It will be understood that some features from certain embodiments may be mixed with other embodiments such that hybrid embodiments may result from these combinations. It will be appreciated that certain features may be removed from each of these embodiments and still provide adequate functionality in many instances.

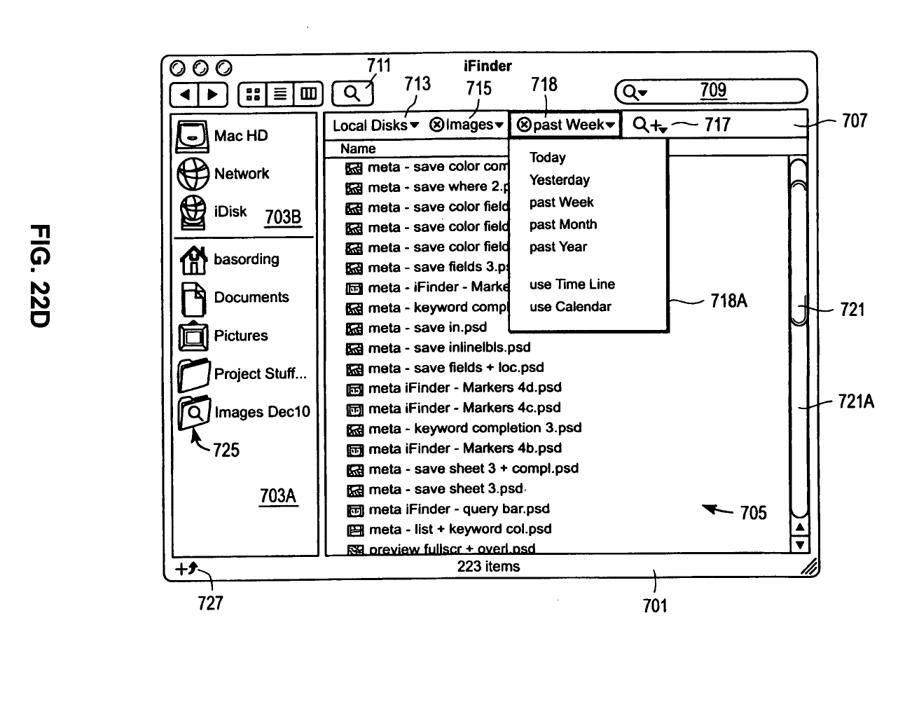

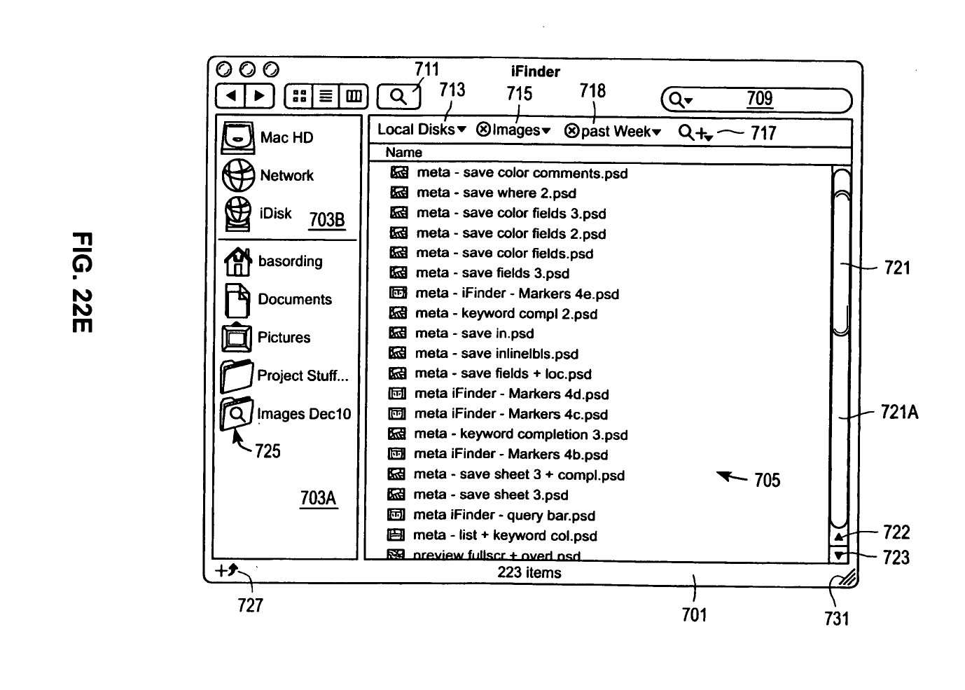

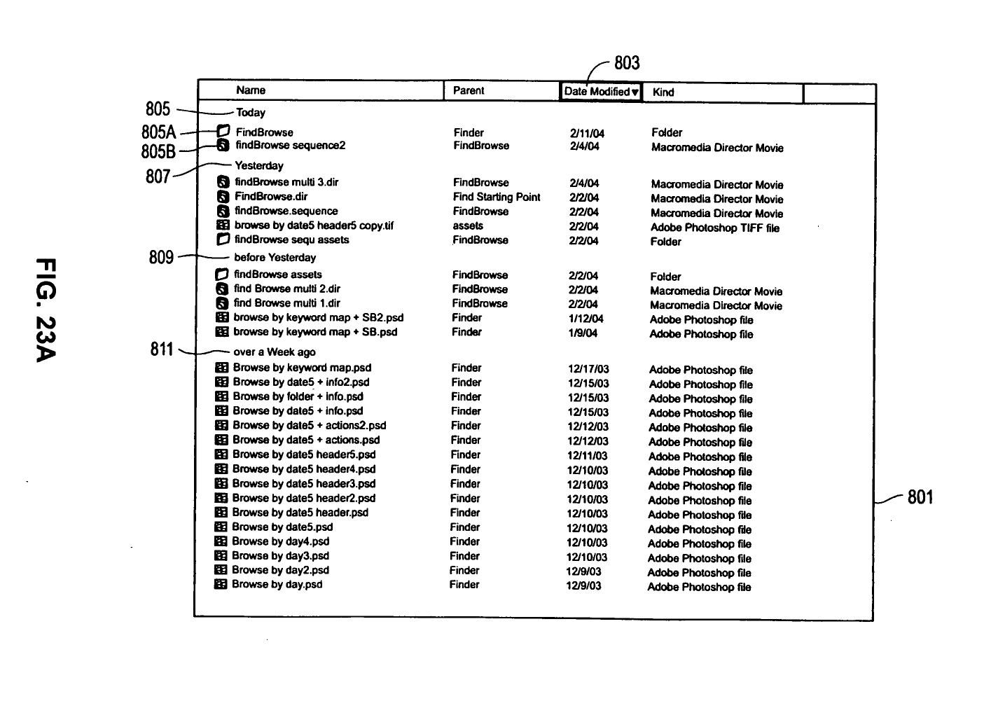

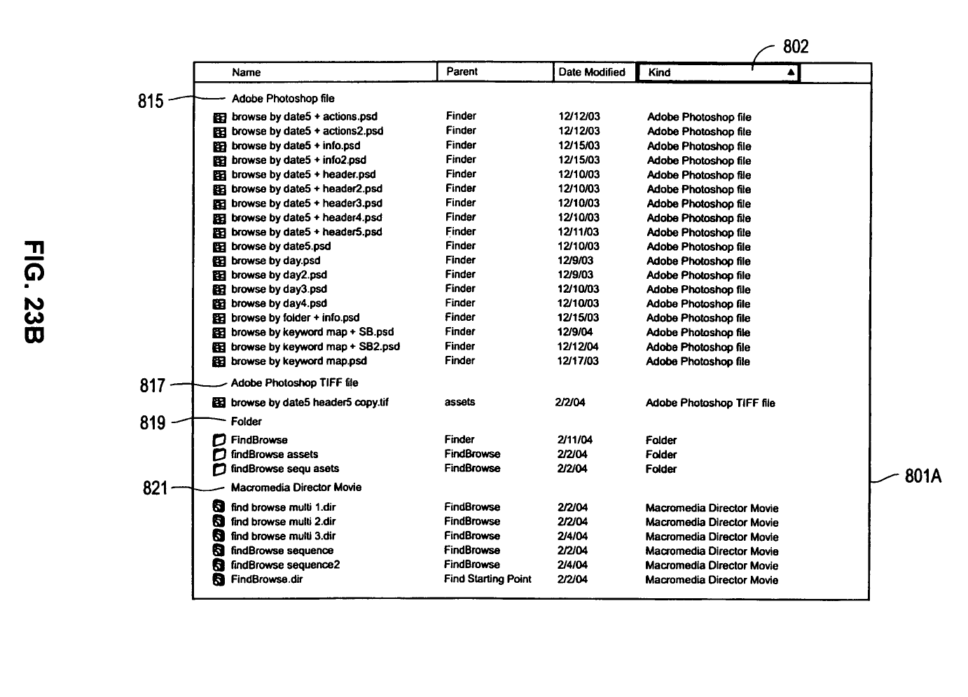

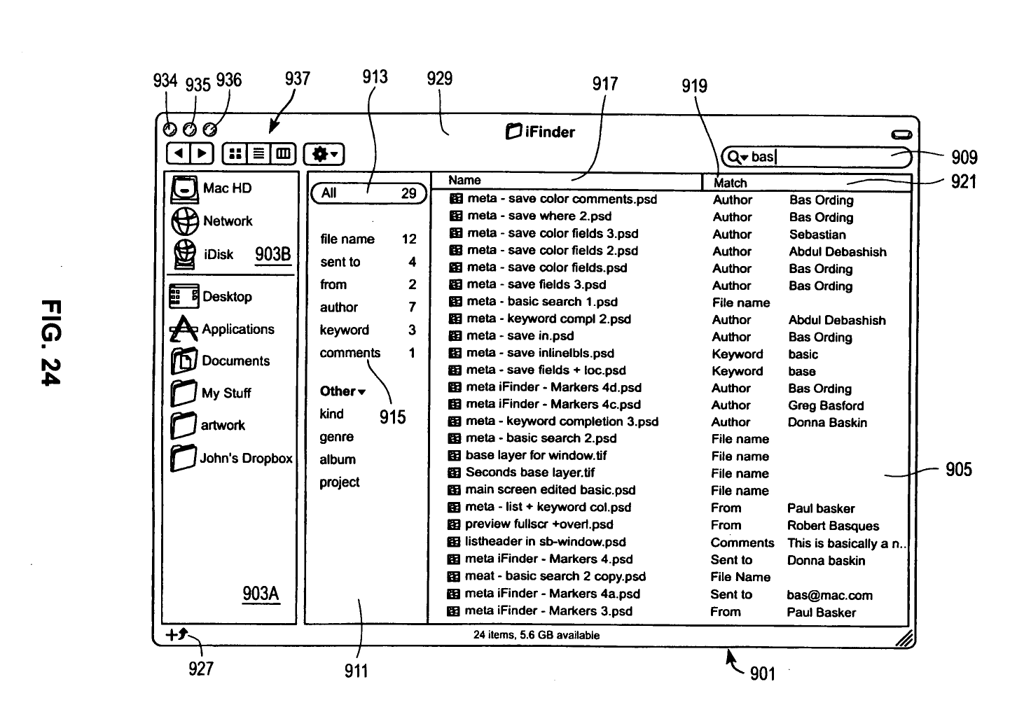

FIG. 22A shows a graphical user interface which is a window which may be displayed on a display device which is coupled to a data processing system such as a computer system. The window 701 includes a side bar having two regions 703A, which is a user-configurable region, and 703B, which is a region which is specified by the data processing system. Further details in connection with these side bar regions may be found in co-pending U.S. patent application Ser. No. 10/877,584 filed Jun. 21, 2004, and entitled “Methods and Apparatuses for Operating a Data Processing System,” by inventors Donald Lindsay and Bas Ording. The window 701 also includes a display region 705 which in this case displays the results of searches requested by the user. The window 701 also includes a search parameter menu bar 707 which includes configurable pull down menus 713, 715, and 717. The window 701 also includes a text entry region 709 which allows a user to enter text as part of the search query or search parameters. The button 711 may be a start search button which a user activates in order to start a search based upon the selected search parameters. Alternatively, the system may perform a search as soon as it receives any search parameter inputs or search queries from the user rather than waiting for a command to begin the search. The window 701 also includes a title bar 729 which may be used in conjunction with a cursor control device to move, in a conventional manner, the window around a desktop which is displayed on a display device. The window 701 also includes a close button 734, a minimize button 735, and a resize button 736 which may be used to close or minimize or resize, respectively, the window. The window 701 also includes a resizing control 731 which allows a user to modify the size of the window on a display device. The window 701 further includes a back button 732 and a forward button 733 which function in a manner which is similar to the back and forward buttons on a web browser, such as Internet Explorer or Safari. The window 701 also includes view controls which include three buttons for selecting three different types of views of the content within the display region 705. When the contents found in a search exceed the available display area of a display region 705, scroll controls, such as scroll controls 721, 722, and 723, appear within the window 701. These may be used in a conventional manner, for example, by dragging the scroll bar 721 within the scroll region 721A using conventional graphical user interface techniques.

The combination of text entry region 709 and the search parameter menu bar allow a user to specify a search query or search parameters. Each of the configurable pull down menus presents a user with a list of options to select from when the user activates the pull down menu. As shown in FIG. 22A, the user has already made a selection from the configurable pull down menu 713 to specify the location of the search, which in this case specifies that the search will occur on the local disks of the computer systems. Configurable pull down menu 715 has also been used by the user to specify the kind of document which is to be searched for, which in this case is an image document as indicated by the configurable pull down menu 715 which indicates “images” as the selected configuration of this menu and hence the search parameter which it specifies. The configurable pull down menu 717, as shown in FIG. 22A, represents an add search parameter pull down menu. This add search parameter pull down menu allows the user to add additional criteria to the search query to further limit the search results. In the embodiment shown in FIG. 22A, each of the search parameters is logically ANDed in a Boolean manner. Thus the current search parameter specified by the user in the state shown in FIG. 22A searches all local disks for all images, and the user is in the middle of the process of selecting another search criteria by having selected the add search criteria pull down menu 717, resulting in the display of the pull down menu 719, which has a plurality of options which may be selected by the user.

FIG. 22B shows the window 701 after the user has caused the selection of the time option within pull down menu 719, thereby causing the display of a submenu 719A which includes a list of possible times which the user may select from. Thus it appears that the user wants to limit the search to all images on all local disks within a certain period of time which is to be specified by making a selection within the submenu 719A.

FIG. 22C shows the window 701 on the display of a data processing system after the user has selected a particular option (in this case “past week”) from the submenu 719A. If the user accepts this selection, then the display shown in FIG. 22D results in which the configurable pull down menu 718 is displayed showing that the user has selected as part of the search criteria files that have been created or modified in the past week. It can be seen from FIG. 22D that the user can change the particular time selected from this pull down menu 718 by selecting another time period within the pull down menu 718A shown in FIG. 22D. Note that the configurable pull down menu 717, which represents an add search parameter menu, has now moved to the right of the configurable pull down menu 718. The user may add further search parameters by pressing or otherwise activating the configurable pull down menu 717 from the search parameter menu bar 707. If the user decides that the past week is the proper search criteria in the time category, then the user may release the pull down menu 718A from being displayed in a variety of different ways (e.g. the user may release the mouse button which was being depressed to keep the pull down menu 718A on the display). Upon releasing or otherwise dismissing the pull down menu 718A, the resulting window 701 shown in FIG. 22E then appears. There are several aspects of this user interface shown in FIG. 22A-22E which are worthy of being noted. The search parameters or search query is specified within the same window as the display of the search results. This allows the user to look at a single location or window to understand the search parameters and how they affected the displayed search results, and may make it easier for a user to alter or improve the search parameters in order to find one or more files. The configurable pull down menus, such as the add search parameter pull down menu, includes hierarchical pull down menus. An example of this is shown in FIG. 22B in which the selection of the time criteria from the pull down menu 717 results in the display of another menu, in this case a submenu 719A which may be selected from by the user. This allows for a compact presentation of the various search parameters while keeping the initial complexity (e.g. without submenus being displayed) at a lower level. Another useful aspect of the user interface shown in FIG. 22A-22E is the ability to reconfigure pull down menus which have previously been configured. Thus, for example, the configurable pull down menu 713 currently specifies the location of the search (in this case, all local disks), however, this may be modified by selecting the pull down region associated with the configurable pull down menu 713, causing the display of a menu of options indicating alternative locations which may be selected by the user. This can also be seen in FIG. 22D in which the past week option has been selected by the user (as indicated by “past week” being in the search parameter menu bar 707), but a menu of options shown in the pull down menu 718A allows the user to change the selected time from the “past week” to some other time criteria. Another useful aspect of this user interface is the ability to continue adding various search criteria by using the add search criteria pull down menu 717 and selecting a new criteria.

It will also be appreciated that the various options in the pull down menus may depend upon the fields within a particular type of metadata file. For example, the selection of “images” to be searched may cause the various fields present in the metadata for an image type file to appear in one or more pull down menus, allowing the user to search within one or more of those fields for that particular type of file. Other fields which do not apply to “images” types of files may not appear in these menus in order reduce the complexity of the menus and to prevent user confusion.

Another feature of the present invention is shown in FIGS. 22A-22E. In particular, the side bar region 703A, which is the user-configurable portion of the side bar, includes a representation of a folder 725 which represents the search results obtained from a particular search, which search results may be static or they may be dynamic in that, in certain instances, the search can be performed again to obtain results based on the current files in the system. The folder 725 in the example shown in FIGS. 22A-22E represents a search on a local disk for all images done on December 10th. By selecting this folder in the side bar region 703A, the user may cause the display in the display region 705 of the results of that search. In this way, a user may retrieve a search result automatically by saving the search result into the side bar region 703A. One mechanism for causing a search result or a search query to be saved into the side bar region 703A is to select the add folder button 727 which appears in the bottom portion of the window 701. By selecting this button, the current search result or search query is saved as a list of files and other objects retrieved in the current search result. In the case where the search query is saved for later use rather than the saving of a search result, then the current search query is saved for re-use at a later time in order to find files which match the search query at that later time. The user may select between these two functionalities (saving a search result or saving a search query) by the selection of a command which is not shown.

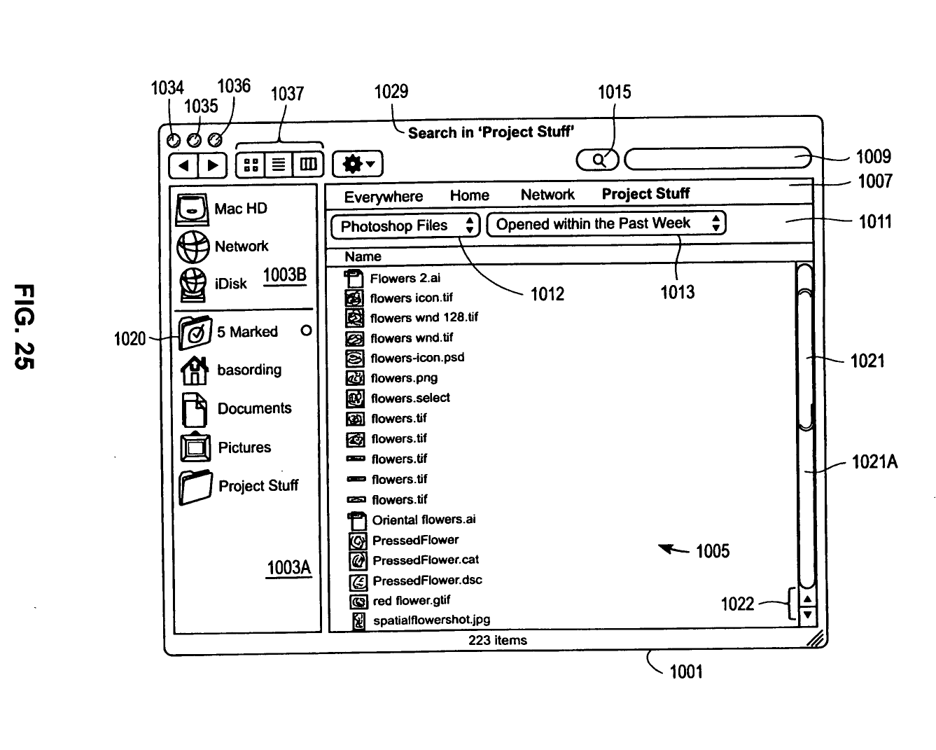

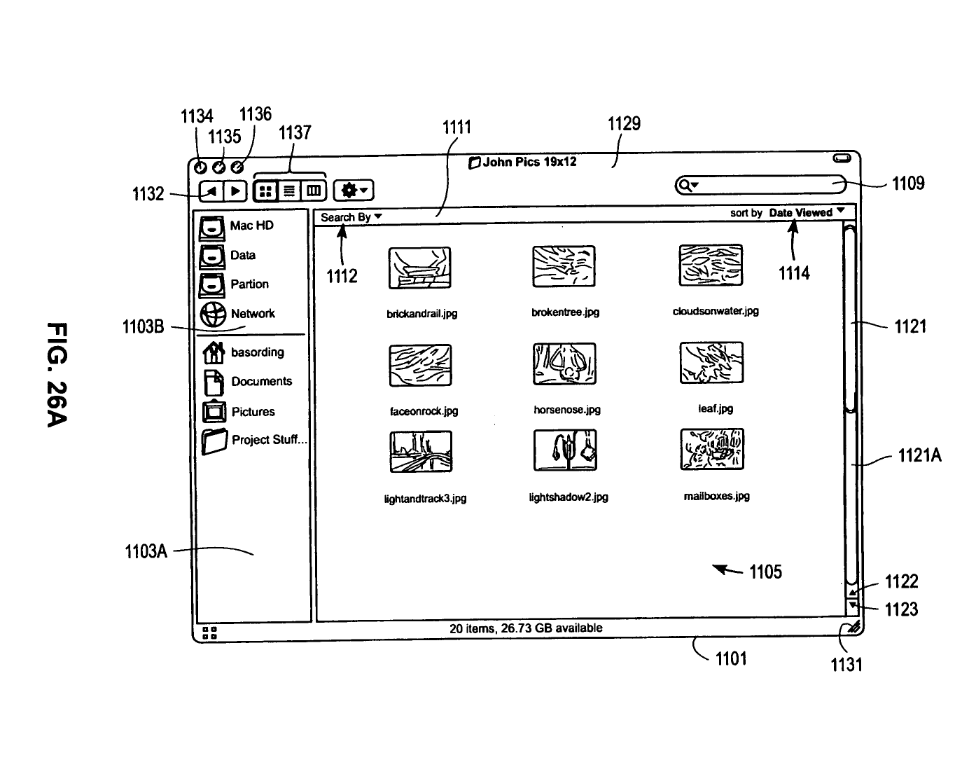

FIGS. 23A and 23B show another aspect of a user interface feature which may be used with certain embodiments of the present invention. The window 801 of FIG. 23A represents a display of the search results which may be obtained as a result of using one of the various different embodiments of the present invention. The search results are separated into categories which are separated by headers 805, 807, 809, and 811 which in this case represent periods of time. This particular segmentation with headers was selected by the user's selecting the heading “date modified” using the date modified button 803 at the top of the window 801. An alternative selection of the kind category by selecting the button 802 at the top of the window 801A shown in FIG. 23B results in a different formatting of the search results which are now categorized by headers which indicate the types of files which were retrieved in the search and are separated by the headings 815, 817, 819, and 821 as shown in FIG. 23B. The use of these headings in the search results display allows the user to quickly scan through the search results in order to find the file.

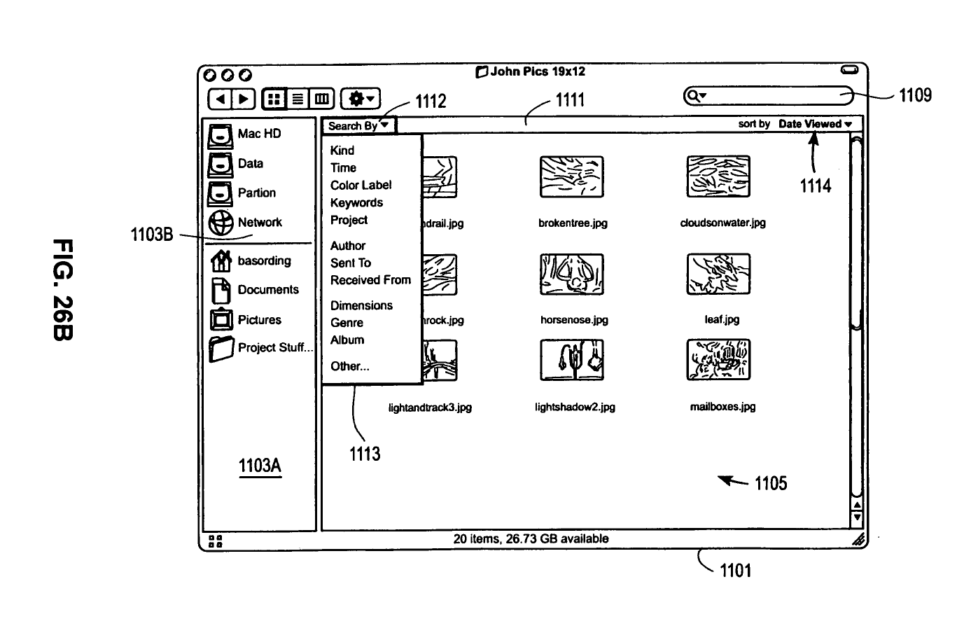

FIG. 24 shows another aspect of the present invention that is illustrated as part of the window 901 shown in FIG. 24. This window includes a display region 905 which shows the results of the search and the window also includes two side bar regions 903A and 903B, where the side bar region 903A is the user-configurable portion and the side bar region 903B is the system controlled portion. A folder add button 927 may be selected by the user to cause the addition of a search result or a search query to be added to the user-configurable portion of the side bar. The window 901 also includes conventional window controls such as a title bar or region 929 which may be used to move the window around a display and view select buttons 937 and maximize, minimize and resize buttons 934, 935, and 936 respectively. The window 901 shows a particular manner in which the results of a text-based search may be displayed. A text entry region 909 is used to enter text for searching. This text may be used to search through the metadata files or the indexed files or a combination of both. The display region 905 shows the results of a search for text and includes at least two columns, 917 and 919, which provide the name of the file that was found and the basis for the match. As shown in column 919, the basis for the match may be the author field or a file name or a key word or comments or other data fields contained in metadata that was searched. The column 921 shows the text that was found which matches the search parameter typed into the text entry field 909. Another column 911 provides additional information with respect to the search results. In particular, this column includes the number of matches for each particular type of category or field as well as the total number of matches indicated in the entry 913. Thus, for example, the total number of matches found for the comments field is only 1, while other fields have a higher number of matches.

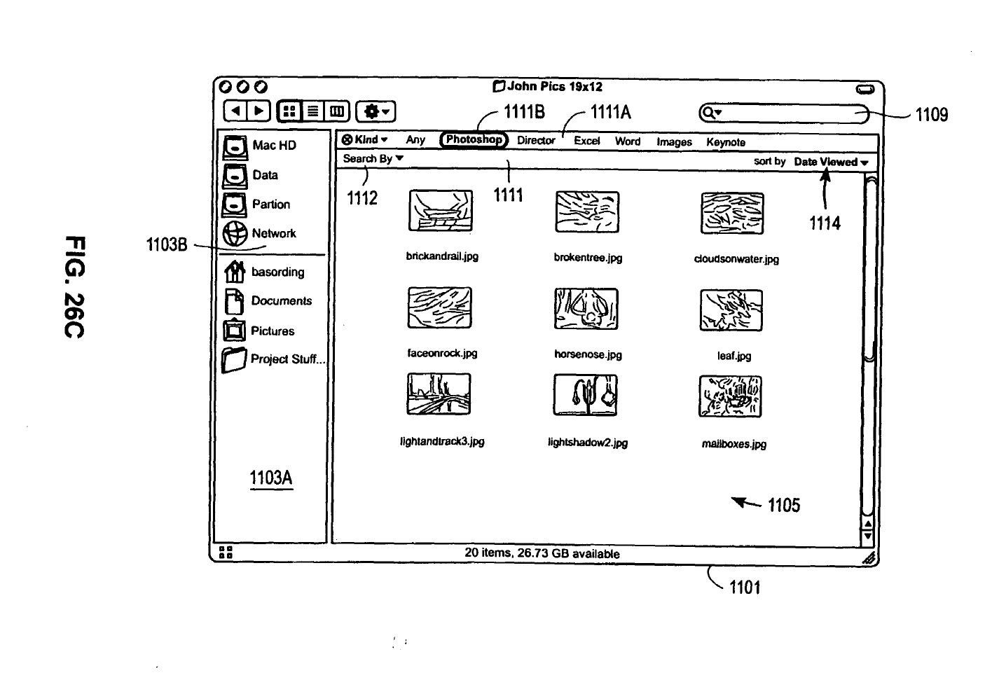

FIG. 25 shows certain other aspects of some embodiments of the present invention. Window 1001 is another search result window which includes various fields and menus for a user to select various search parameters or form a search query. The window 1001 includes a display region 1005 which may be used to display the results of a search and a user-configurable side bar portion 1003A and a system specified side bar portion 1003B. In addition, the window 1001 includes conventional scrolling controls such as controls 1021 and 1022 and 1021A. The window further includes conventional controls such as a title bar 1029 which may be used to move the window and view control buttons 1037 and maximize, minimize, and resize buttons 1034, 1035, and 1036. A start search button 1015 is near a text entry region 1009. A first search parameter menu bar 1007 is displayed adjacent to a second search parameter bar 1011. The first search parameter search bar 1007 allows a user to specify the location for a particular search while two menu pull down controls in the second search parameter menu bar 1011 allow the user to specify the type of file using the pull down menu 1012 and the time the file was created or last modified using the menu 1013.

The window 1001 includes an additional feature which may be very useful while analyzing a search result. A user may select individual files from within the display region 1005 and associate them together as one collection. Each file may be individually marked using a specific command (e.g. pressing the right button on a mouse and selecting a command from a menu which appears on the screen, which command may be “add selection to current group”) or similar such commands. By individually selecting such files or by selecting a group of files at once, the user may associate this group of files into a selected group or a “marked” group and this association may be used to perform a common action on all of the files in the group (e.g. print each file or view each file in a viewer window or move each file to a new or existing folder, etc.). A representation of this marked group appears as a folder in the user-configurable portion 1003A. An example of such a folder is the folder 1020 shown in the user-configurable portion 1003A. By selecting this folder (e.g. by positioning a cursor over the folder 1020 and pressing and releasing a mouse button or by pressing another button) the user, as a result of this selection, will cause the display within the display region 1005 of the files which have been grouped together or marked. Alternatively, a separate window may appear showing only the items which have been marked or grouped. This association or grouping may be merely temporary or it may be made permanent by retaining a list of all the files which have been grouped and by keeping a folder 1020 or other representations of the grouping within the user-configurable side bar, such as the side bar 1003A. Certain embodiments may allow multiple, different groupings to exist at the same time, and each of these groupings or associations may be merely temporary (e.g. they exist only while the search results window is displayed), or they may be made permanent by retaining a list of all the files which have been grouped within each separate group. It will be appreciated that the files within each group may have been created from different applications. As noted above, one of the groupings may be selected and then a user may select a command which performs a common action (e.g. print or view or move or delete) on all of the files within the selected group.

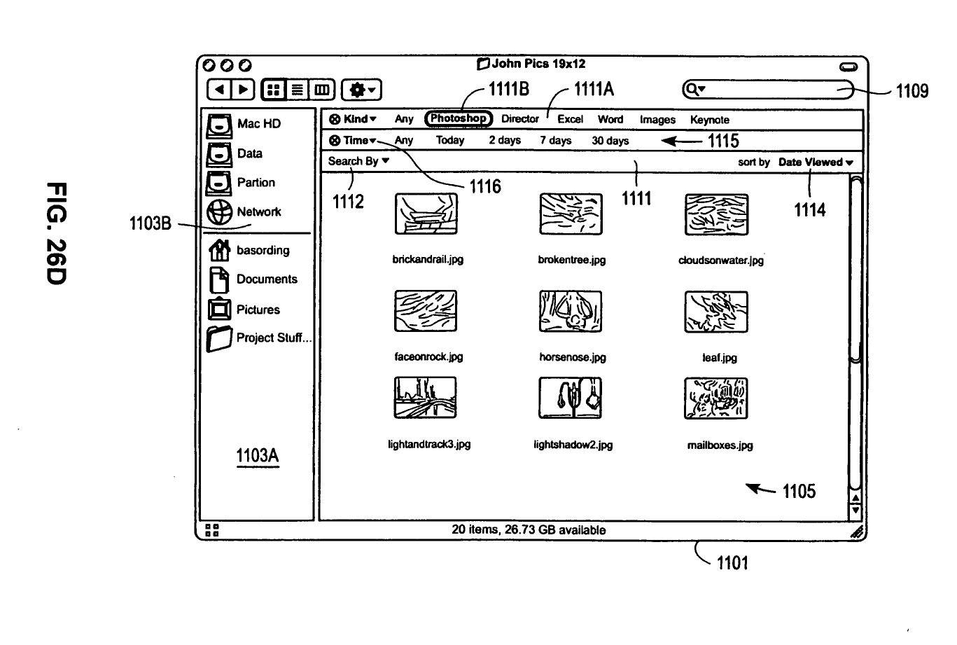

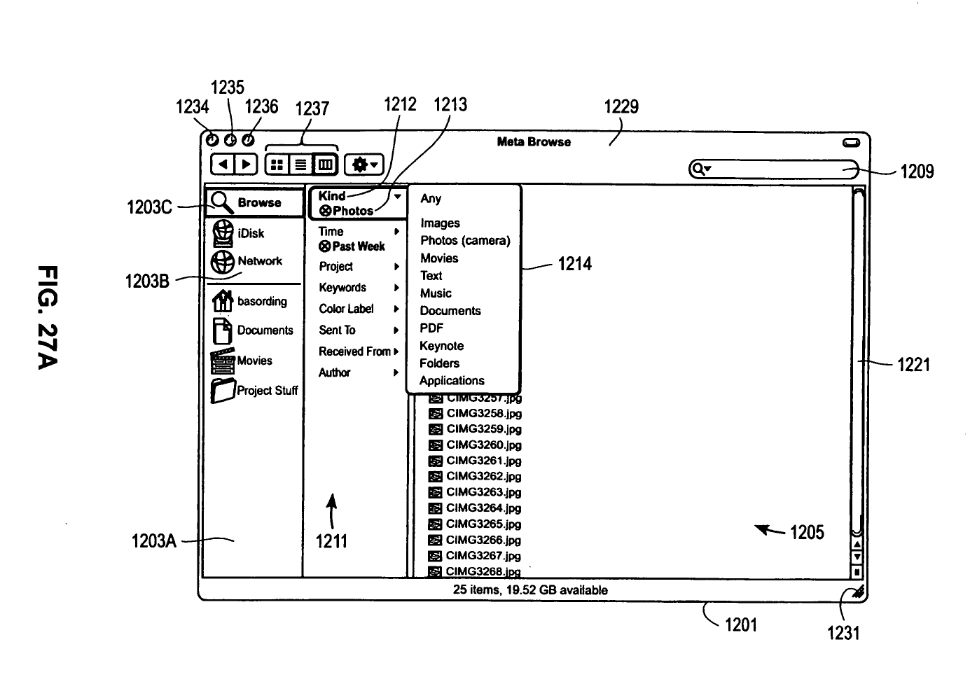

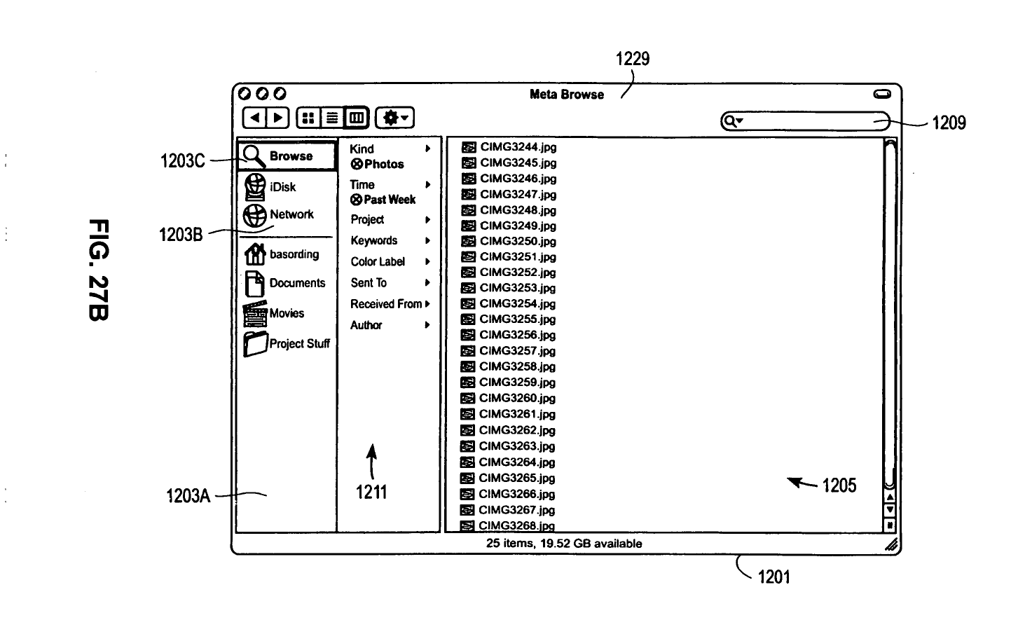

FIGS. 26A, 26B, 26C, and 26D show an alternative user interface for allowing a user to input search queries or search parameters. The user interface shown in these figures appears within the window 1101 which includes a user-configurable side bar region 1103A and a system specified side bar region 1103B. The window 1101 also includes traditional window controls such as a window resizing control 1131 which may be dragged in a conventional graphical user interface manner to resize the window, and the window further includes scrolling controls such as controls 1121, 1122, and 1123. The scrolling control 1121 may, for example, be dragged within the scrolling region 1121A or a scroll wheel on a mouse or other input device may be used to cause scrolling within a display region 1105. Further, traditional window controls include the title bar 1129 which may be used to move the window around a desktop which is displayed on a display device of a computer system and the window also includes view buttons 1137 as well as close, minimize, and resize buttons 1134, 1135 and 1136. A back and forward button, such as the back button 1132, are also provided to allow the user to move back and forth in a manner which is similar to the back and forth commands in a web browser. The window 1101 includes a search parameter menu bar 1111 which includes a “search by” pull down menu 1112 and a “sort by” pull down menu 1114. The “search by” pull down menu 1112 allows a user to specify the particular search parameter by selecting from the options which appear in the pull down menu once it is activated as shown in FIG. 26B. In particular, the pull down menu 1113 shows one example of a pull down menu when the “search by” pull down menu 1112 has been activated. The “sort by” pull down menu 1114 allows a user to specify how the search results are displayed within a display region 1105. In the example shown in FIGS. 26A-26D a user has used the “sort by” pull down menu 1114 to select the “date viewed” criteria to sort the search results by. It should also be noted that the user may change the type of view of the search results by selecting one of the three view buttons 1137. For example, a user may select an icon view which is the currently selected button among the view buttons 1137, or the user may select a list view or a column view.

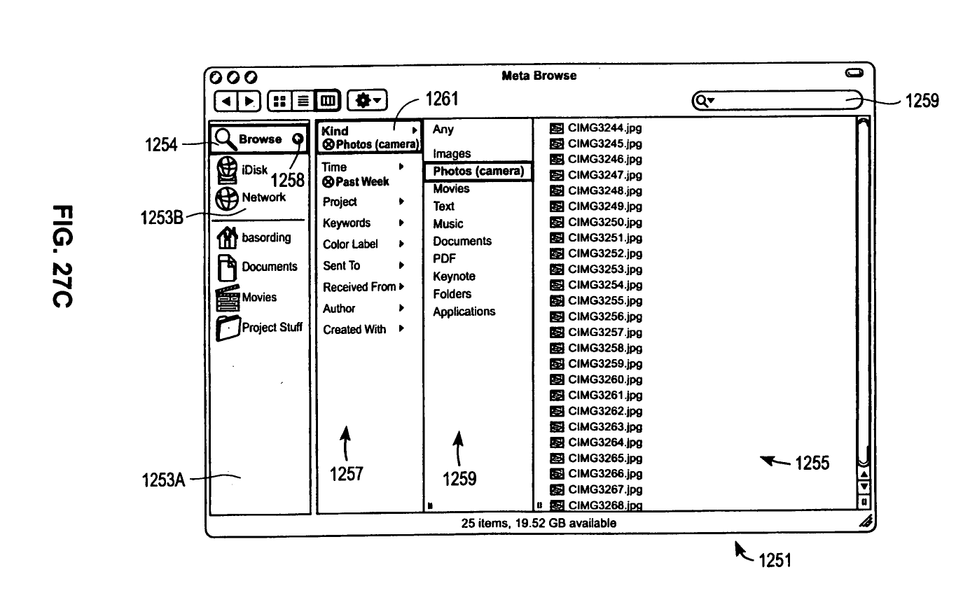

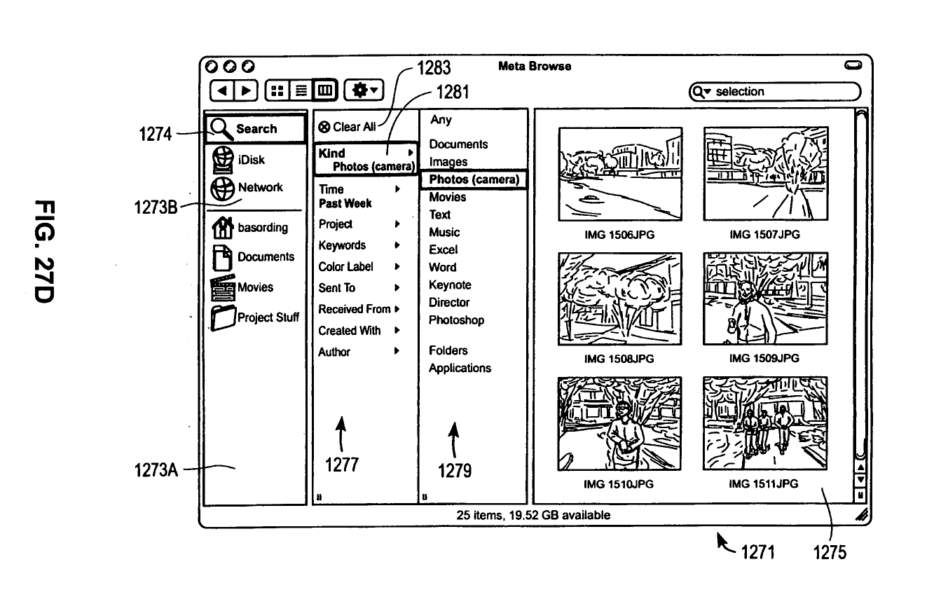

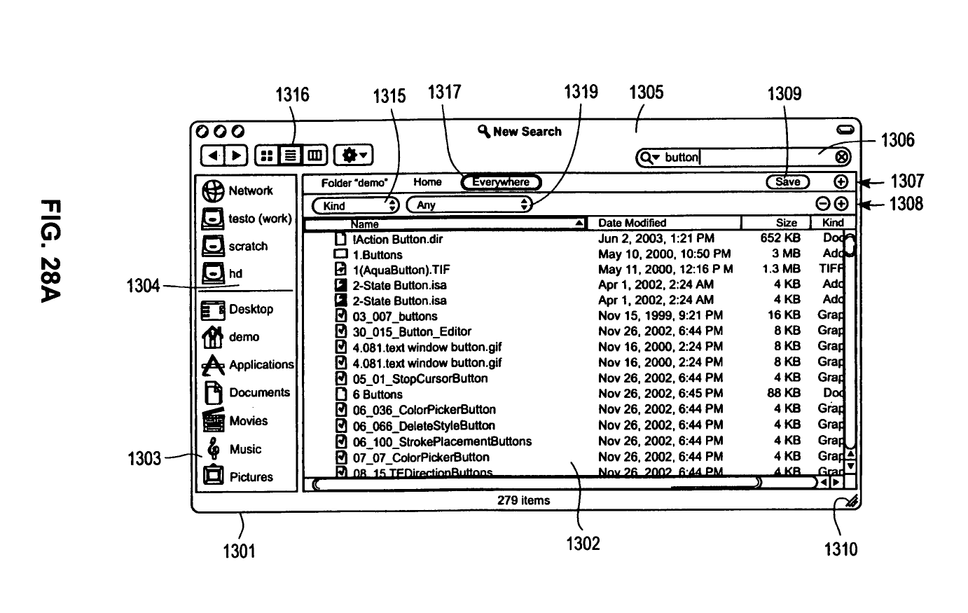

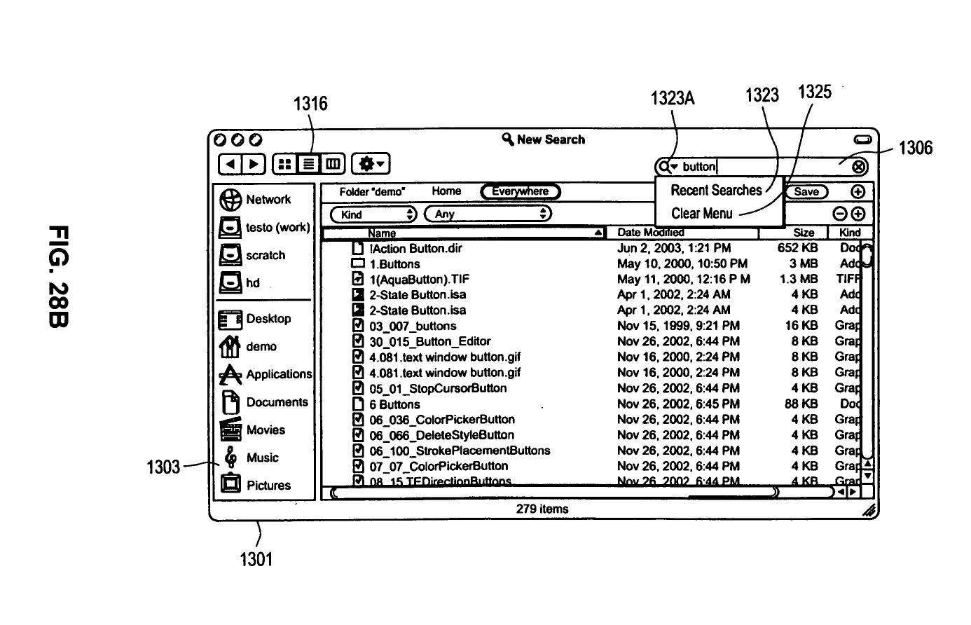

FIG. 26B shows the result of the user's activation of a “search by” pull down menu 1112 which causes the display of the menu 1113 which includes a plurality of options from which the user may choose to perform a search by. It will be appreciated that there are a number of different ways for a user to activate the “search by” pull down menu 1112. One way includes the use of a cursor, such as a pointer on a display which is controlled by a cursor control device, such as a mouse. The cursor is positioned over the region associated with the “search by” menu title (which is the portion within the search parameter menu bar 1111 which contains the words “search by”) and then the user indicates the selection of the menu title by pressing a button, such as a mouse's button, to cause the pull down menu to appear, which in this case is the menu 1113 shown in FIG. 26B. At this point, the user may continue to move the cursor to point to a particular option within the menu, such as the “time” option. This may result in the display of a submenu to the left or to the right of the menu 1113. This submenu may be similar to the submenu 719A or to the menu 1214 shown in FIG. 27A. If the “kind” option is selected in the menu 1113, the submenu may include a generic list of the different kinds of documents, such as images, photos, movies, text, music, PDF documents, email documents, etc. or the list may include references to specific program names such as PhotoShop, Director, Excel, Word, etc. or it may include a combination of generic names and specific names. FIG. 26C shows the result of the user having selected PhotoShop type of documents from a submenu of the “kind” option shown in menu 1113. This results in the display of the search parameter menu bar 1111A shown in FIG. 26C which includes a highlighted selection 1111B which indicates that the PhotoShop type of documents will be searched for. The search parameter menu bar 1111 appears below the search parameter menu bar 1111A as shown in FIG. 26C. The user may then specify additional search parameters by again using the “search by” pull down menu 1112 or by typing text into the text entry field 1109. For example, from the state of the window 1101 shown in FIG. 26C, the user may select the “search by” pull down menu 1112 causing the display of a menu containing a plurality of options, such as the options shown within the menu 1113 or alternative options such as those which relate to PhotoShop documents (e.g. the various fields in the metadata for PhotoShop type of documents). A combination of such fields contained within metadata for PhotoShop type documents and other generic fields (e.g. time, file size, and other parameters) may appear in a menu, such as the menu 1113 which is activated by selecting the “search by” pull down menu. The user may then select another criteria such as the time criteria. In this case, the window 1101 displays a new search parameter menu bar 1115 which allows a user to specify a particular time. The user may select one of the times on the menu bar 1115 or may activate a pull down menu by selecting the menu title “time,” which is shown as the menu title 1116. The state of the window 1101 shown in FIG. 26D would then search for all PhotoShop documents created in the last 30 days or 7 days or 2 days or today or at any time, depending on the particular time period selected by the user.

FIGS. 27A, 27B, 27C and 27D show another example of a user interface for allowing the creation of search queries for searching metadata and other data and for displaying the results of the search performed using a search query. The different implementation shown in FIGS. 27A-27D shows a user interface presentation in a column mode; this can be seen by noting the selection of the column button, which is the rightmost button in the view buttons 1237 shown in FIG. 27A. The window 1201 has two columns 1211 and the display region 1205, while the window 1251 of FIG. 27C has three columns which are columns 1257, 1259, and the display region 1255, and the window 1271 has three columns which are columns 1277, 1279, and the display region 1275.

The window 1201 shown in FIGS. 27A and 27B includes a display region 1205 which shows the results of a search; these results may be shown dynamically as the user enters search parameters or the results may be shown only after the user has instructed the system to perform the search (e.g. by selecting a “perform search” command). The window 1201 includes conventional window controls, such as a resizing control 1231, a scrolling control 1221, a title bar 1229 which may be used to move the window, a window close button, a window minimize button, and a window resize button 1234, 1235, and 1236, respectively. The window 1201 also includes a user configurable side bar region 1203A and a system specified side bar region 1203B. It can be seen from FIG. 27A that a browse mode has been selected as indicated by the highlighted “browse” icon 1203C in the system specified side bar region 1203B. The window 1201 also includes a text entry region 1209, which a user may use to enter text for a search, and the window 1201 also includes view selector buttons 1237.

A column 1211 of window 1201 allows a user to select various search parameters by selecting one of the options which in turn causes the display of a submenu that corresponds to the selected option. In the case of FIG. 27A, the user has selected the “kind” option 1212 and then has used the submenu 1214 to select the “photos” option from the submenu, resulting in an indicator 1213 (photos) to appear in the column 1211 under the “kind” option as shown in FIG. 27A. It can also be seen that the user has previously selected the “time” option in the column 1211 and has selected from a submenu brought up when the “time” option was selected the “past week” search parameter. When the user has finished making selections of the various options and suboptions from both the column 1112 and any of the corresponding submenus which appear, then the display showed in FIG. 27B appears. Note that the submenus are no longer present and that the user has completed the selection of the various options and suboptions which specify the search parameters. Column 1211 in FIG. 27B provides feedback to the user indicating the exact nature of the search query (in this case a search for all photos dated in the past week), and the results which match the search query are shown in the display region 1205.

FIGS. 27C and 27D show an alternative embodiment in which the submenus which appear on a temporary basis in the embodiment of FIGS. 27A and 27B are replaced by an additional column which does not disappear after a selection is made. In particular, the column 1259 of the window 1251 functions in the same manner as the submenu 1214 except that it remains within the window 1251 after a selection is made (wherein the submenu 1214 is removed from the window after the user makes the selection from the submenu). The column 1279 of window 1271 of FIG. 27D is similar to the column 1259. The window 1251 includes a side bar which has a user configurable side bar region 1253A and a system defined side bar region 1253B. The system specified side bar region 1253B includes a “browse” selection region 1254 which has a clear button 1258 which the user may select to clear the current search query. The window 1271 of FIG. 27D provides an alternative interface for clearing the search query. The window 1271 also includes a user configurable side bar region 1273A and a system specified side bar region 1273B, but the clear button, rather than being with the “search” region 1274 is at the top of the column 1277. The user may clear the current search parameter by selecting the button 1283 as shown in FIG. 27D.

FIG. 28A shows another embodiment of a window 1301 which displays search results within a display region 1302. The window 1301 may be a closeable, minimizable, resizable, and moveable window having a resizing control 1310, a title bar 1305 which may be used to move the window, a text entry region 1306 and a user configurable portion 1303, and a system specified portion 1304. The window 1301 further includes buttons for selecting various views, including an icon view, a list view, and a column view. Currently, the list view button 1316 has been selected, causing the display of the search results in a list view manner within the display region 1302. It can be seen that the text (“button”) has been entered into the text entry region 1306 and this has caused the system to respond with the search results shown in the display region 1302. The user has specified a search in every location by selecting “everywhere” button 1317. Further, the user has searched for any kind of document by selecting the “kind” option from the pull down menu 1315 and by selecting the “any” option in the pull down menu 1319. The where or location slice 1307 includes a “+” button which may be used to add further search parameters, and similarly, the slice 1308 includes a “+” and a “−” button for adding or deleting search parameters, respectively. The slice 1307 further includes a “save” button 1309 which causes the current search query to be saved in the form of a folder which is added to the user configurable portion 1303 for use later. This is described further below and may be referred to as a “smart folder.” The search input user interface shown in FIGS. 28A and 28B is available within, in certain embodiments, each and every window controlled by a graphical user interface file management system, such as a Finder program which runs on the Macintosh or Windows Explorer which runs on Microsoft Windows. This interface includes the text entry region 1306 as well as the slices 1307 and 1308.

The window 1301 shown in FIG. 28B shows the activation of a menu by selecting the search button 1323A, causing a display of a menu having two entries 1323 and 1325. Entry 1323 displays recently performed searches so that a user may merely recall a prior search by selecting the prior search and cause the prior search to be run again. The menu selection 1325 allows the user to clear the list of recent searches in the menu.

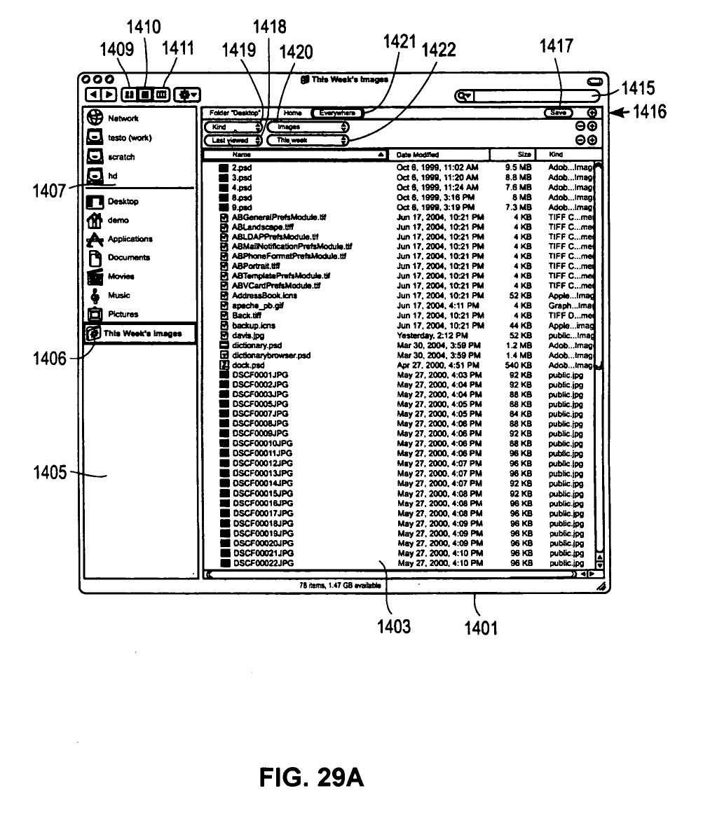

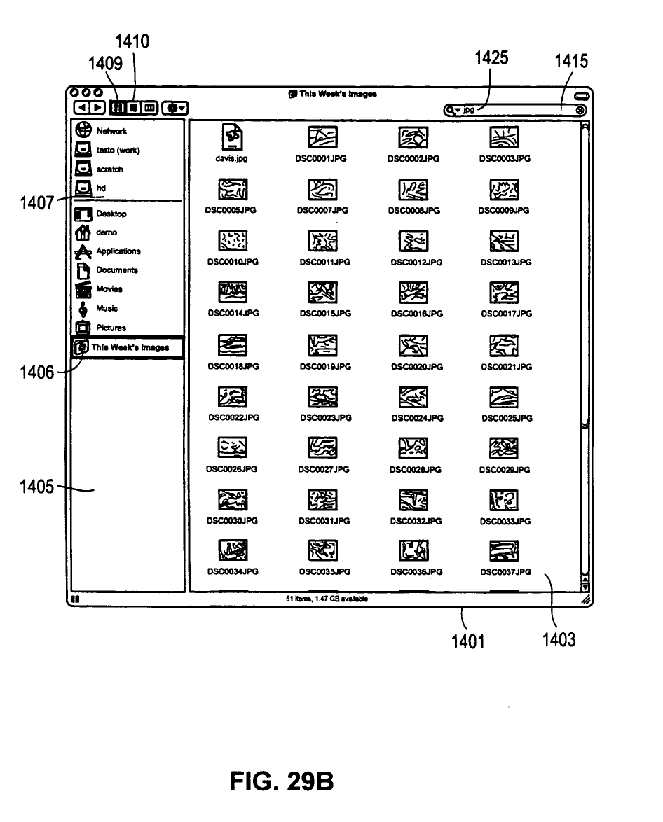

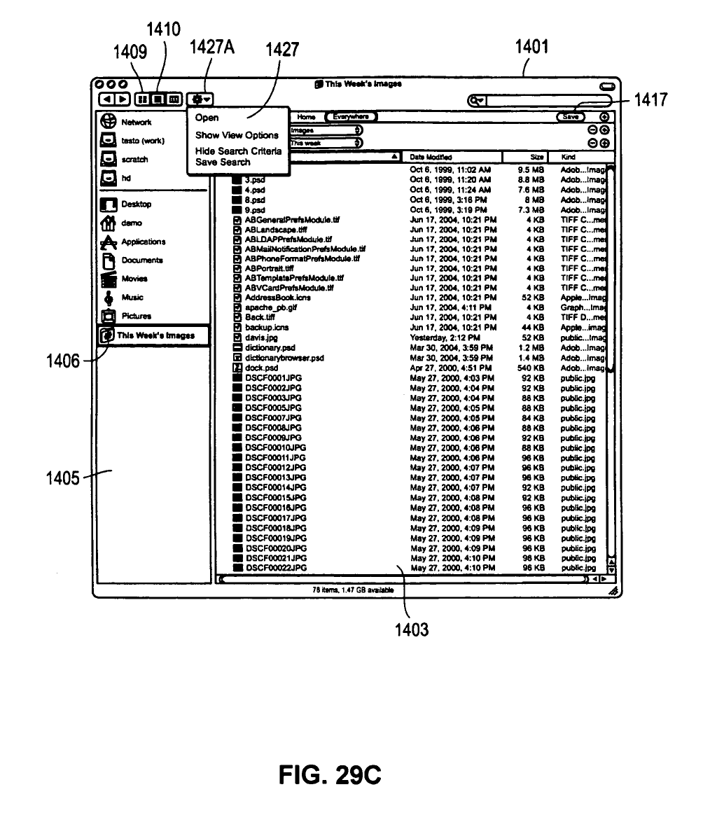

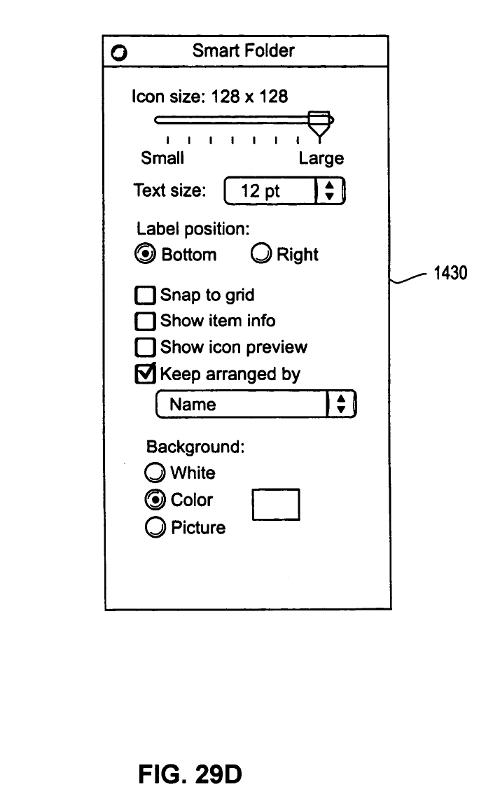

FIGS. 29A, 29B, and 29C show examples of another window in a graphical user interface file system, such as the Finder which runs on the Macintosh operating system. These windows show the results of a particular search and also the ability to save and use a smart folder which saves a prior search. The window 1401 shown in FIG. 29A includes a display region 1403, a user configurable region 1405, a smart folder 1406, a system specified region 1407, an icon view button 1409, a list view button 1410, and a column view button 1411. The window 1401 also includes a text entry region 1415 and a location slice 1416 which may be used to specify the location for the search, which slice also includes a save button 1417. Additional slices below the slice 1416 allow the user to specify further details with respect to the search, in this case specifying types of documents which are images which were last viewed this week. The user has set the search parameters in this manner by selecting the “kind” option from the pull down menu 1419 and by selecting the “images” type from the pull down menu 1420 and by selecting the “last viewed” option from pull down menu 1418 and by selecting “this week” from the pull down menu 1422. The user has also selected “everywhere” by selecting the button 1421 so that the search will be performed on all disks and storage devices connected to this system. The results are shown within the display region 1403. The user can then save the search query by selecting the “save” button 1417 and may name the saved search query as “this week's images” to produce the smart folder 1406 as shown in the user configurable portion 1405. This allows the user to repeat this search at a later time by merely selecting the smart folder 1406 which causes the system to perform a new search again, and all data which matches the search criteria will be displayed within the display region 1403. Thus, after several weeks, a repeating of this search by selecting the smart folder 1406 will produce an entirely different list if none of the files displayed in the display region 1403 of FIG. 29A are viewed in the last week from the time in which the next search is performed by selecting the smart folder 1406.

FIG. 29B shows a way in which a user may sort or further search within the search results specified by a saved search, such as a smart folder. In the case of FIG. 29B, the user has selected the smart folder 1406 and has then entered text “jpg” 1425 in the text entry region 1415. This has caused the system to filter or further limit the search results obtained from the search query saved as the smart folder 1406. Thus, PhotoShop files and other files such as TIF files and GIF files are excluded from the search results displayed within the display region 1403 of FIG. 29B because the user has excluded those files by adding an additional search criteria specified by the text 1425 in the text entry region 1415. It can be seen that the “jpg” text entry is ANDed logically with the other search parameters to achieve the search results displayed in the display region 1403. It can also be seen that the user has selected the icon view by selecting the icon view button 1409. Thus, it is possible for a user to save a search query and use it later and to further limit the results of the search query by performing a search on the results of the search query to further limit the search results.

FIG. 29C shows the window 1401 and shows the search results displayed within the display region 1403, where the results are based upon the saved search specified by the smart folder 1406. The user has caused a pull down menu 1427 to appear by selecting the pull down region 1427A. The pull down region 1427 includes several options which a user may select. These options include hiding the search criteria or saving the search (which is similar to selecting the button 1417) or showing view options or opening the selected file. This allows the user, for example, to hide the search criteria, thereby causing the slice 1416 and the other search parameters to be removed from the window 1401 which is a moveable, resizable, minimizable, and closeable window.

FIG. 29D shows an example of a user interface which allows the user to specify the appearance of a smart folder, such as the smart folder 1406.

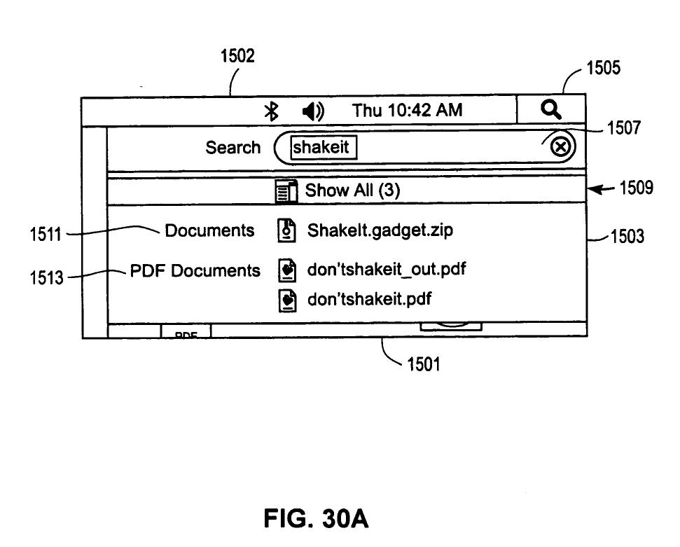

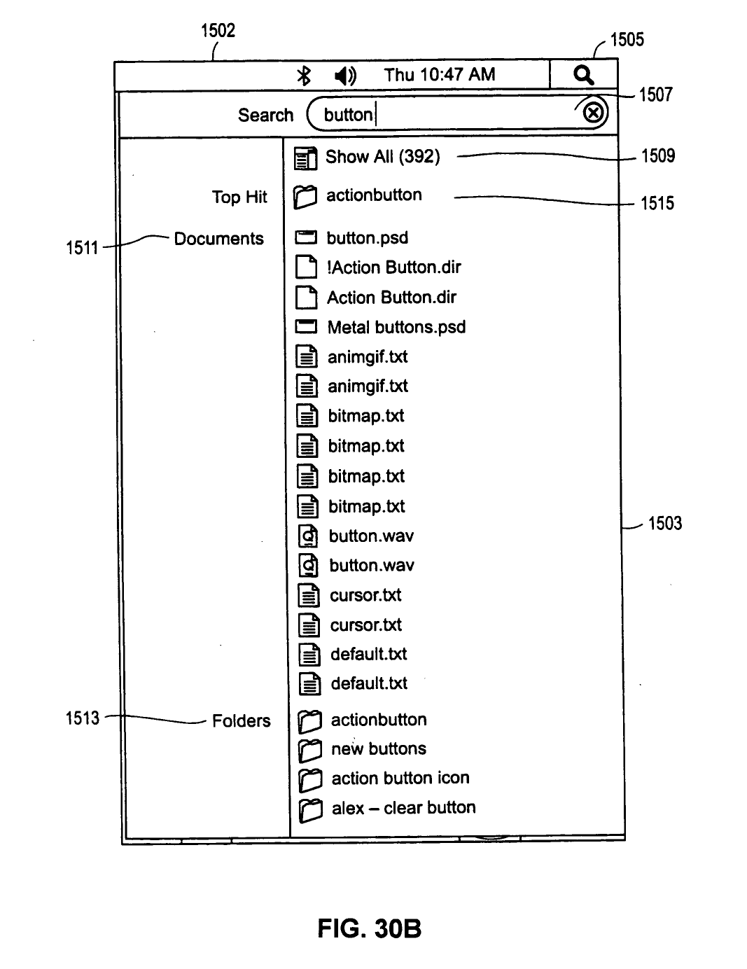

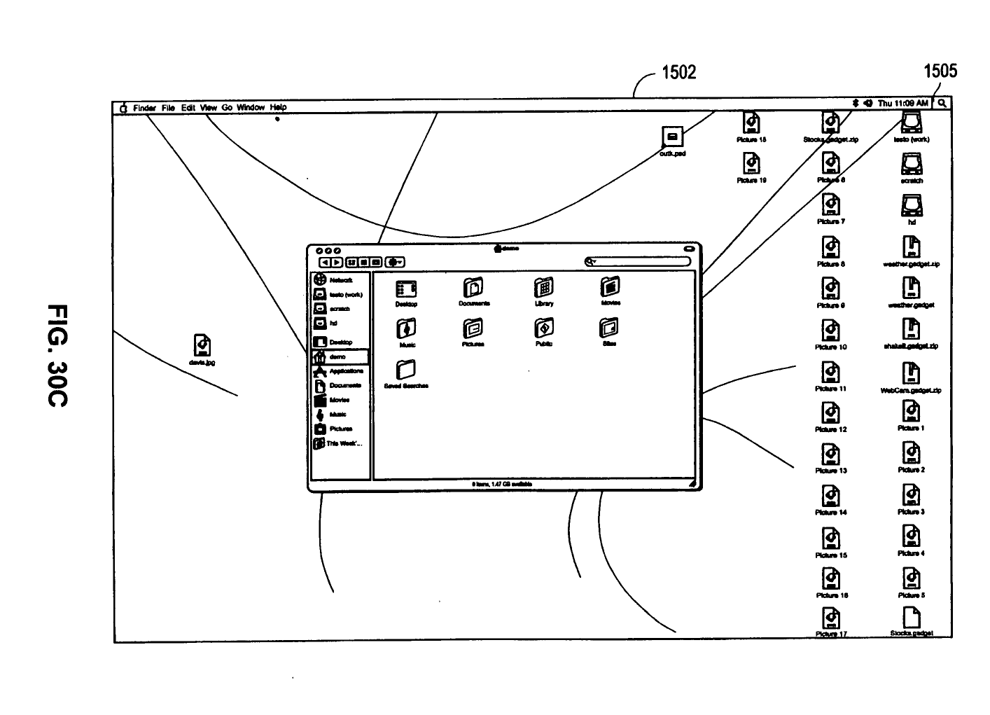

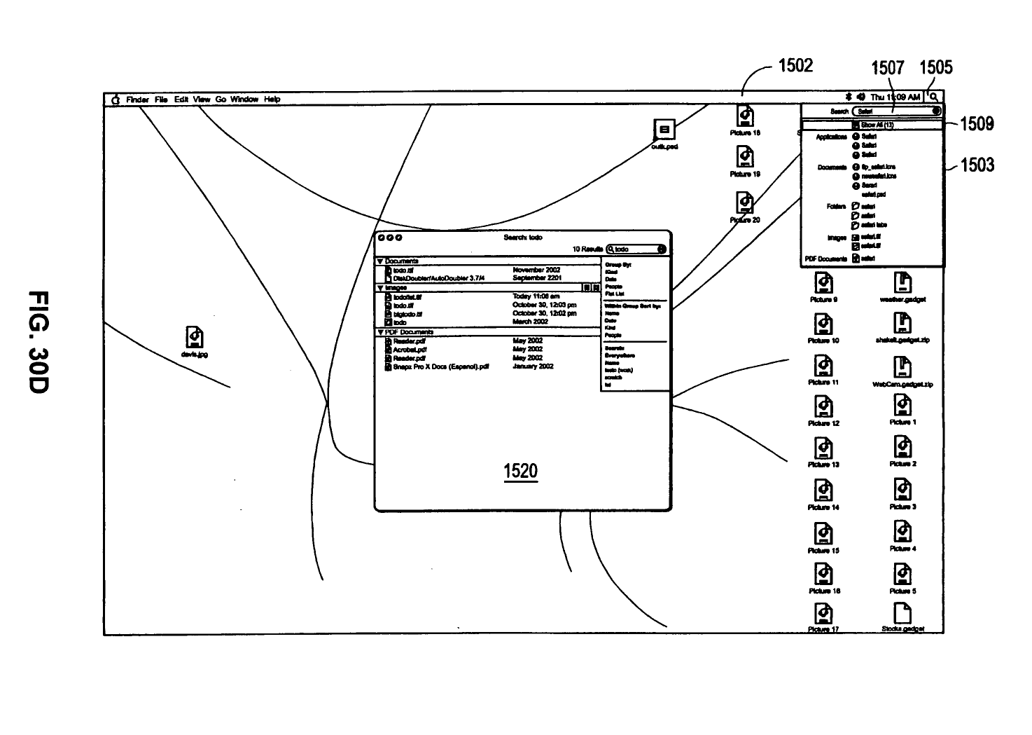

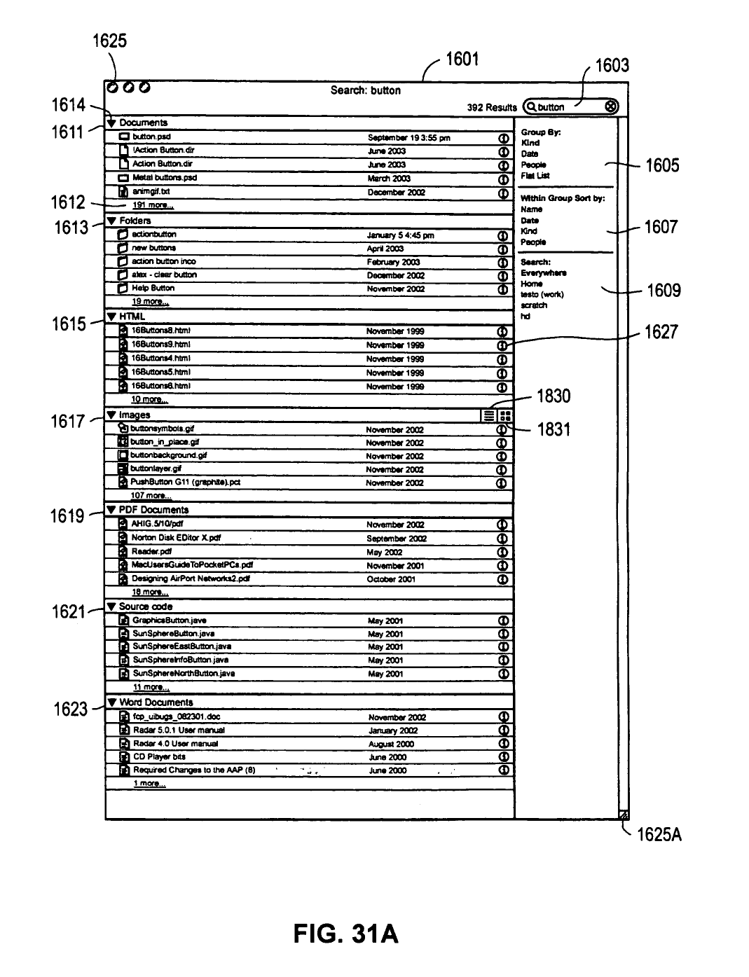

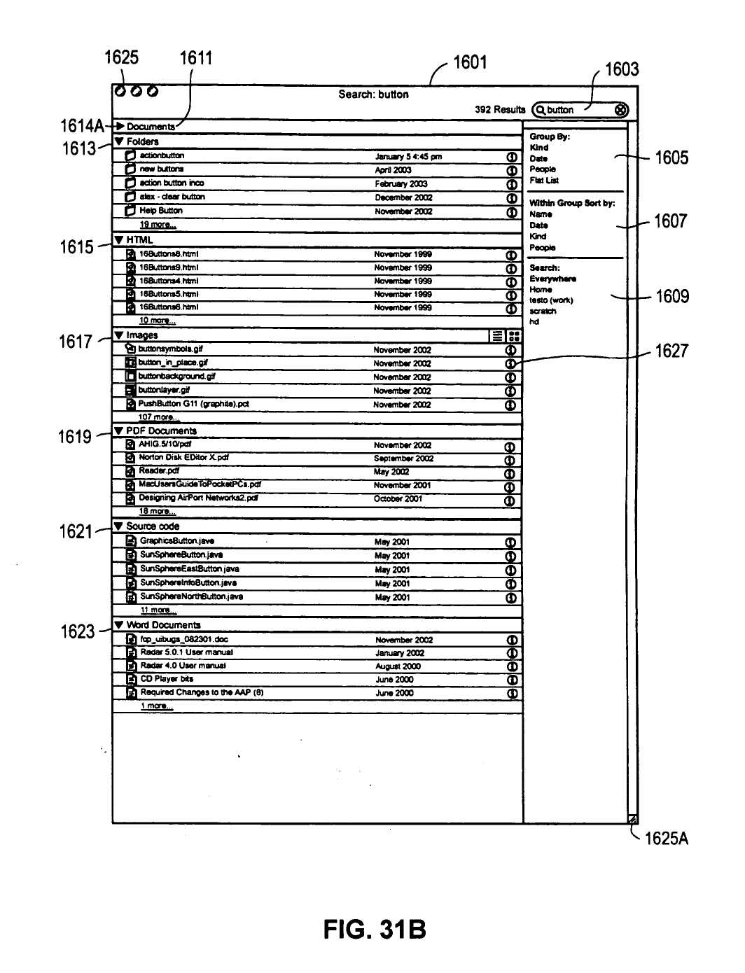

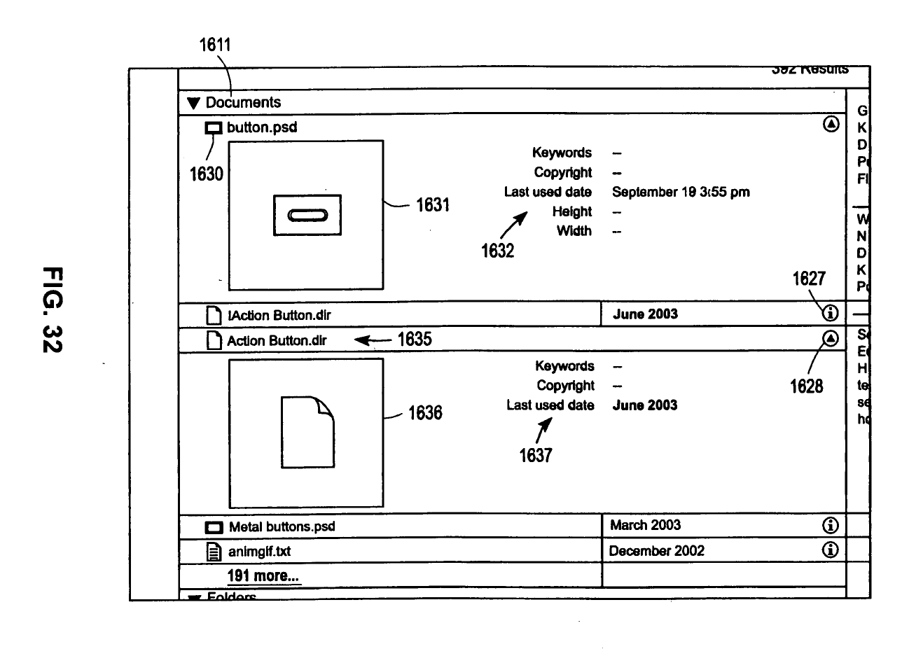

FIGS. 30A, 30B, 30C, and 30D show an example of a system wide search input user interface and search result user interface. In one particular exemplary embodiment, these user interfaces are available on the entire system for all applications which run on the system and all files and metadata, and even address book entries within an address book program, such as a personal information manager, and calendar entries within a calendar program, and emails within an email program, etc. In one exemplary embodiment, the system begins performing the search and begins displaying the results of the search as the user types text into a text entry field, such as the text entry field 1507. The search results are organized by categories and are displayed as a short list which is intentionally abbreviated in order to present only a selected number of the most relevant (scored) matches or hits to the search query. The user can ask for the display of all the hits by selecting a command, such as the “show all” command 1509. FIG. 30A shows a portion of a display controlled by a data processing system. This portion includes a menu bar 1502 which has at its far end a search menu command 1505. The user can select the search menu command by positioning a cursor, using a mouse, for example, over the search menu command 1505 and by pressing a button or by otherwise activating or selecting a command. This causes a display of a text entry region 1507 into which a user can enter text. In the example shown in FIG. 30A, which is a portion of the display, the user has entered the text “shakeit” causing the display of a search result region immediately below a “show all” command region 1509 which is itself immediately below the text entry region 1507. It can be seen that the hits or matches are grouped into categories (“documents” and “PDF documents”) shown by categories 1511 and 1513 within the search result region 1503. FIG. 30B shows another example of a search. In this case, a large number of hits was obtained (392 hits), only a few of which are shown in the search result region 1503. Again, the hits are organized by categories 1511 and 1513. Each category may be restricted in terms of the number of items displayed within the search result region 1503 in order to permit the display of multiple categories at the same time within the search result region. For example, the number of hits in the documents category may greatly exceed the available display space within the search result region 1503, but the hits for this category are limited to a predetermined or dynamically determinable number of entries within the search result region 1503 for the category 1511. An additional category, “top hit” is selected based on a scoring or relevancy using techniques which are known in the art. The user may select the “show all” command 1509 causing the display of a window, such as window 1601 shown in FIG. 31A. FIG. 30C shows a display of a graphical user interface of one embodiment of the invention which includes the menu bar 1502 and the search menu command 1505 on the menu bar 1502. FIG. 30D shows another example of the search result region 1503 which appeared after a search of the term “safari” was entered into the text entry region 1507. It can be seen from the search result region 1503 of FIG. 30D that the search results are again grouped into categories. Another search result window 1520 is also shown in the user interface of FIG. 30D. It can be seen that application programs are retrieved as part of the search results, and a user may launch any one of these application programs by selecting it from the search result region, thereby causing the program to be launched.

FIGS. 31A and 31B show examples of search result windows which may be caused to appear by selecting the “show all” command 1509 in FIG. 30A or 30B. Alternatively, these windows may appear as a result of the user having selected a “find” command or some other command indicating that a search is desired. Moreover, the window 1601 shown in FIGS. 31A and 31B may appear in response to either of the selection of a show all command or the selection of a find command. The window 1601 includes a text entry region 1603, a group by menu selection region 1605, a sort by menu selection region 1607, and a where menu selection region 1609. The group by selection region 1605 allows a user to specify the manner in which the items in the search results are grouped according to. In the example shown in FIG. 31A, the user has selected the “kind” option from the group by menu selection region 1605, causing the search results to be grouped or sorted according to the kind or type of document or file. It can be seen that the type of file includes “html” files, image files, PDF files, source code files, and other types of files as shown in FIG. 31A. Each type or kind of document is separated from the other documents by being grouped within a section and separated by headers from the other sections. Thus, headers 1611, 1613, 1615, 1617, 1619, 1621, and 1623 designate each of the groups and separate one group from the other groups. This allows a user to focus on evaluating the search results according to certain types of documents. Within each group, such as the document groups or the folder groups, the user has specified that the items are to be sorted by date, because the user has selected the date option within the sort by menu region 1607. The user has also specified that all storage locations are to be searched by selecting “everywhere” from the where menu selection region 1609. Each item in the search result list includes an information button 1627 which may be selected to produce the display of additional information which may be available from the system. An example of such additional information is shown in FIG. 32 in which a user has selected the information button 1627 for item 1635, resulting in the display of an image 1636 corresponding to the item as well as additional information 1637. Similarly, the user has selected the information button for another item 1630 to produce the display of an image of the item 1631 as well as additional information 1632. The user may remove this additional information from the display by selecting the close button 1628 which causes the display of the information for item 1635 to revert to the appearance for that item shown in FIG. 31A. The user may collapse an entire group to hide the entries or search results from that group by selecting the collapse button 1614 shown in FIG. 31A, thereby causing the disappearance of the entries in this group as shown in FIG. 31B. The user may cause these items to reappear by selecting the expand button 1614A as shown in FIG. 31B to thereby revert to the display of the items as shown in FIG. 31A.

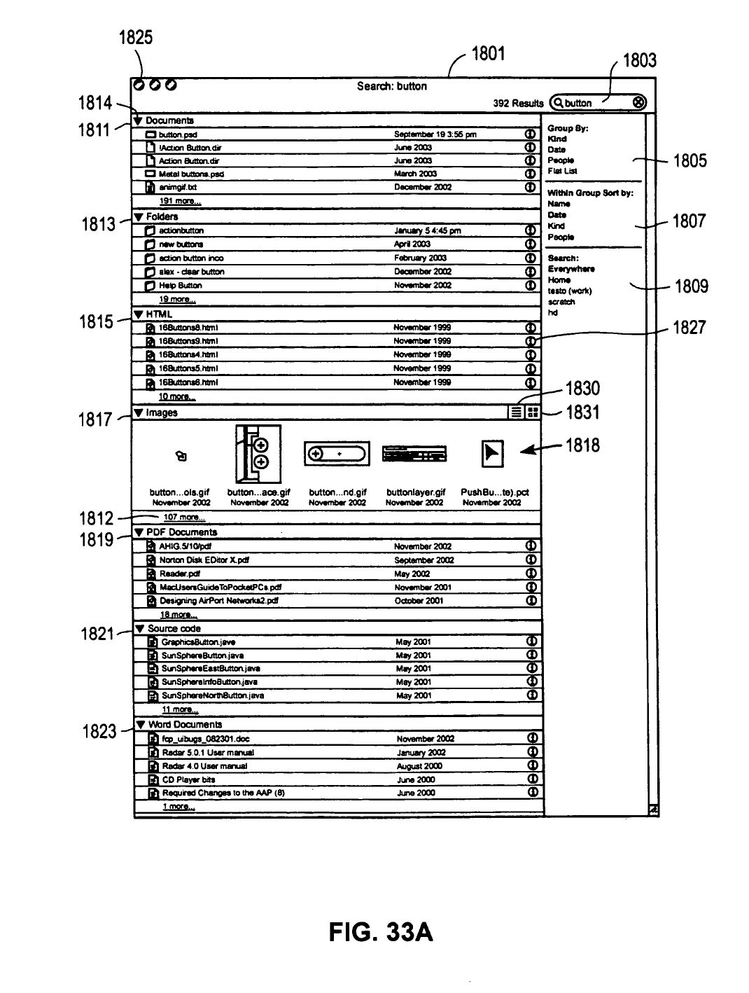

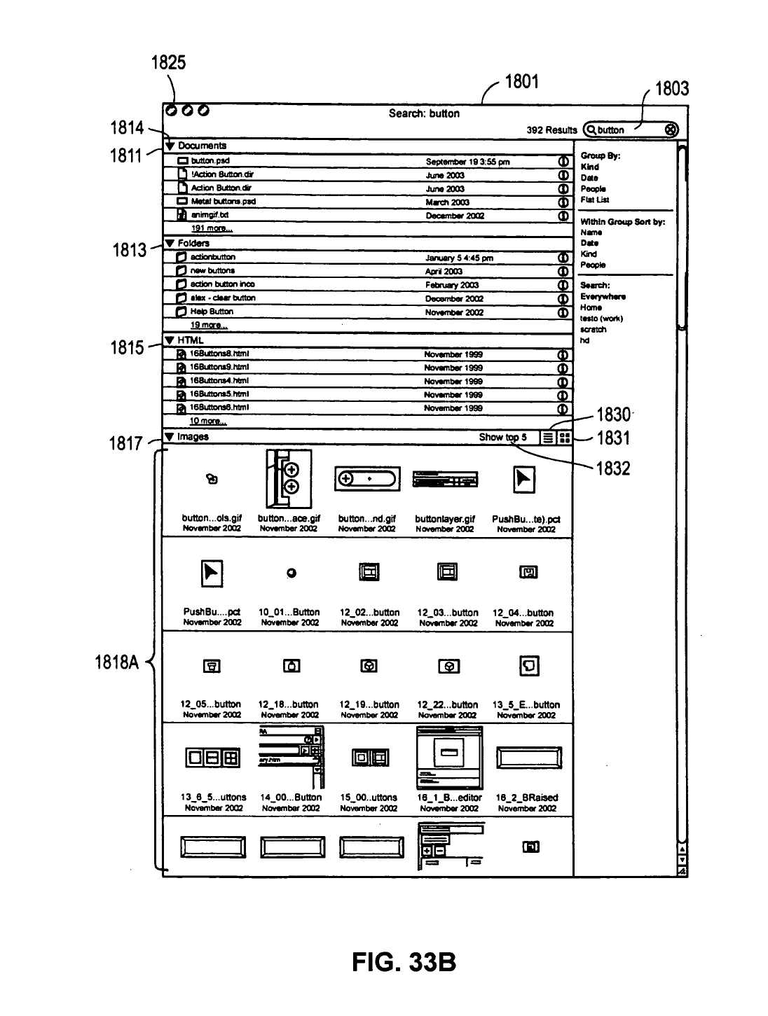

The search results user interface shown in FIGS. 31A and 31B presents only a limited number of matches or hits within each category. In the particular example of these figures, only the five top (most relevant or most highly sorted) hits are displayed. This can be seen by noticing the entry at the bottom of each list within a group which specifies how many more hits are within that group; these hits can be examined by selecting this indicator, such as indicator 1612, which causes the display of all of the items in the documents category or kind for the search for “button” which was entered into the text entry region 1603. Further examples of this behavior are described below and are shown in conjunction with FIGS. 33A and 33B. It will be appreciated that window 1601 is a closeable and resizable and moveable window and includes a close button and a resizing control 1625A.

FIGS. 33A and 33B illustrate another window 1801 which is very similar to the window 1601. The window 1801 includes a text entry region 1803, a group by menu selection region 1805, a sort by menu selection region 1807, and a where menu selection region 1809, each of which function in a manner which is similar to the regions 1605, 1607, and 1609 respectively of FIG. 31A. Each item in a list view within the window 1801 includes an information button 1827, allowing a user to obtain additional information beyond that listed for each item shown in the window 1801. The window 1801 further includes headers 1811, 1813, 1815, 1817, 1819, 1821, and 1823 which separate each group of items, grouped by the type or kind of document, and sorted within each group by date, from the other groups. A collapse button 1814 is available for each of the headers. The embodiment shown in FIGS. 33A and 33B shows the ability to switch between several modes of viewing the information. For example, the user may display all of the hits within a particular group by selecting the indicator 1812 shown in FIG. 33A which results in the display of all of the images files within the window 1801 within the region 1818A. The window is scrollable, thereby allowing the user to scroll through all the images. The user can revert back to the listing of only five of the most relevant images by selecting the “show top 5” button 1832 shown in FIG. 33B. Further, the user can select between a list view or an icon view for the images portion shown in FIGS. 33A and 33B. The user may select the list view by selecting the list view button 1830 or may select the icon view by selecting the icon view button 1831. The list view for the images group is shown in FIG. 31A and the icon view for the images group is shown in FIGS. 33A and 33B. It can be seen that within a single, moveable, resizable, closeable search result window, that there are two different views (e.g. a list view and an icon view) which are concurrently shown within the window. For example, the PDF documents under the header 1819 are displayed in a list view while the images under the header 1817 are displayed in an icon view in FIGS. 33A and 33B. It can also be seen from FIGS. 33A and 33B that each image is shown with a preview which may be capable of live resizing as described in a patent application entitled “Live Content Resizing” by inventors Steve Jobs, Steve Lemay, Jessica Kahn, Sarah Wilkin, David Hyatt, Jens Alfke, Wayne Loofbourrow, and Bertrand Serlet, filed on Jun. 25, 2004, and being assigned to the assignee of the present inventions described herein, and which is hereby incorporated herein by reference.

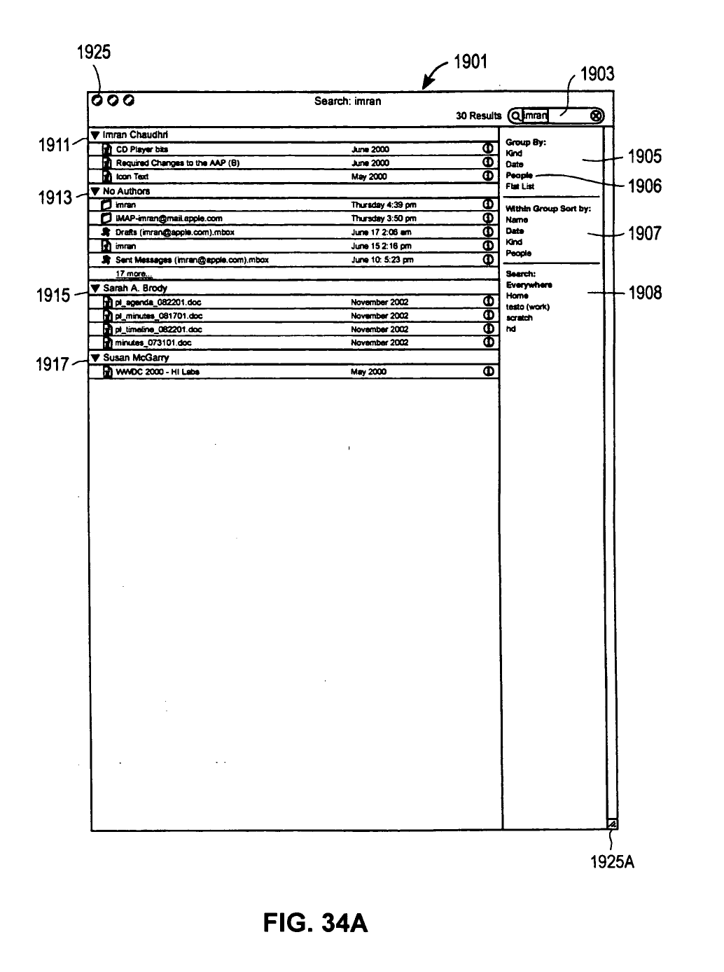

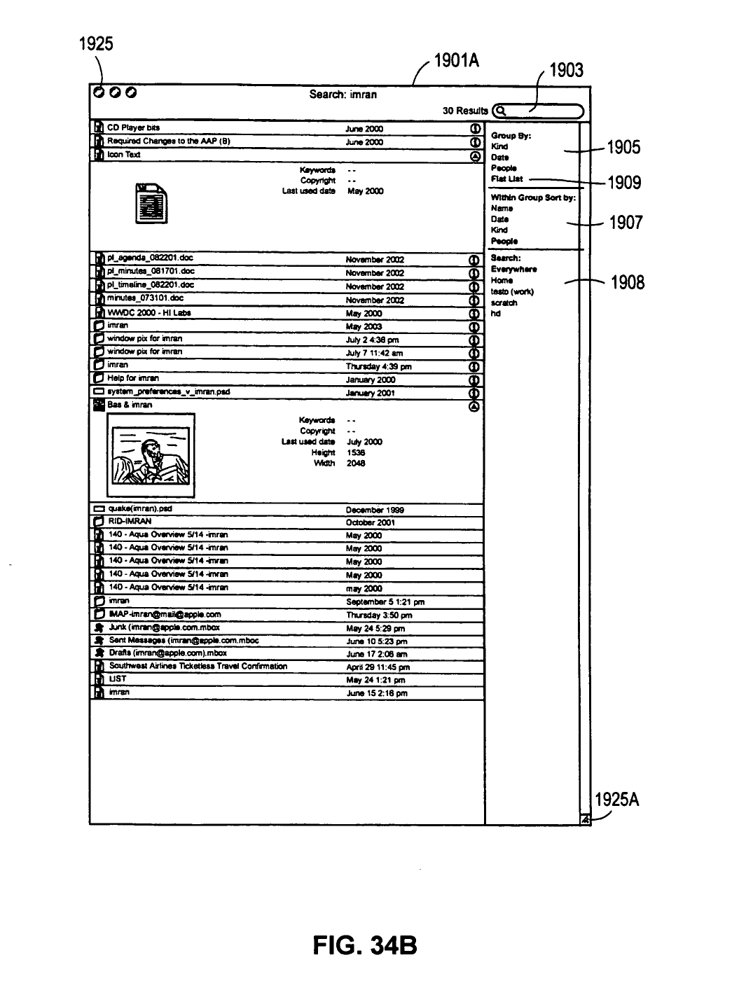

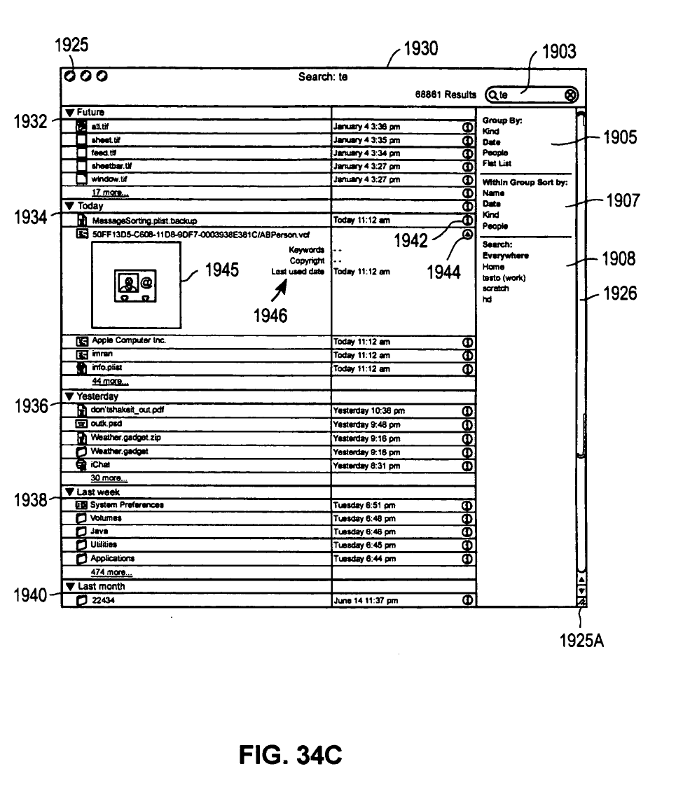

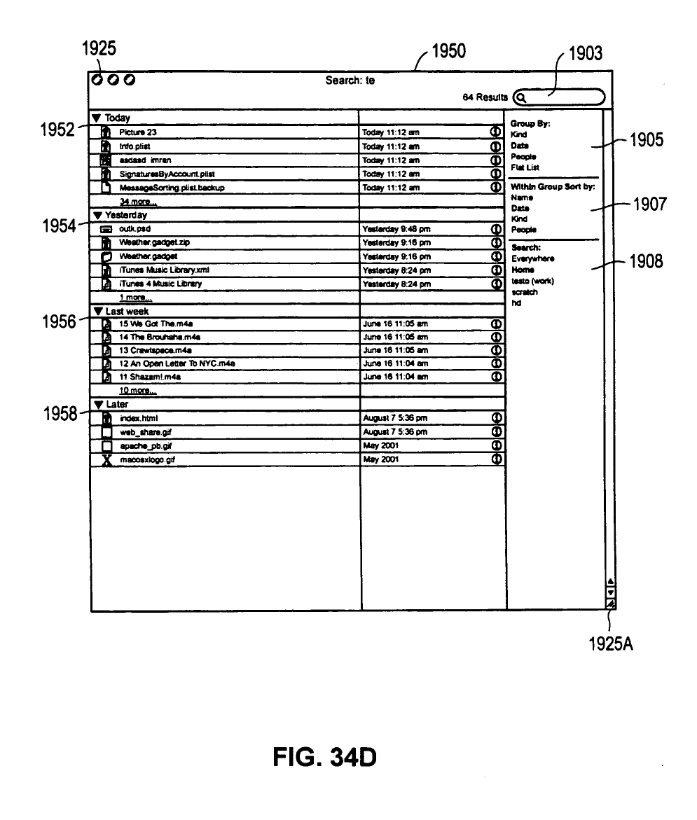

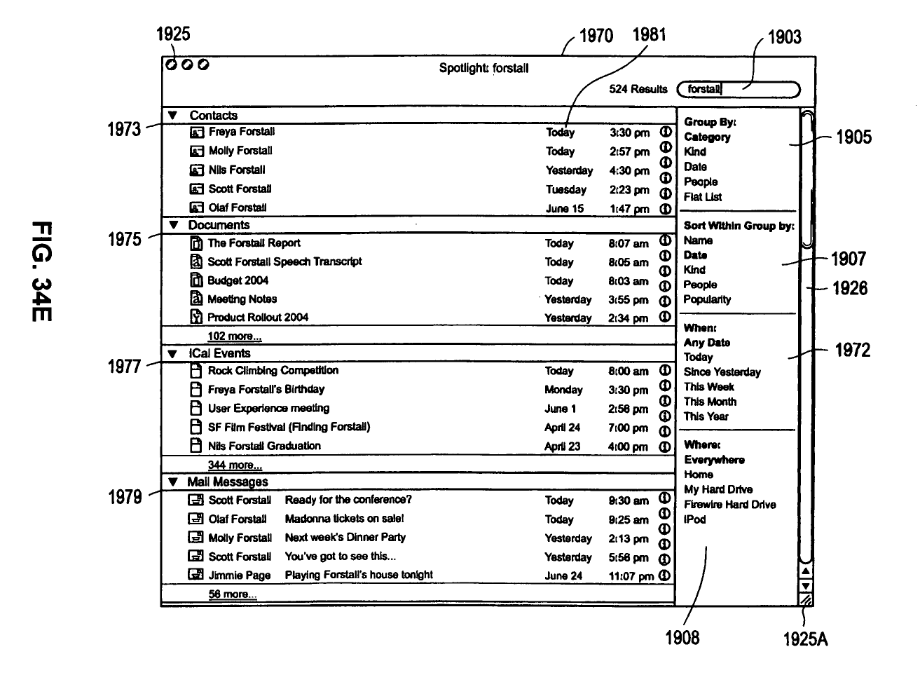

FIG. 34A shows another example of a search result window which is similar to the window 1601. The window 1901 shown in FIG. 34A includes a text entry region 1903 and a group by menu selection region 1905 and a sort by menu selection region 1907 and a where menu selection region 1908. Further, the window includes a close button 1925 and a resizing control 1925A. Text has been entered into the text entry region 1903 to produce the search results shown in the window 1901. The search results again are grouped by a category selected by a user which in this case is the people options 1906. This causes the headers 1911, 1913, 1915, and 1917 to show the separation of the groups according to names of people. Within each group, the user has selected to sort by the date of the particular file or document. The user interface shown in FIG. 34A allows a user to specify an individual's name and to group by people to look for communications between two people, for example. FIG. 34B shows another way in which a user can group a text search (“imran”) in a manner which is different from that shown in FIG. 34A. In the case of FIG. 34B, the user has selected a flat list from the group by menu selection region 1905 and has selected “people” from the sort by menu region 1907. The resulting display in window 1901A is without headers and thus it appears as a flat list.

FIG. 34C shows the user interface of another search result window 1930 which includes a text entry region 1903 and the selection regions 1905, 1907, and 1908 along with a scrolling control 1926. The results shown in the window 1930 have been grouped by date and sorted within each group by date. Thus, the headers 1932, 1934, 1936, 1938, and 1940 specify time periods such as when the document was last modified (e.g. last modified today, or yesterday, or last week). Also shown within the search results window 1930 is the information button 1942 which may be selected to reveal further information, such as an icon 1945 and additional information 1946 as shown for one entry under the today group. This additional information may be removed by selecting the contraction button 1944.

FIG. 34D shows a search result window 1950 in which a search for the text string “te” is grouped by date but the search was limited to a “home” folder as specified in the where menu selection region 1908. Time specific headers 1952, 1954, 1956, and 1958 separate items within one group from the other groups as shown in FIG. 34D.

FIG. 34E shows an alternative embodiment of a search result window. In this embodiment, the window 1970 includes elements which are similar to window 1901 such as the selection regions 1905, 1907, and a scrolling control 1926 as well as a close button 1925 and a resizing control 1925A. The search result window 1970 further includes a “when” menu selection region 1972 which allows the user to specify a search parameter based on time in addition to the text entered into the text entry region 1903. It can be seen from the example shown in FIG. 34E that the user has decided to group the search results by the category and to sort within each group by date. This results in the headers 1973, 1975, 1977, and 1979 as shown in FIG. 34E.

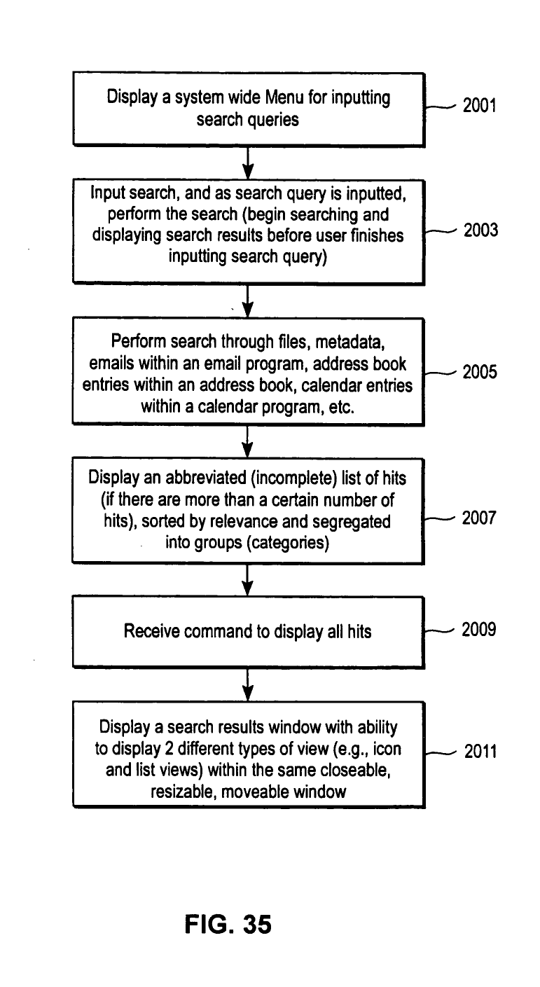

FIG. 35 shows an exemplary method of operating a system wide menu for inputting search queries, such as the system wide menu available by selecting the search menu command 1505 shown in FIG. 30A or 30B, or 30C. In operation 2001, the system displays a system wide menu for inputting search queries. This may be the search menu command 1505. The user, in operation 2003, inputs a search, and as the search query is being inputted, the system begins performing and begins displaying the search results before the user finishes inputting the search query. This gives immediate feedback and input to the user as the user enters this information. The system is, in operation 2005, performing a search through files, metadata for the files, emails within an email program, address book entries within an address book program, calendar entries within a calendar program, etc. The system then, in operation 2007, displays an abbreviated (e.g. incomplete) list of hits if there are more than a certain number of hits. An example of this abbreviated listing is shown in FIG. 30B. The listing may be sorted by relevance and segregated into groups such as categories or types of documents. Then in operation 2009, the system receives a command from the user to display all the hits and in operation 2011 the system displays the search results window, such as the window 1601 shown in FIG. 31A. This window may have the ability to display two different types of views, such as an icon view and a list view within the same closeable, resizable, and moveable window. It will be appreciated that the searching, which is performed as the user is typing and the displaying of results as the user is typing may include the searching through the metadata files created from metadata extracted from files created by many different types of software programs.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method of managing data, the method comprising:
storing a document lineage of a document as a metadata of the document, wherein the document lineage comprises:
a document identifier identifying a collection of related documents;
a file identifier identifying a branch of related documents within the collection of related documents.

2. The method of claim 1 wherein the file identifier remains the same within a branch of related documents, and is different for different branches of related documents.

3. The method of claim 1 wherein the file identifier remains the same for an operation providing modification between documents, and is different for an operation providing duplication between documents.

4. The method of claim 1 wherein the document lineage further comprises a version identifier, the version identifier identifying a version of document within a branch of related documents and wherein the metadata is stored in a metadata database which contains different types of metadata for different types of files.

5. The method of claim 1 wherein the document lineage, comprising the document identifier, the file identifier and a version identifier, is stored as a metadata associated with the document.

6. The method of claim 5 further comprising:
performing an operation on a parent document; and
retrieving a metadata associated with the parent document.

7. The method of claim 6 wherein the operation is a file importing or a file copy operation, and
wherein the file identifier associated with the document is different from the file identifier associated with the metadata associated with the parent document.

8. The method of claim 6 wherein the operation is a file modification operation, and
wherein the file identifier associated with the document is the same as the file identifier associated with the metadata associated with the parent document.

9. The method of claim 5 wherein the file identifier associated with the document is linked to the parent document.

10. The method of claim 9 wherein the file identifier associated with the document comprises a link to the parent document.

11. The method of claim 9 wherein the file identifier associated with the document comprises a file identifier and a version identifier which are associated with the parent document.

12. The method of claim 9 wherein the file identifier associated with the document comprises a metadata associated with the parent document.

13. A machine readable medium containing executable program instructions for causing a data processing system to perform a method of managing data, the method comprising:
storing a document lineage of a document as a metadata of the document, wherein the document lineage comprises:
a document identifier identifying a collection of related documents;
a file identifier identifying a branch of related documents within the collection of related documents.

14. The medium of claim 13 wherein the file identifier remains the same within a branch of related documents, and is different for different branches of related documents.

15. The medium of claim 13 wherein the file identifier remains the same for an operation providing modification between documents, and is different for an operation providing duplication between documents.

16. The medium of claim 13 wherein the document lineage further comprises a version identifier, the version identifier identifying a version of document within a branch of related documents and wherein the metadata is stored in a metadata database which contains different types of metadata for different types of files.

17. The medium of claim 13 wherein the document lineage, comprising the document identifier, the file identifier and a version identifier, is stored as a metadata associated with the document.

18. The medium of claim 17 wherein the method further comprises:
performing an operation on a parent document; and
retrieving a metadata associated with the parent document.

19. The medium of claim 18 wherein the operation is a file importing or a file copy operation, and
wherein the file identifier associated with the document is different from the file identifier associated with the metadata associated with the parent document.

20. The medium of claim 18 wherein the operation is a file modification operation, and
wherein the file identifier associated with the document is the same as the file identifier associated with the metadata associated with the parent document.

21. The medium of claim 17 wherein the file identifier associated with the document is linked to the parent document.

22. The medium of claim 21 wherein the file identifier associated with the document comprises a link to the parent document.

23. The medium of claim 21 wherein the file identifier associated with the document comprises a file identifier and a version identifier which are associated with the parent document.

24. The medium of claim 21 wherein the file identifier associated with the document comprises a metadata associated with the parent document.

25. A data processing system comprising:
means for storing a document lineage of a document as a metadata of the document, wherein the document lineage comprises:
a document identifier identifying a collection of related documents;
a file identifier identifying a branch of related documents within the collection of related documents.

26. The system of claim 25 wherein the file identifier remains the same within a branch of related documents, and is different for different branches of related documents.

27. The system of claim 25 wherein the file identifier remains the same for an operation providing modification between documents, and is different for an operation providing duplication between documents.

28. The system of claim 25 wherein the document lineage further comprises a version identifier, the version identifier identifying a version of document within a branch of related documents and wherein the metadata is stored in a metadata database which contains different types of metadata for different types of files.

29. The system of claim 25 wherein the document lineage, comprising the document identifier, the file identifier and a version identifier, is stored as a metadata associated with the document.

30. The system of claim 29 further comprising:
means for performing an operation on a parent document; and
means for retrieving a metadata associated with the parent document.

31. The system of claim 30 wherein the operation is a file importing or a file copy operation, and
wherein the file identifier associated with the document is different from the file identifier associated with the metadata associated with the parent document.

32. The system of claim 30 wherein the operation is a file modification operation, and
wherein the file identifier associated with the document is the same as the file identifier associated with the metadata associated with the parent document.

33. The system of claim 29 wherein the file identifier associated with the document is linked to the parent document.

34. The system of claim 33 wherein the file identifier associated with the document comprises a link to the parent document.

35. The system of claim 33 wherein the file identifier associated with the document comprises a file identifier and a version identifier which are associated with the parent document.

36. The system of claim 33 wherein the file identifier associated with the document comprises a metadata associated with the parent document.

37. A machine implemented method of managing data, the method comprising:
retrieving a plurality of document lineages,
each document lineage associated with a document,
each document lineage comprising:
a document identifier identifying a collection of related documents;
a file identifier identifying a branch of related documents within the collection of related documents;
performing an operation associated with the plurality of document lineages.

38. The method of claim 37 wherein the document lineage further comprises a version identifier, the version identifier identifying a version of document within a branch of related documents.

39. The method of claim 38 wherein the document lineage, comprising the document identifier, the file identifier and the version identifier, is a metadata associated with the document, and stored in a metadata database.

40. The method of claim 39 wherein the operation comprises modifying the document to a modified document, wherein the file identifier of the modified document is assigned the value of the file identifier of the document.

41. The method of claim 39 wherein the operation comprises copying the document to a copied document, wherein the file identifier of the copied document is assigned a different value than the value of the file identifier of the document.

42. The method of claim 39 wherein the operation comprises tracking the document lineage by generating a latest version of the document, by generating all latest versions of the document, by generating a branch of the document, identified by the document file identifier, by generating a tree of the document, or by generating a collection of related documents.

43. The method of claim 39 wherein the operation comprises generating a relationship between two documents.

44. The method of claim 39 wherein the operation comprises searching the metadata.

45. The method of claim 39 wherein the operation comprises displaying a search input interface for searching the metadata.

46. A machine readable medium containing executable program instructions for causing a data processing system to perform a method of managing data, the method comprising:
retrieving a plurality of document lineages,
each document lineage associated with a document,
each document lineage comprising:
a document identifier identifying a collection of related documents;
a file identifier identifying a branch of related documents within the collection of related documents;
performing an operation associated with the plurality of document lineages.

47. The medium of claim 46 wherein the document lineage further comprises a version identifier, the version identifier identifying a version of document within a branch of related documents.

48. The medium of claim 47 wherein the document lineage, comprising the document identifier, the file identifier and the version identifier, is a metadata associated with the document, and stored in a metadata database.

49. The medium of claim 48 wherein the operation comprises modifying the document to a modified document, and wherein the file identifier of the modified document is assigned the value of the file identifier of the document.

50. The medium of claim 48 wherein the operation comprises copying the document to a copied document, and wherein the file identifier of the copied document is assigned a different value than the value of the file identifier of the document.

51. The medium of claim 48 wherein the operation comprises tracking the document lineage by generating a latest version of the document, by generating all latest versions of the document, by generating a branch of the document, identified by the document file identifier, by generating a tree of the document, or by generating a collection of related documents.

52. The medium of claim 48 wherein the operation comprises generating a relationship between two documents.

53. The medium of claim 48 wherein the operation comprises searching the metadata.

54. The medium of claim 48 wherein the operation comprises displaying a search input interface for searching the metadata.

55. A data processing system comprising:
means for retrieving a plurality of document lineages,
each document lineage associated with a document,
each document lineage comprising:
a document identifier identifying a collection of related documents;
a file identifier identifying a branch of related documents within the collection of related documents;
means for performing an operation associated with the plurality of document lineages.

56. A machine implemented method of managing data, the method comprising:
storing a document lineage of a document as a metadata of the document, wherein the document lineage comprises:
a first identifier identifying a collection of related documents;
a second identifier identifying a branch of related documents within the collection of related documents.

57. The method of claim 56 wherein the second identifier remains the same within a branch of related documents, and is different for different branches of related documents.

58. The method of claim 56 wherein the second identifier remains the same for an operation providing modification between documents, and is different for an operation providing duplication between documents.

59. The method of claim 56 wherein the document lineage further comprises a version identifier, the version identifier identifying a version of document within a branch of related documents and wherein the metadata is stored in a metadata database which contains different types of metadata for different types of files.

60. The method of claim 56 wherein the document lineage, comprising the first identifier, the second identifier and a version identifier, is stored as a metadata associated with the document.

61. The method of claim 60 further comprising:
performing an operation on a parent document; and
retrieving a metadata associated with the parent document.

62. The method of claim 61 wherein the operation is a file importing or a file copy operation, and
wherein the second identifier associated with the document is different from the second identifier associated with the metadata associated with the parent document.

63. The method of claim 61 wherein the operation is a file modification operation, and
wherein the second identifier associated with the document is the same as the second identifier associated with the metadata associated with the parent document.

64. A machine readable medium containing executable program instructions for causing a data processing system to perform a method of managing data, the method comprising:
storing a document lineage of a document as a metadata of the document, wherein the document lineage comprises:
a first identifier identifying a collection of related documents;
a second identifier identifying a branch of related documents within the collection of related documents.

65. The medium of claim 64 wherein the second identifier remains the same within a branch of related documents, and is different for different branches of related documents.

66. The medium of claim 64 wherein the second identifier remains the same for an operation providing modification between documents, and is different for an operation providing duplication between documents.

67. The medium of claim 64 wherein the document lineage further comprises a version identifier, the version identifier identifying a version of document within a branch of related documents and wherein the metadata is stored in a metadata database which contains different types of metadata for different types of files.

68. The medium of claim 64 wherein the document lineage, comprising the first identifier, the second identifier and a version identifier, is stored as a metadata associated with the document.

69. The medium of claim 68 wherein the method further comprises:
performing an operation on a parent document; and
retrieving a metadata associated with the parent document.

70. The medium of claim 69 wherein the operation is a file importing or a file copy operation, and
wherein the file identifier associated with the document is different from the file identifier associated with the metadata associated with the parent document.

71. The medium of claim 69 wherein the operation is a file modification operation, and
wherein the second identifier associated with the document is the same as the second identifier associated with the metadata associated with the parent document.

72. A data processing system comprising:
means for storing a document lineage of a document as a metadata of the document, wherein the document lineage comprises:
a first identifier identifying a collection of related documents;
a second identifier identifying a branch of related documents within the collection of related documents.

73. A machine readable medium containing executable program instructions which when executed by a data processing system cause the system to perform a method comprising:
receiving a message that a second file has been created from a first file;
retrieving document lineage metadata of the first file;
creating, for the second file, document lineage metadata which includes document lineage metadata of the first file, wherein the document lineage metadata specifies a relationship between the second file and the first file.

74. A medium as in claim 73 wherein the document lineage metadata for the second file includes a file identifier of the first file and a version identifier of the first file.

75. A data structure, capable of being stored or transmitted, the data structure comprising:
a first identifier identifying a collection of documents;
a second identifier identifying a branch of related documents within the collection of related documents.

76. A data structure, capable of being stored or transmitted, the data structure comprising:
a document lineage metadata which includes document lineage metadata of a first file and document lineage metadata for a second file created from the first file.
